(19) United States
(12) Patent Application Publication
(10) Pub. No.: US 2005/0178401 A1
(43) Pub. Date: Aug. 18, 2005

(54) Method and apparatus for treating a substrate with an ozone-solvent solution III

(76) Inventor: David G. Boyers, Los Altos, CA (US)

Correspondence Address: Joseph H. Smith, 4410 Casa Madeira Lane, San Jose, CA, 95127, US

(21) Appl. No.: 10/425,692

(22) Filed: Apr. 28, 2003

Related U.S. Application Data
(60) Provisional application No. 60/375,952, filed on Apr. 26, 2002.

(51) Int. Cl. C25F 1/00; B08B 6/00

(52) U.S. Cl. 134/1.3; 134/31; 216/83; 216/57; 156/345.11

(57) ABSTRACT

A general method and apparatus for treating materials at high speed comprises the steps of dissolving a relatively high concentration ozone gas in a solvent at a relatively low predetermined temperature T1 to form an ozone-solvent solution with a relatively high dissolved ozone concentration, and heating either the ozone-water solution or the material to be treated or both, the ozone-solvent solution and the material to be oxidized with a point-of-use heater to quickly increase the temperature to a predetermined higher temperature T2>T1, and applying the ozone-solvent solution to said material(s) whereby the heated ozone-water solution will have a much higher dissolved ozone concentration at said higher temperature, than could be achieved if the ozone gas was initially dissolved in water at said higher temperature.

### BACKGROUND—FIELD OF INVENTION

This invention presents a method for treating materials using an ozone-solvent solution. The method may be used for removing photoresist, post ash photoresist residue, post-etch residue, and other organic materials from semiconductor wafers, flat panel display substrates, and the like at high speed using a solution of ozone gas dissolved in a solvent. The method may also be used to grow an oxide layer on a metal surface using an ozone-solvent solution. The method may also be used for disinfection or sterilization of medical instruments whereby bacteria, viruses, and other microbes are inactivated by the ozone-solvent solution.

### BACKGROUND—WAFER PROCESSING

Low Temperature Immersion Processing: The patent by Mathews (U.S. Pat. No. 5,464,480), publications by Kashkoush, et.al 1997, Kashkoush, et.al. 1998, and Mathews, 1998 disclose a method of removing photoresist from semiconductor wafers using with ozone dissolved in water at a temperature of 1 to 15 degree C. and applied to the surface of the wafers at the same temperature. They achieved an etch rate for I-line positive photoresist of about 700 Angstroms/min at a dissolved concentration of about 90 mg/L and temperature of 5 degree C. They reported that DUV positive resists were not effectively removed by the process. The method has a number of disadvantages: 1) low etch rates for I-line positive photoresist and inability to etch DUV positive resists; this is a severe disadvantage because most high resolution lithography for electronic device fabrication is based upon positive photoresist with new generation designs using DUV resists, 2) the presence of high concentration ozone gas in the process tank presents a safety hazard to the users 3) the immersion design uses water inefficiently and provides no means for integration of a drying step. We can analyze the etch rate performance of this method by noting the following: 1) a low temperature of 1 to 15 degree C. produces a higher dissolved ozone concentration C for a given gas phase concentration and pressure, 2) a low temperature of 1 to 15 degree C. produces a low surface reaction rate, and 3) the very low mass transport available in an immersion design with a very large stagnant layer thickness δ reduces the temperature at which the reaction becomes surface breaction rate limited, and 4) the etch rate is therefore lowest of the four prior art methods reviewed.

Room Temperature Spin Processing: The publications by Christenson, et. al. 1997, Christenson, et. al., 1998, and Nelson et. al. 1999 disclose a method of removing photoresist from semiconductor wafers using ozone dissolved in water at room temperature (20 degree C.) and applied to the surface of the wafers at the same temperature. The method achieves improved mass transfer over that which can be achieved by an immersion process by applying an ozone-water solution to the center of a semiconductor wafer that is rotating at 1,000 rpm. The reported etch rate for I-line positive photoresist is non-uniform, peaking at 2500 Angstroms/min in the very center of the wafer and falling quickly to about 1500 Angstroms/minute at a radius of 30 mm and remaining relatively constant to the edge at a radius of 75 mm. No etch rate results were reported for DUV positive resists. The water is sent to waste after one pass over the wafer. The resist removal method offers some advantages over the method disclosed by Mathews and Kashkoush: 1) the reported etch rate for I-line positive photoresist is a factor of two higher (1500 Angstroms/min compared to 700 Angstroms/min), 2) high concentration ozone gas is not present in the process chamber, and 3) the use of a spinning wafer configuration provides for more efficient use of water and means for integration of a spin rinse and spin drying step at the end of the process. However, the photoresist etch rates which can be achieved with this technique are still too low to form the basis for a single wafer processing tool with a practical throughput. Our own measurements show that the etch rate for DUV positive photoresist that can be achieved with this technique is about 600 Angstroms per minute as compared to the 1500 Angstroms/min. for I-line positive photoresist. We can analyze the etch rate performance of this method by noting the following: 1) a temperature of 20 degree C. produces an intermediate dissolved ozone concentration for a given gas phase concentration and pressure, 2) a temperature of 20 degree C. produces a modest surface reaction rate, 3) the higher mass transport available in 1000 rpm spinning wafer design with a smaller stagnant layer thickness δ increases the temperature at which the reaction becomes surface reaction rate limited, and 4) the etch rate is higher than that achieved by the low temperature immersion processing method.

Humidified Ozone Gas Processing Method: The publications by DeGendt, et. al. 1998 disclose a method of removing photoresist from semiconductor wafers using humidified ozone gas. In the moist gas phase process quartz container is filled with DI water. A diffuser is located in the bottom of the quartz container and high concentration ozone gas is bubbled through the liquid while the liquid is heated to about 80 degree C. One or more photoresist coated semiconductor wafers are placed above the liquid level (not immersed) and exposed to a moist ozone gas ambient. Etch rates as high as 6,000 Angstroms/min. for I-line positive and DUV positive photoresist were reported. These workers also noted that the ozone etch process is limited by kinetic factors at low temperature and by ozone solubility at higher temperatures. They also note that any optimized process should aim at maximizing the ozone concentration at elevated temperatures. They state that by exposing the wafer to a moist gas ambient that a thin condensation layer is formed on the wafer and the ozone gas ambient maintains a continuous supply of ozone gas above the condensation layer and achieve a higher dissolved ozone concentration in the condensation layer. The method has several significant disadvantages: 1) the high concentration ozone gas in the presence of water vapor can be corrosive to metals, 2) the presence of high concentration ozone gas in the process tank presents a safety hazard to the users, and 3) the high etch rates can only be achieved at relatively high temperatures (80 C) where metal corrosion rates are increased further. Accordingly, the method may only be suitable for front end of line wafer processing before metals are deposited on the wafer. We can analyze the etch rate performance of this method by noting the following: 1) a temperature of 80 degree C. produces very low dissolved ozone concentration for a given gas phase concentration and pressure, 2) a temperature of 80 degree C. produces a high surface reaction rate, 3) the higher mass transport available in wet ozone gas method with a smaller stagnant layer thickness δ increases the temperature at which the reaction becomes surface reaction rate limited, and 4) the etch rate is higher than that achieved by the low temperature immersion processing method or the room temperature spin processing method.

Humidified Ozone Gas with Spin Processing Method: Workers at Semitool (Scranton, 1999) have developed a similar wet ozone gas technique in which hot DI water at a temperature of between 40 and 95 deg. is sprayed onto the surface of a wafer spinning at 1,000 rpm in process chamber filled with 14 weight percent ozone gas. They have reported etch rates for I-line positive photoresist of 4200 angstroms/minute at a temperature of 95 deg. C., 2000 angstroms/minute at 45 deg. C., and 1200 angstroms/minute at 20 deg. C. They reported that in the case of back-end-of-line (BEOL) processes that metal corrosion limited process temperatures to about 45 deg. C. They reported that the 95 deg. C. process was only suitable for use in front-end-of-line (FEOL) processes where metal corrosion was not a consideration. This method has the same disadvantages as the humidified ozone gas processing method: 1) the high concentration ozone gas in the presence of water vapor can be corrosive to metals, 2) the presence of high concentration ozone gas in the process tank presents a safety hazard to the users, and 3) the high etch rates can only be achieved at relatively high temperatures (95 C) where metal corrosion rates are increased further. We can analyze the etch rate performance of this method by noting the following: 1) a temperature of 80 degree C. produces very low dissolved ozone concentration for a given gas phase concentration and pressure, 2) a temperature of 80 degree C. produces a high surface reaction rate, 3) the higher mass transport available in wet ozone gas method increases the temperature at which the reaction becomes surface reaction rate limited, and 4) the etch rate is higher than that achieved by the low temperature immersion processing method or the room temperature spin processing method.

Underlying Basis of the Etch Rate Limitations of the Prior Art Methods: In all the prior art described above, the ozone is dissolved in water at a given temperature and the ozone water solution is applied to the material to be oxidized at the same temperature. Accordingly, if one lowers the temperature to increase the dissolved ozone concentration, then one decreases the surface reaction. Alternatively, if one increases the temperature to increase the surface reaction rate, then one decreases the dissolved ozone concentration. Accordingly, the etch rate may limited by a low dissolved ozone concentration or a low surface reaction rate.

### BACKGROUND: MEDICAL INSTRUMENT STERILIZATION:

Humidified Ozone Gas Sterilization Method: Faddis, et. al discloses a technique for medical instrument sterilization with humidified ozone gas in U.S. Pat. No. 5,344,622 and U.S. Pat. No. 5,069,880. Karlson discloses a technique for medical instrument sterilization with humidified ozone gas in U.S. Pat. No. 5,069,880. This method has a number disadvantages including: 1) the high concentration ozone gas in the presence of water vapor can be corrosive to metals, 2) the high concentration ozone gas in the presence of water vapor is not compatible with many of the common plastic and elastomer materials used in the construction of medical devices, 3) the presence of high concentration ozone gas in the process tank presents a safety hazard to the users, and 4) the inactivation rate is relatively low because the surface reaction rate is relatively low.

Room Temperature Immersion Processing: Rickloff, 1987, and Omi, et. al A room temperature (20 deg. C.) immersion processor has a number of limitations: 1) the modest temperature produces a modest surface reaction rate, 2) the very low mass transport available in an immersion design with a very large stagnant layer thickness δ reduces the temperature at which the reaction becomes surface reaction rate limited, and 3) the inactivation rate is low because of the low surface reaction rate and low mass transport rate.

### SUMMARY OF INVENTION

In accordance with preferred embodiments of the invention, methods and apparatus are provided for treating materials which have broad advantages over prior systems and a very wide range of applications, including materials processing, wafer processing, medical instrument sterilization, and the like. In a first preferred embodiment, the method entails forming an ozone-solvent solution at a first temperature and reacting the ozone-solvent solution with the material at a second temperature and at a pressure that is elevated relative to ambient. The method involves heating the ozone-solvent solution from the first temperature to the second temperature to form a heated ozone-solvent solution, and applying the heated ozone-solvent solution to the material at approximately the second temperature at the elevated pressure. Applying it at the elevated pressure reduces the rate of loss of ozone from the ozone-solvent solution resulting from heating the ozone-solvent solution. Various apparatuses can be used to carry out these treatment processes.

In another preferred embodiment of the invention, a system is provided for treating a substrate with an ozone-solvent solution that comprises a supply of an ozone-solvent solution formed at a first temperature that delivers a generally continuous supply of the ozone-solvent solution at the first temperature. The system includes a heater coupled to receive the ozone-solvent solution at the first temperature from the supply and heats the ozone-solvent solution received, and provides a generally continuous supply of heated ozone-solvent solution. The system also includes a pressure regulator coupled to the outlet of the heater to maintain the heated ozone-solvent solution at a pressure that is elevated relative ambient, and an applicator fluidly coupled the outlet of the pressure regulator to receive the generally continuous supply of the heated ozone-solvent solution, the applicator having an outlet configured to direct the heated ozone-solvent solution at a second temperature greater than the first temperature toward a substrate.

A method is also presented for achieving a uniform etching of a substrate by insuring that the surface reaction rate of the ozone-solvent solution is much less than the mass transport rate over the substrate. That method can also be used to provide for uniform oxidation of oxidizable materials.

A method and apparatus are also provided for quickly achieving equilibrium concentrations of ozone in ozone-solvent solutions.

Outlined below are some of the advantages of the various processes and how they are achieved:
higher oxidation rate: provides a method for oxidizing materials using a solution of ozone gas dissolved in solvent which can produce much higher oxidation rates than can be achieved by current methods
environmentally benign chemical: provides a method for oxidizing materials at high speed which uses an environmentally benign, residue free chemistry thereby reducing chemical disposal cost
increased user safety and reduced chemical cost and reduced chemical disposal cost: provides a method for oxidizing materials at high speed where the oxidizing chemical can be created and destroyed at the point of manufacture thereby increasing user safety, reducing chemical cost and reducing chemical disposal cost
additional chemicals can be injected with minimal impact on dissolved ozone concentration or injected-chemical concentration: provides a method for oxidizing materials using a solution of ozone gas dissolved in a solvent which may include injecting additional chemicals which significantly reduce the time available for injected chemicals to react with the ozone-solvent solution and thereby minimizes any decrease in dissolved ozone concentration or injected chemical concentration caused by such a reaction.
different injected chemicals may be added to the ozone-water solution during different phases of the materials processing cycle: provides a method for oxidizing materials using a solution of ozone gas dissolved in water which may include a means to select the mix of chemical(s) that are dispensed onto the surface of the materials to be oxidized during a given phase of the materials processing cycle
DI water and other chemicals may be introduced in lieu of the ozone-water solution during different phases of the materials processing cycle: provides a method for oxidizing materials using a solution of ozone gas dissolved in water which may include a means for injecting chemicals or DI water in lieu of the ozone-water solution and thereby provide a means to selectively dispense chemicals or DI water onto the surface of the materials to be oxidized during a given phase materials processing cycle
   Wafer Processing Advantages

higher removal rates: provides a method for removing photoresist, post ash photoresist residue, post-etch residue, and other organic materials from semiconductor wafers, flat panel display substrates, and the like which can produce much higher removal rates than can be achieved by current methods

lower process temperature and lower corrosion potential: provides a method for removing photoresist, post ash photoresist residue, post-etch residue, and other organic materials from semiconductor wafers, flat panel display substrates, and the like which can produce much higher removal rates at lower temperatures than can be achieved by current methods and thereby reduce the potential for metal corrosion

practical throughputs in both single wafer and batch processing systems: provides a method for removing photoresist, post ash photoresist residue, post-etch residue, and other organic materials from semiconductor wafers, flat panel display substrates, and the like which can achieve practical throughputs in both single wafer processing systems and batch wafer processing systems

readily retrofitted at low marginal cost: provides a method for removing photoresist, post ash photoresist residue, post-etch residue, and other organic materials from semiconductor wafers, flat panel display substrates, and the like which can be readily retrofitted at low marginal cost to many existing single wafer and batch wafer spin processing tools

readily integrated into a cluster tool: provides a method for removing photoresist, post ash photoresist residue, post-etch residue, and other organic materials from semiconductor wafers, flat panel display substrates, and the like which can be readily integrated into a cluster tool comprising multiple processes in a single platform

readily integrated with a spin rinse and spin dry step: provides a method for removing photoresist, post ash photoresist residue, post-etch residue, and other organic materials from semiconductor wafers, flat panel display substrates, and the like which can be readily integrated with a spin rinse and spin dry step provides the basis of a dry-in dry-out cleaning process

low cost processing chamber: provides a method for removing photoresist, post ash photoresist residue, post-etch residue, and other organic materials from semiconductor wafers, flat panel display substrates, and the like which does not require that high concentration ozone gas be introduced into the process chamber thereby significantly reducing the cost of the wafer processing chamber.

increased user safety: provides a method for removing photoresist, post ash photoresist residue, post-etch residue, and other organic materials from semiconductor wafers, flat panel display substrates, and the like which does not require that high concentration ozone gas be introduced into the process chamber thereby significantly increasing user safety

reduced corrosion potential: provides a method for removing photoresist, post ash photoresist residue, post-etch residue, and other organic materials from semiconductor wafers, flat panel display substrates, and the like which does not require that high concentration ozone gas be introduced into the process chamber thereby eliminating high concentration ozone gas as a source of corrosion

nitrogen blanketed process chamber: provides a method for removing photoresist, post ash photoresist residue, post-etch residue, and other organic materials from semiconductor wafers, flat panel display substrates, and the like in which an inert gas such a nitrogen can be introduced into the process chamber

increased user safety: provides a method for removing photoresist, post ash photoresist residue, post-etch residue, and other organic materials from semiconductor wafers, flat panel display substrates, and the like in which the dissolved ozone concentration quickly falls to very low levels immediately downstream of the point of application thereby further increasing user safety

Medical Instrument Sterilization Advantages

higher sterilization rates: provides a method for sterilization of medical instruments at moderate temperatures which can achieve much higher sterilization rates than can be achieved by current methods

residue free sterilant: provides a method for sterilization of medical instruments at moderate temperatures which utilizes a residue free sterilant and thereby eliminate the risk of carry-over of sterilant chemical residue to the patient and reduce the cost of chemical disposal

no water rinse required: provides a method for sterilization of medical instruments at moderate temperatures which utilizes a residue free sterilant and thereby eliminate the need for a separate water rinse step.

increased user safety and reduced chemical cost and reduced chemical disposal cost: provides a method for sterilization of medical instruments at moderate temperatures in which the active component is created for each cycle and then destroyed at end of the cycle thereby increasing user safety, decreasing chemical cost, and decreasing chemical disposal cost

lower consumables cost: provides a method for sterilization of medical instruments at moderate temperatures which has a lower consumables cost ($.50 per cycle) than leading processes.

single-use sterilant always at full concentration: provides a method for sterilization of medical instruments at moderate temperatures which is a single pass design in which sterilant is sprayed onto instrument surfaces and then sent to the drain thereby eliminating the degradation in the sterilant concentration otherwise caused by the retention in the sterilant solution of serum and other organic residue washed from the processed instruments

low cost sterilization processing chamber: provides a method for sterilization of medical instruments at moderate temperatures which does not require that high concentration ozone gas be introduced into the process chamber thereby significantly reducing the cost of the wafer processing chamber.

increased user safety: provides a method for sterilization of medical instruments at moderate temperatures which does not require that high concentration ozone gas be introduced into the process chamber thereby significantly increasing user safety

reduced potential for instrument materials degradation: provides a method for sterilization of medical instruments at moderate temperatures which does not require that high concentration ozone gas be introduced into the process chamber thereby eliminating high concentration ozone gas as a source of corrosion of metals or degradation of elastomers or plastics.

reduced potential for instrument materials degradation provides a method for sterilization of medical instruments at moderate temperatures in which an inert gas such a nitrogen can be introduced into the process chamber thereby eliminating high concentration ozone gas as a source of corrosion of metals or degradation of elastomers or plastics.

increased user safety: provides a method for sterilization of medical instruments at moderate temperatures in which the dissolved ozone concentration quickly falls to very low levels immediately downstream of the point of application thereby further increasing user safety

applicable to complex shaped instruments with internal passages with large L/D: provides a method for sterilization of medical instruments at moderate temperatures which can be used with complex shaped items, or items containing internal surfaces, such as rigid and flexible endoscopes with internal passages with a large length to diameter ratio L/D.

### BRIEF DESCRIPTION OF DRAWINGS

The various features of the present invention and its preferred embodiments may be better understood by referring to the following discussion and the accompanying drawings in which like reference numerals refer to like elements in the several figures.
FIG. 1A illustrates a functional block diagram of a method of processing materials: A cold ozone-water solution at temperature T1 is heated to temperature T2>T1 using a liquid to liquid heat exchanger just upstream of the point of application of the ozone-water solution to the material to be processed.

FIG. 1B illustrates a functional block diagram of a method of processing materials: A cold ozone-water solution at temperature T1 is heated to temperature T2>T1 using a liquid to liquid heat exchanger just upstream of the point of application of the ozone-water solution to the material to be processed and a back pressure regulator positioned downstream of the heat exchanger.

FIG. 2 illustrates a functional block diagram of a method of processing materials: A cold ozone-water solution at temperature T1 is heated to temperature T2>T1 using a point-of-use heater just upstream of the point of application of the ozone-water solution to the material to be processed.

FIG. 3 illustrates a functional block diagram of a method of processing materials in which additional chemicals are injected into the ozone-water solution just upstream of the point of application.

FIG. 4 illustrates a functional block diagram of a method of processing materials with multiple chemical injection supplies.

FIG. 5A illustrates a block diagram of a method of processing semiconductor wafers with a single-wafer spin processor.

FIG. 5B illustrates a block diagram of a method of processing semiconductor wafers with a single-wafer spin processor with a liquid back pressure regulator in the drain outlet line and a gas back pressure regulator in the vent outlet line.

FIG. 6 illustrates a functional block diagram of a method of processing materials with upper and lower rotating spray arms (dishwasher geometry).

FIG. 7 illustrates a functional block diagram of a method of processing materials with an immersion design.

FIG. 8A illustrates a schematic diagram of a cross sectional view of a single substrate spin processing module with a gas back pressure regulator in the vent line and a series of liquid pressure dropping orifices around the perimeter of the module to provide a means to operate the module at pressures above atmospheric. The module housing is circular in top view (not shown).

FIG. 8B illustrates a schematic diagram of a cross sectional view of a single substrate spin processing module with a gas back pressure regulator in the vent line and a pressure dropping element around the perimeter of the module to provide a means to operate the module at pressures above atmospheric. The module housing is circular in top view (not shown).

FIG. 8C illustrates a schematic diagram of a cross sectional view of a single substrate spin processing module with a gas back pressure regulator in the module vent line and a liquid back pressure regulator in the module drain line to provide a means to operate the module at pressures above atmospheric. The module housing is circular in top view (not shown).

FIG. 9 illustrates a block diagram of a method of dissolving ozone gas into chilled water using a venturi injector and downstream bubble column to form an ozone-water solution.

FIG. 10 illustrates a block diagram of a method of dissolving ozone gas into chilled water using a packed column to form an ozone-water solution.

### DETAILED DESCRIPTION OF THE PREFERRED EMBODIMENTS

Factors Determining Oxidation Rate or Removal Rate—A Model

The inventors have developed a model to help better understand the factors determining oxidation and removal rate of an organic material such as photoresist from a semiconductor wafer using an ozone-solvent solution at concentration C and temperature T. The rate of oxidation and removal of an organic layer from a substrate can be defined in terms of an etch rate. We can write an expression for the etch rate E (cm resist/sec) as E=C*(X/ρ)*(M*S)/(M+S). The parameter C (g ozone/cm3) is the dissolved ozone concentration in the water far from the surface of the organic layer on a semiconductor wafer for example (the bulk concentration). The parameter X (g resist/g Ozone) is the mass of resist removed per mass of ozone consumed at the surface. If we assume that the resist is composed of chains of CH2 units which must be fully oxidized to be removed, then 3 moles of ozone are required to oxide each mole of CH2. This corresponds to 10.3 grams of ozone to fully oxidize each gram of resist. Christensen (1998) was the first to observe that etch rates for I-line photoresist are a factor of 20 higher than that predicted by the assumption of full oxidation. They concluded that the resist need only be cut into short fragments about 20 CH2 units long before the fragments become hydrophilic and float off the wafer into the stream of flowing water. The net result is that the parameter X is not (1/10.3) but about (20/10.3). The parameter ρ (g resist/cm3) is the density of the resist.

Terminology: Throughout this discussion the terms ozonated water, ozone-water solution, and ozone-gas-water solution are used interchangeably. In addition, the terms etch, etch clean, clean, process, oxidize are used interchangeably. DI water is De-ionized water

Dissolved Ozone Concentration C: When ozone is dissolved in a solvent, the maximum dissolved ozone concentration C that can be achieved after a sufficiently long transfer time, the saturation concentration, is predicted by Henry's law. According to Henry's law, the maximum solubility is proportional to the partial pressure of the ozone gas at a given temperature. Higher gas phase concentrations, high pressures, and lower solvent temperatures yield higher maximum equilibrium dissolved ozone concentrations. We have calculated the approximate equilibrium saturation concentration in mg/L (equivalent to parts per million by weight) for a gas phase concentration of 240 mg/L (15.9 weight percent), pressures of 1, 2, and 4 bar, and water (solvent) temperatures of 5 to 95 degree C. in 5 deg. C. increments. See Table 1.

TABLE 1
Solubility of ozone gas in water: The dissolved ozone concentration in
mg/L as a function of the water temperature and gas pressure for a gas
phase ozone concentration of 240 g/Nm3 = mg/liter (15.9 weight
percent) in oxygen for a range of water temperatures.

| | p = 1 bar | p = 2 bar | p = 4 bar |
|---|---|---|---|
| | (14.5 psia) | (29 psia) | (58 psia) |
| 5 deg. C. | 109 | 218 | 436 |
| 10 deg. C. | 85 | 170 | 340 |
| 15 deg. C. | 66 | 132 | 264 |
| 20 deg. C. | 52 | 104 | 208 |
| 25 deg. C. | 40 | 80 | 160 |
| 30 deg. C. | 31 | 62 | 124 |
| 40 deg. C. | 24 | 48 | 96 |
| 45 deg. C. | 19 | 38 | 76 |
| 50 deg. C. | 15 | 30 | 60 |
| 55 deg. C. | 11 | 22 | 44 |
| 60 deg. C. | 9 | 18 | 36 |
| 65 deg. C. | 7 | 14 | 28 |
| 70 deg. C. | 5 | 10 | 20 |
| 75 deg. C. | 4 | 8 | 16 |
| 80 deg. C. | 3 | 6 | 12 |
| 85 deg. C. | 2.5 | 5 | 10 |
| 90 deg. C. | 1.2 | 2.4 | 4.8 |
| 95 deg. C. | .9 | 1.8 | 3.6 |

Mass Transport Rate Coefficient M: The parameter M (cm/sec) is the liquid phase mass transport rate coefficient. The ozone is transported to the wafer surface by diffusion. The mass transport rate M (cm/sec)=D/δ, where D (cm2/sec) is the diffusion constant of the ozone diffusing in the liquid and δ (cm) is the thickness of the stagnant layer. The diffusion constant D for ozone in water is 1.7E-5 cm2/sec at 20 deg. C. Accordingly the mass transport rate is increased when the diffusion constant is increased and/or the diffusion distance δ is decreased.

Surface Reaction Rate Constant S: The parameter S(cm/sec) is the temperature dependent surface reaction rate constant. The surface reaction rate S (cm/sec) is an exponential function of the absolute temperature T (deg. K) and the activation energy Ea of the oxidation process. In particular, S=Soexp(−Ea/KT) where K is Boltzman's constant and So is the surface reaction rate proportionality constant. The difference in etch rates of different materials at a given temperature is attributed to the difference in the magnitude of the surface reaction rate constant for the two materials.

Etching Wafers at High Temperature: An increase in temperature will increase S and the magnitude of the term (M*S)/(M+S). If the dissolved concentration remained approximately constant with an increase in temperature, then we can see that the etch rate would increase with increased temperature. However, as we have seen, the dissolved ozone concentration falls with increases in water temperature. If the temperature is such that S>>M, the etch rate becomes mass transport limited and E=C(X/ρ)*M. If M is larger, then the temperature at which the etch rate becomes limited by the mass transport rate M will be higher. If the temperature is higher, then the mass transport rate at which the etch rate will become mass transport limited will be higher.

Etching Wafers at Low Temperature: A decrease in temperature will decrease S and the magnitude of the term (M*S)/(M+S). If the dissolved concentration remained approximately constant with decreases in temperature, then we can see that the etch rate would decrease with a decrease in temperature. However, as we have seen, the dissolved ozone concentration rises with decreases in water temperature. If the temperature is decreased until S<<M, the etch rate becomes surface reaction rate limited and E=C(X/ρ)*S.

Measured Temperature Dependence of S: We made a preliminary measurement of the temperature dependence of the surface reaction rate S in our laboratory. We made the measurements of the etch rate of IBM Apex positive DUV resist under conditions where M>>S and E=SCX by etching a spinning wafer with a small diameter nozzle to produce high velocities and small values of δ. We measured the etch rate at 7 deg. C., 12 deg. C., and 17 deg. C. Our measurements showed that the surface reaction rate coefficient S (cm/sec) increases by a factor of two for every 5 degree C. increase in temperature corresponding to an activation energy of about 1 eV. We found the same activation energy but larger coefficient So for Shipley 1805 positive I-line resist. This is consistent with I-line positive resist etching faster than DUV positive photoresist.

Measured Etch Rate at Different Temperatures: Our initial measured results show that the etch rate increases when the temperature is increased from 10 deg. C. to 19 deg. C. because the normalized etch rate E/C increases by a larger factor than the dissolved ozone concentration decreases. However, when the temperature is increased from 19 deg. C. to 28 deg. C., the dissolved ozone concentration decreases by a larger factor than the normalized etch rate decreases. This trend continues at all higher temperatures with the result that under equilibrium conditions the highest etch rate is achieved at about 20 deg. C.

An Approach to Achieving Very High Etch Rates: This model can provide us valuable insight into the problem. It shows that the normalized etch rate be increased by increasing the temperature and that the etch rate could be increased by increasing the temperature above 20 degree C. if we could find a method to provide a higher dissolved concentration at the elevated temperature. The present preferred embodiments utilize just such a method.

The general principal is to achieve the highest dissolved ozone concentration at a given surface reaction temperature. This can be done in a number of ways including the following:
a) heat the cold ozone-solvent solution with an in-line heater located just upstream of the point at which the ozone-solvent solution is dispensed onto the substrate. The heated ozone-solvent solution will then heat the surface of the substrate and increase the surface reaction rate. The ozone-solvent solution will retain most of the ozone dissolved at the lower temperature if the solution is not heated until the last moment.
b) heat the cold ozone-solvent solution at the point of application with a point of application heater as the solution passes over the substrate surface by for example using a radiant heater with the wavelength band chosen to be absorbed by the ozone-solvent solution. The heated ozone-solvent solution will then heat the surface of the substrate and increase the surface reaction rate.
c) heat the substrate with a point of application heater and dispense the cold ozone-solvent solution onto the surface of the heated substrate. Provide sufficient heat input to the substrate to overcome cooling effect of the cold solvent. In practice the substrate can be heated from the backside or from the front side. If the substrate is heated from the backside, the entire volume of the substrate may be heated so that the front surface, the surface to be etched, can be heated. If the substrate is heated from the front side, the entire volume of the substrate may be heated or only the front surface may be heated. The surface reaction rate at the front surface is a function of the temperature of the front surface.
d) heat the cold ozone-solvent solution and heat the substrate by for example using a radiant heater with the wavelength band chosen to be absorbed partially by the ozone-solvent solution and partially by the substrate.

The substrate surface can be heated by conduction, convection, or radiation. The surface can be heated by conduction using a heated surface such as a hot plate. The surface can be heated by convection using a hot gas or hot liquid to the front or rear surface. The substrate can be heated by radiation using a heat lamp or laser or other source of radiation. The radiation wavelength band can be chosen so that the radiation passes through the ozone-water solution with little energy deposition in the water and the majority of the energy absorbed in the surface. In fact the radiation can be chosen to be most strongly absorbed in the layer to removed (photoresist for example).

Factors Determining Oxidation Rate or Oxide Growth Rate—A Model:

A similar expression can be written for the growth rate of a material such as an oxide on semiconductor wafer, or an oxide on a metal such as copper or aluminum, using an ozone-solvent solution at concentration C and temperature T. The rate of oxidation and removal of an organic layer from a substrate can be defined in terms of an etch rate. We can write an expression for the growth rate G of a material such as an oxide for example(cm oxide/sec) as G=C*(X/ρ)*(M*S)/(M+S). The parameter C (g ozone/cm3) is the dissolved ozone concentration in the water far from the surface of the growing film on a semiconductor wafer for example (the bulk concentration). The parameter X (g oxide/g Ozone) is the mass of oxide grown per mass of ozone consumed at the growing surface.

Mass Transport Rate Coefficient M: As the film grows, the ozone diffuses through the oxide to the interface between the oxide and the unoxidized metal. Accordingly, the mass transport M is determined not only by transport rate M1 of ozone through the boundary layer of thickness δ, but is also by the transport rate M2. The parameter M1 (cm/sec) is the liquid phase mass transport rate coefficient. The ozone is transported to the wafer surface by diffusion. The mass transport rate M1 (cm/sec)=D/δ, where D (cm2/sec) is the diffusion constant of the ozone diffusing in the liquid and δ (cm) is the thickness of the stagnant layer. The parameter M2 (cm/sec) is the solid phase mass transport rate coefficient. The ozone is transported to the growing film (oxide in this example) surface by diffusion through the oxide to the underlying metal surface. The mass transport rate M2 (cm/sec)=D/t , where D (cm2/sec) is the diffusion constant of the oxidizing species (ozone for example) diffusing in the solid (oxide in this example) and t (cm) is the thickness of the growing oxide layer. In this case, the total mass transport rate M=(M1*M2)/(M1+M2) since 1/M=1/M1+1/M2.

Surface Reaction Rate Constant S: The parameter S(cm/sec) is the temperature dependent surface reaction rate constant. The surface reaction rate S (cm/sec) is an exponential function of the absolute temperature T (deg. K) and the activation energy Ea of the oxidation process. In particular, S=Soexp(−Ea/KT) where K is Boltzman's constant and So is the surface reaction rate proportionality constant. The difference in growth rates of different materials at a given temperature is attributed to the difference in the magnitude of the surface reaction rate constant for the two materials. Since the growth of a film such an oxide is also dependent upon the rate of diffusion of the oxidizing species in the solid film, the growth rate is also material dependent because of the material dependence of that diffusion constant.

Film Growth at High Temperature: An increase in temperature will increase S and the magnitude of the term (M*S)/(M+S). If the dissolved concentration remained approximately constant with an increase in temperature, then we can see that the growth rate would increase with increased temperature. However, as we have seen, the dissolved ozone concentration falls with increases in water temperature. If the temperature is such that S>>M, the growth rate G becomes mass transport limited and G=C(X/ρ)*M. If M is larger, then the temperature at which the growth rate becomes limited by the mass transport rate M will be higher. If the temperature is higher, then the mass transport rate at which the growth rate will become mass transport limited will be higher.

Oxide Film Growth at Low Temperature: A decrease in temperature will decrease S and the magnitude of the term (M*S)/(M+S). If the dissolved concentration remained approximately constant with decreases in temperature, then we can see that the growth rate would decrease with a decrease in temperature. However, as we have seen, the dissolved ozone concentration rises with decreases in water temperature. If the temperature is decreased until S<<M, the growth rate G becomes surface reaction rate limited and G=C(X/ρ)*S.

An Approach to Achieving Very High Growth Rates: The approach to achieving very high growth rates is the same as that described above for achieving very high etch rates when treating a substrate with an ozone-solvent solution.

Treating Wafers and Other Substrates when S<<M: A decrease in temperature will decrease S and the magnitude of the term (M*S)/(M+S). If the dissolved concentration remained approximately constant with decreases in temperature, then we can see that the etch rate would decrease with a decrease in temperature. However, as we have seen, the dissolved ozone concentration rises with decreases in water temperature. If the temperature is decreased until S<<M, the etch rate or oxide growth rate becomes surface reaction rate limited and etch rate E=C(X/ρ)*S and oxide growth rate G=C(X/ρ)*S. The inventor have measured the etch rate for I-line and DUV photoresist in a spin processing configuration at 4000 RPM and shown that the etch rate is nearly constant with radius at an application temperature of 10 degree C. In a spin processing configuration in which an ozone solvent solution is applied to the surface of a substrate which is rotated about an axis normal to the substrate, M is not generally constant with radius whereas the temperature and corresponding surface reaction rate can be relatively constant with radius. In this case one can achieve etch rates or growth rates which are constant with radius by processing at lower temperatures or other conditions under which the reaction is surface reaction rate limited. In this case in which the mass transport rate is not constant, the criteria for the reaction being surface reaction rate limited is that S<<Mmin, where Mmin is the lowest value of M. There are a number of other processing configurations in which the mass transport rate is not constant over all the reaction sites but the temperature is constant which can benefit from a similar approach for achieving constant reaction rates over all the reaction sites by operating under surface reaction rate limited conditions.

There are other means other than reducing temperature for reducing the surface reaction rate S. For example, we have shown that a change in pH can reduce the surface reaction rate S. In additional, any condition that produces a small value of So can yield a low value of S such that S<<M where M*S/(M+S)˜S.

A general method and apparatus for treating materials at high speed comprises the steps of dissolving a relatively high concentration ozone gas in a solvent at a relatively low predetermined temperature T1 to form an ozone-solvent solution with a relatively high dissolved ozone concentration, and heating either the ozone-water solution or the material to be treated or both, the ozone-solvent solution and the material to be oxidized with a point-of-use heater to quickly increase the temperature to a predetermined higher temperature T2>T1, and applying the ozone-solvent solution to said material(s) whereby the heated ozone-water solution will have a much higher dissolved ozone concentration at said higher temperature, than could be achieved if the ozone gas was initially dissolved in water at said higher temperature

Factors Determining the Dissolved Ozone Concentration at T2—A Model

the concentration at temperature T2 after time t is the initial concentration (when the ozone-solvent solution is initially formed at temperature T1) minus the product of rate of loss of ozone from solution and the time for that loss to occur

the loss is smaller if the time is smaller (short heating time and transport time to substrate ) and/or the rate of loss is smaller

the rate of loss is smaller if the driving force for the loss is smaller

conditions of ozone concentration and pressure above the heated solution which correspond to approximately the same equilibrium concentration as the initial concentration reduce the driving force

reducing the rate of decay of the ozone gas concentration (lower max temperature) increases the partial pressure of ozone above the solution

reducing the amount of dilution of the ozone gas by ambient gas (small confined gas volume above the material to be treated) increases the partial pressure of ozone above the solution

increasing the pressure of the ozone gas above the solution (higher back pressure downstream of the heated ozone-solvent solution) increases the partial pressure of ozone above the solution

The rate of loss is small if the diffusion rate is smaller (lower max temperature)

The rate of loss is smaller if the interfacial area for loss is smaller (smooth surfaces in contact with solution in lieu of non-smooth surfaces with multiple bubble nucleation sites)

The rate of loss is smaller if the interfacial area for loss is smaller (single solid dispense stream with a low surface to volume ration in lieu of multiple streams with a larger surface to volume ratio)

The Role Of Back Pressure—A Model

1. Use of a nozzle, needle valve, orifice, back pressure regulator, or other pressure dropping element at a point down stream of the in-line heater can reduce the rate of loss of the ozone gas from the heated ozone-solvent solution.
the use of a back pressure regulator or pressure dropping element downstream of the in-line heater can reduce the rate of loss of the ozone gas from the heated ozone-solvent solution both for the case in which the ozone gas is dissolved at a pressure p≦1.0 bar p>1.0 bar.
the back pressure regulator or pressure dropping orifice can be placed at the outlet of the in-line heater
the back pressure regulator or pressure dropping orifice can be placed just upstream of the dispense nozzle
the back pressure regulator or pressure dropping orifice can be placed downstream of the point of application of the ozone-solvent solution to the material to be oxidized
the back pressure regulator or pressure dropping orifice can be placed downstream of the point of application of the ozone-solvent solution to the material to be oxidized at the outlet of a closed processing chamber

2. We can estimate the magnitude of back pressure for minimizing the loss of ozone gas from the heated solution. Let us consider some examples.
Case 1. Ozone-solvent solution initially formed by dissolving ozone gas to full saturation concentration (using a recirculating contactor for example): If an ozone-solvent solution is first formed by dissolving in a solvent at temperature T1, ozone gas at a concentration Cg1 and absolute pressure p1, where the saturation dissolved ozone concentration C in the solvent is determined by Henry's law from Cg1, T1, and P1. For example, if Cg1=240 mg/L, and T1=10 degree C., and P1=1 bar, then the dissolved ozone concentration at saturation is approximately 85 mg/liter. (See Table 1.) The rate of transport of ozone gas into solution is equal to (Csat−C)Ai/D where C is the dissolved concentration at a given time t, Csat is the saturation concentration as determined by Henry's law, D is Diffusion constant for ozone gas in the solvent, and Ai is the interfacial area for transport into solution in the ozone-solvent contactor. Accordingly, the dissolved concentration approaches saturation with an exponential time dependence.
Case 1A: If the ozone solvent solution formed above under case 1 is heated to a temperature T2, and the back pressure P3 is set to 1 bar, then the new equilibrium dissolved ozone concentration is determined by Henry's law from Cg2, T2, and P3. For example, if Cg2=Cg1=240 mg/L, and T2=40 degree C., and P3=1 bar, then the dissolved ozone concentration predicted by Henry's law data is approximately 24 mg/liter. (See Table 1.) The concentration of the solution formed at T1 will fall toward this equilibrium concentration. Again, the rate of transport of ozone gas into solution is equal to (Csat−C)Af*D where C is the dissolved concentration, Csat is the saturation concentration as determined by Henry's law, and D is Diffusion constant for ozone gas in the solvent, and Af is the interfacial area for transport from solution. Accordingly, the dissolved concentration approaches saturation (equilibrium) with an exponential time dependence. Since the initial dissolved ozone concentration C is now greater than that predicted by Henry's law, the rate of transport into solution is negative and ozone gas is lost from solution at the rate predicted by the same relationship where Af is the new interfacial area over which ozone gas can be lost from the heated ozone-solvent solution, and Cg2, and P3 is the new ozone gas concentration and pressure of ozone gas above the heated solution, and D is the diffusion constant at temperature T2. We can see that the greater the driving force, the higher the diffusion constant, and the larger the interfacial area, the faster the rate of loss of ozone from solution.
Case 1B: If the ozone solvent solution formed above under case 1 is heated to a temperature T2, and the back pressure P3 is set to P=85/24=3.54 bar, then the new equilibrium dissolved ozone is determined by Henry's law from Cg2, T2, and P3. For example, if Cg2=Cg1=240 mg/L, and T2=40 degree C., and P3=3.54 bar, then the dissolved ozone concentration predicted by Henry's law data is approximately 85 mg/liter. We can then see based upon the analysis under case 1A above that the rate of loss of ozone from solution is approximately zero since the driving force is approximately zero since the initial dissolved ozone concentration is equal to the equilibrium dissolved concentration at the new temperature and pressure and ozone gas concentration (ozone gas partial pressure). This assumes that thermal decay of the ozone is minimal and Cg2=Cg1. In general, Cg2<Cg1, and the dissolved ozone concentration will be lower. Accordingly, the installation of a nozzle, needle valve, orifice, back pressure regulator, or other pressure dropping element at a point down stream of the in-line heater can reduce the rate of loss of the ozone gas from the heated ozone-solvent solution. The rate of loss can be minimized when the back pressure is set to a value as determined using the above teaching. If the pressure is set at a lower value, then the rate of loss can be higher. In most cases, the provision of a back pressure above 1 bar absolute will serve to reduce the rate at which the concentration of the heated solution will decay.
Case 2. Ozone-solvent solution initially formed by dissolving ozone gas to less than full saturation concentration (using a single pass contactor for example): If an ozone-solvent solution is first formed by dissolving in a solvent at temperature T1, ozone gas at a concentration Cg1 and absolute pressure p1, where the dissolved ozone concentration C in the solvent may be less than that determined by Henry's law from Cg1, T1, and P1 if the solution is not at full saturation concentration. A single pass contactor does not typically dissolve ozone in the solvent to the saturation concentration. The saturation concentration is approached exponentially. For example, if Cg1=240 mg/L, and T1=10 degree C., and P1=4 bar, then the dissolved concentration may only be 85 mg/L which is much less than the predicted saturation concentration of 340 mg/L. (See Table 1). Again, the rate of transport of ozone gas into solution is equal to (Csat−C)Ai/D where C is the dissolved concentration at a given time t, Csat is the saturation concentration as determined by Henry's law, D is Diffusion constant for ozone gas in the solvent, and Ai is the interfacial area for transport into solution in the ozone-solvent contactor. Accordingly, the dissolved concentration approaches saturation with an exponential time dependence. However, since the increased pressure increases the saturation concentration, the rate of transport into solution is a factor of 4 higher. The single pass contactor residence time is typically set to achieve a concentration less than the saturation concentration. A single pass contactor can utilize the high rate of transport that is available in the initial phase of the exponential rise.

In this example we have assumed conditions in which the single pass contactor produces an concentration at the outlet of 70 mg/L which is the same as that which is achieved by the recirculating contactor dissolving ozone to saturation at the same temperature. This is to illustrate the use of a pressurized contactor to quickly achieve a concentration at 10 degree C. that is equal to the equilibrium saturation concentration at 10 degree C. In general, a single-pass pressurized contactor operating at a pressure P>1 bar and temperatureT=T1 can produce a continuous flow of an ozone-water solution at a concentration C which may be less than, equal to, or greater than the equilibrium saturation concentration at P=1 bar and T=T1 depending upon the design of the contactor and the contactor residence time.
Case 2A: If the ozone solvent solution formed above under case 2 is heated to a temperature T2, and the back pressure P3 is set to 1 bar, then new dissolved ozone concentration is determined by Henry's law from Cg2, T2, and P3. For example, if Cg2=Cg1=240 mg/L, and T2=40 degree C., and P3=1 bar, then the dissolved ozone concentration predicted by Henry's law data is approximately 24 mg/liter. (See Table 1.) Since the initial dissolved ozone concentration C is now greater than that predicted by Henry's law, the rate of transport into solution is negative and ozone gas is lost from solution at the rate predicted by the same relationship where A is the new interfacial area, and Cg2 is the new concentration of ozone gas, and P3 is pressure of ozone gas above the solution, and D is the diffusion constant at temperature T2. We can see that the greater the driving force, the higher the diffusion constant, and the larger the interfacial area, the faster the rate of loss of ozone from solution.
Case 2B: If the ozone solvent solution formed above under case 2 is heated to a temperature T2, and the back pressure P3 is set to p=85/24=3.54 bar, then the new equilibrium dissolved ozone is determined by Henry's law from Cg2, T2, and P3. For example, if Cg2=Cg1=240 mg/L, and T2=40 degree C., and P3=2.9 bar, then the dissolved ozone concentration predicted by Henry's law data is approximately 85 mg/liter. We can then see based upon the analysis above that the rate of loss of ozone from solution is approximately zero since the driving force is approximately zero since the initial dissolved ozone concentration is equal to the equilibrium dissolved concentration at the new temperature and pressure and ozone gas concentration (ozone gas partial pressure). This assumes that thermal decay of the ozone is minimal and Cg2=Cg1. In general, Cg2<Cg1, and the dissolved ozone concentration will be lower. Accordingly, the installation of a nozzle, needle valve, orifice, back pressure regulator, or other pressure dropping element at a point down stream of the in-line heater can reduce the rate of loss of the ozone gas from the heated ozone-solvent solution. The rate of loss can be minimized when the back pressure is set to a value as determined using the above teaching. If the pressure is set at a lower value, then the rate of loss can be higher. In most cases, the provision of a back pressure above 1 bar absolute will serve to reduce the rate at which the concentration of the heated solution will decay.

In the above discussion, P1 is the pressure at which the ozone gas is initially dissolved in water or other solvent, P3 is the pressure above the heated ozone-solvent solution downstream of the in-line heating means, and P2 is the pressure above the heated ozone-solvent solution at the point of application of the ozone solvent solution to the substrate or material to be treated. In some embodiments in which the back pressure regulator(s) are placed at the outlet(s) of the materials processing module, P2 can be approximately equal to P3.

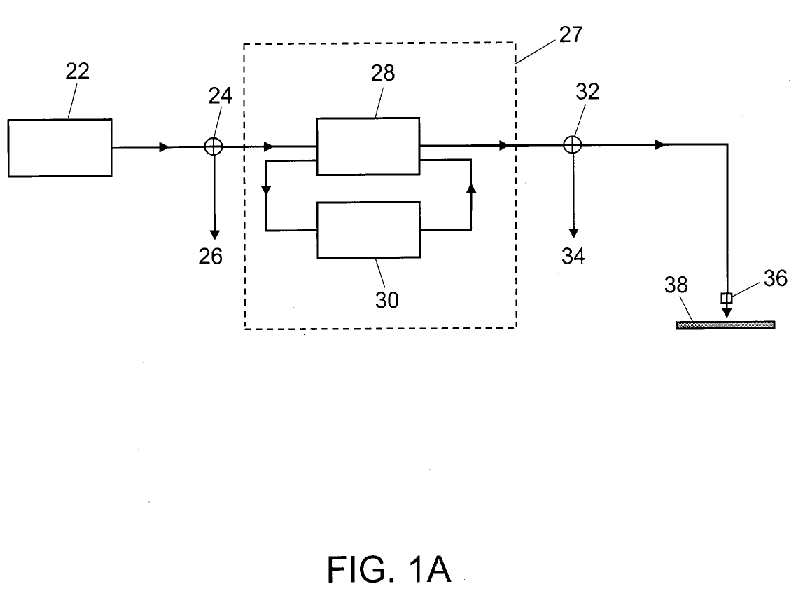

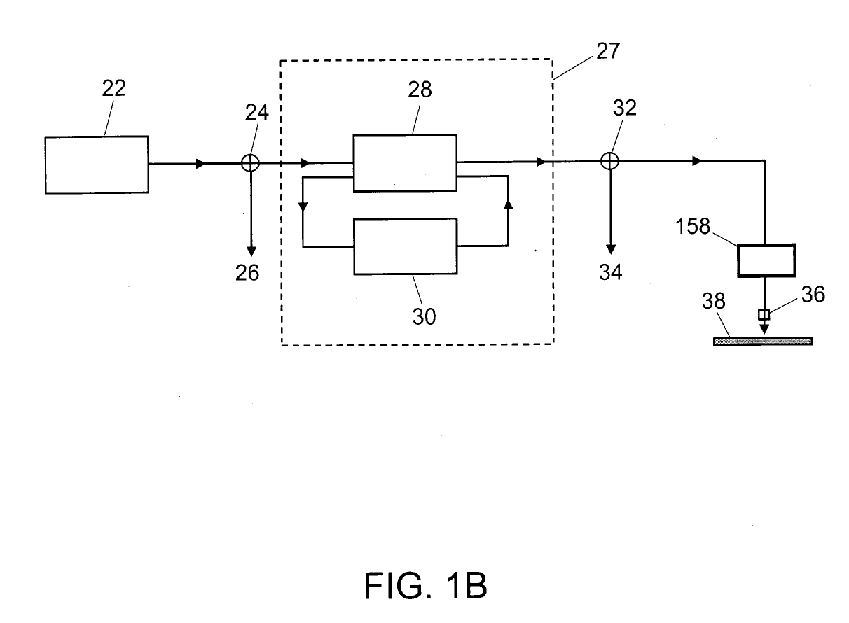

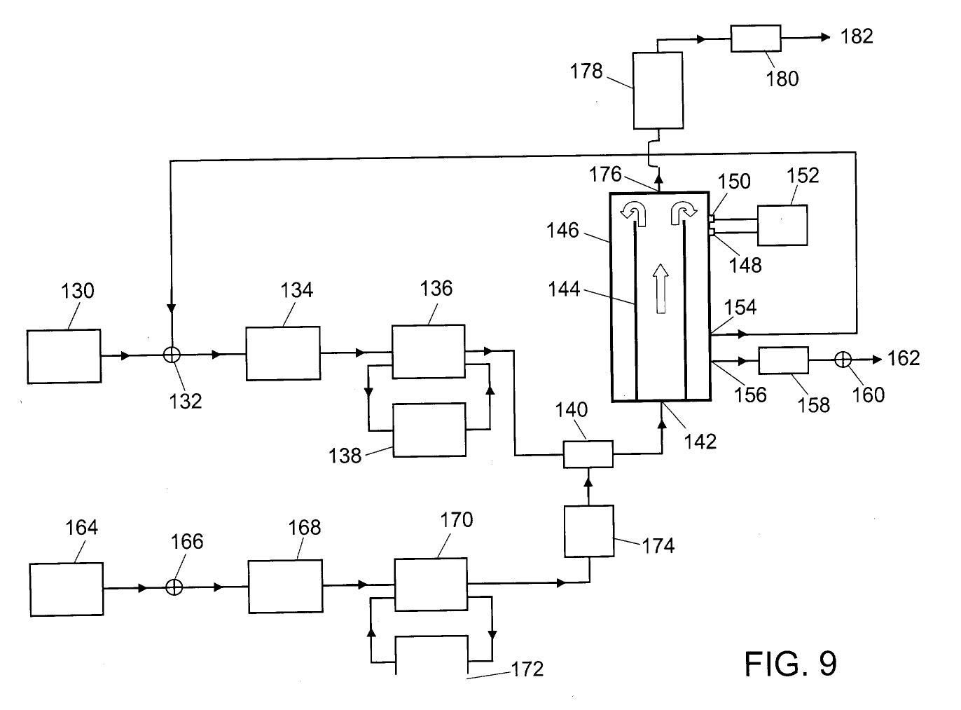

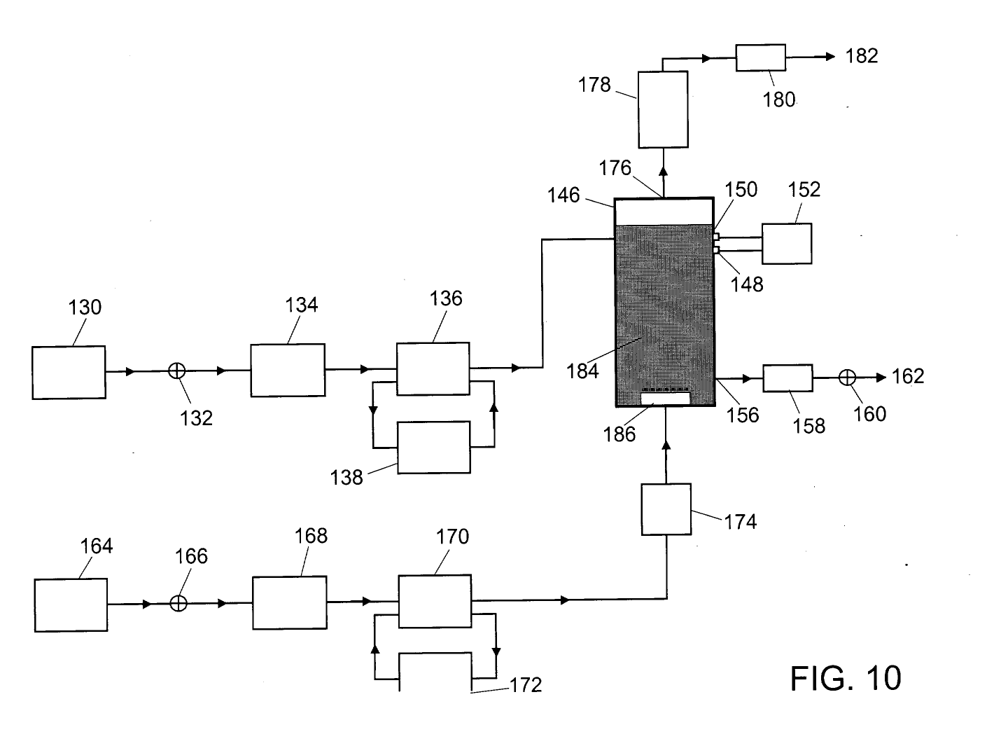

The description of the preferred embodiments for oxidizing materials at high speed is divided into three groups
1st GROUP: Heat Applied Just Upstream of the Point of Application (FIG. 1 through FIG. 8)
2^{nd} GROUP: Heat Applied at the Point of Application (these embodiments are described in a prior patent application by the inventor)
3^{nd} GROUP: High Performance Ozonated Water Supply for Use in Conjunction with the Preferred Embodiments (FIG. 9 and FIG. 10)
   1st GROUP: Heat Applied Just Upstream of the Point of Application (FIG. 1A through FIG. 8C)

A first preferred method for oxidizing materials at high speed using a solution of ozone gas dissolved in solvent comprising the steps of dissolving relatively high concentration ozone gas in solvent at a relatively low predetermined temperature T1 to form an ozone-solvent solution with a relatively high dissolved ozone concentration, and heating the ozone-solvent solution with a point-of-use heater to quickly increase the solution temperature to a predetermined higher temperature T2>T1, and applying the heated ozone-solvent solution to said material(s). The first method for oxidizing materials at high speed may additionally includes a injector/mixer for injecting and mixing additional chemicals into the ozone-solvent solution just upstream of the point of application of the ozone-solvent solution to the materials to be oxidized. A number of preferred embodiments are illustrated in FIG. 1A through FIG. 8C.

Materials Processing Method W/Ozone-Solvent Solution Heated W/Heat Exchanger

Description—FIG. 1A With reference to FIG. 1A, an ozonated water supply 22 is connected through a length of tubing to the common input of a three-way valve 24. The one outlet of three-way valve 24 is connected through a length of tubing to the cold process fluid inlet of a heat exchanger 28. The other outlet of three-way valve 24 is connected through a length of tubing to the facility drain-reclaim inlet 26 for the ozone-water solution. The heated working fluid outlet of a recirculating heating unit 30 is connected through a length of tubing to the heated working fluid inlet of heat exchanger 28. The heated working fluid outlet of heat exchanger 28 is connected through a length of tubing to the working fluid return of recirculating heating unit 30. The heated process fluid outlet of heat exchanger 28 is connected through a short length of tubing to a three-way valve 32. The one outlet of three-way valve 32 is connected through a short length of tubing to a dispense nozzle 36. The dispense nozzle 36 is spaced a relatively short distance from the surface 38 of the material to be oxidized, cleaned, or processed. The other outlet of three-way valve 32 is connected through a length of tubing to the facility drain-reclaim inlet 34 for the heated ozone-water solution.

Operation—FIG. 1A

With reference to FIG. 1A, an ozone-gas-water solution of predetermined dissolved ozone concentration is produced by the ozonated water supply 22 by dissolving ozone gas at predetermined concentration and pressure P1 into water at a predetermined temperature T1. The ozone gas is dissolved into water using a venturi injector and downstream bubble column, a packed column, a gas permeable membrane contactor, a bubble diffuser, a turbine mixer, a spray contactor, or other means known to those skilled in the art. The ozone gas may be dissolved at atmospheric pressure (˜1 bar) or at elevated pressures above atmospheric pressure. The maximum dissolved concentration that can be produced for a given gas phase concentration, gas pressure, and water temperature is predicted by Henry's law as discussed in the introduction. (See Table 1).

Some ozone generators such as the Astex AX8100 and AX 8200 require high purity oxygen gas mixed with approximately 0.5% nitrogen gas by volume to produce relatively high concentration ozone gas (200 to 250 grams/Nm3). Other generators such as the Astex Model AX8401, Astex Model AX8402, Semozon Model 030.2, and Semozon Model 090.2 require a source of high purity oxygen with only about 50 ppm of nitrogen by volume to produce relatively high concentration ozone gas. A generator requiring oxygen mixed with approximately 0.5% nitrogen produces ozone (O3) and a relatively large amount of NO2. When this gas stream is dissolved in water in the ozone-water contactor, the NO2 combines with water (H2O) to form nitric acid (HNO3). If the water is unbuffered, then nitric acid can cause the pH of the ozone-water solution to gradually fall. In the preferred electronic device cleaning/processing embodiment, the use of an ozone generator requiring oxygen mixed with approximately 50 ppm nitrogen is preferred because this type of generator produces ozone (O3) and a very small amount of NO2. Accordingly, when this gas stream is dissolved in water in the ozone-water contactor, only a small amount of nitric acid is formed, and there is a minimal resulting pH change.

The ozonated water supply 22 may be designed to supply an ozone-gas-water solution at a predetermined concentration and flow rate on a continuous basis or on an intermittent basis. In general, the mass flow rate out of the ozone-water solution (the product of the liquid flow rate and the dissolved ozone concentration) is less than the mass flow rate of the ozone gas entering the contactor (the product of the ozone gas flow rate and the ozone gas concentration). Accordingly, some of the ozone gas will exit from the contactor vent line as a waste ozone gas stream.

An ozonated water supply may be designed to flow the water through the gas-water contactor in a single pass and deliver an ozone-gas-water solution at a predetermined value less than the saturation concentration. Alternatively, the ozonated water supply may be designed to flow the water through the gas-water contactor in multiple passes, and thereby provide a longer time for mass transfer to occur between the gas and the liquid, and deliver an ozone-gas-water solution at a predetermined value up to the saturation concentration.

It is convenient to use a three way valve 24 to direct the solution to the process for the required process cycle time, and then direct the ozone-water solution to facility waste/reclaim 26 at the end of the cycle. This is preferred to shutting off the flow for ozonated water supplies based upon a single pass design since this type of ozonated water supply 22 requires water flow the operate. This insures that the supply runs in steady state and can provide a stable supply of ozonated water at a predetermined concentration with no transients associated with stopping and starting flow through the supply contactor. The supply can employ a controller to set the flow to a very low level during the period that the valve is set to the waste-reclaim position to conserve water and ozone. If an ozonated water supply of the batch recirculating type is employed, then the three-way valve may be used to direct the flow of water back to the contactor.

If the flow through heat exchanger 28 is stopped at the end of a process cycle, then the dissolved ozone concentration in the water remaining in the exchanger will decay toward a low value and the temperature will rise to the hot working fluid temperature. It is convenient to use a three way valve 32 just upstream of the dispense nozzle 36 to direct this volume of water to facility waste/reclaim 34 immediately prior to the next process dispense cycle. This insures that the heated ozone-gas-water solution that is subsequently dispensed onto the material 38 is at the predetermined temperature and dissolved ozone concentration. At the start of an etch cycle (process cycle) valve 26 is set to direct the process flow through the point-of-use heater (heat exchanger 28) and valve 32 is set to direct the process flow to facility waste/reclaim 34 for a time greater than or equal to the residence time of the volume between three-way valve 24 and three-way valve 32. In the case of a flow rate of 50 ml/sec (3.0 L/min) and a residence volume of 100 ml, the flow is sent to facility waste/reclaim 34 for a least 2 seconds to insure that the ozone-water solution is purged from the residence volume before valve 32 is set to direct the process flow to the dispense nozzle 36. The valve 32 is placed just upstream of the dispense nozzle 36 to minimize the volume that is not purged when valve 32 is set to direct the process flow to facility waste/reclaim 34. The waste-reclaim 26 and waste-reclaim 34 may be directed to different facility waste-reclaim locations since the process stream sent to 26 is the full concentration ozone-gas-water solution supplied by the ozonated water supply 22 and the process stream sent to 34 is the heated ozone-gas-water solution in which the concentration may have fallen significantly during the time when the flow through exchanger 28 has be set to zero between the end of one process cycle and the start of the next process cycle.

The ozonated water supply 22 delivers an ozone-gas-water solution with sufficient pressure to achieve a predetermined flow rate through the dispense nozzle 36. The delivery pressure must be sufficient pressure to produce the flow through the pressure drop across the heat exchanger 28, connecting tubing, and dispense nozzle 36.

Back Pressure Regulators for an Ozonated Water Supply Using a Pressurized Contactor with P1>1 bar.

If the ozonated water supply 22 is designed to dissolve ozone gas into water at a gas pressure P1 above 1 bar, then a back pressure regulator is typically placed at the ozone off-gas outlet of the ozone-gas-water contactor and ozonated water outlet of the ozone-gas-water contactor to maintain the specified gas pressure P1 inside the contactor which is higher than pressure P2 downstream of the back pressure regulators. Once the ozone-water solution passes through the back pressure regulator to a lower pressure the ozone gas will begin to leave the solution. If the transit time of the ozone-gas-water solution from the outlet of the ozone-gas-water contactor in the ozonated water supply 22 to the inlet of the heat exchanger 28 is relatively long, then the ozone gas will have a longer time available to leave the solution in transit from the back pressure regulator to the exchanger inlet. The dissolved ozone concentration at the exchanger inlet will be less than the dissolved ozone concentration at the outlet of the ozonated water supply 22 just downstream of the back pressure regulator because the ozone concentration will fall toward the equilibrium concentration at the pressure downstream of the regulator. This fall in concentration can be alleviated by moving the back pressure regulator to a point just upstream of heat exchanger 28. If the back pressure regulator set to pressure P3 is moved further downstream to a point just upstream of the dispense nozzle 36, then the decay in concentration can be reduced even further since the solution is maintained at the pressure P3>P2 until last possible moment when the solution is dispensed onto the surface of the material 38 at a pressure P2.

Back Pressure Regulators for an Ozonated Water Supply Using a Un-Pressurized Contactor with P1=1 bar. If the ozononated water supply 22 is designed to dissolve ozone gas into water at a gas pressure P1=1 bar, then a back pressure regulator can be placed at the outlet of the heat exchanger 28 to maintain a specified gas pressure P3>P1 inside the heated ozone-solvent solution which may be higher than pressure P2 downstream of the back pressure regulator. Once the ozone-water solution passes through the back pressure regulator to a lower pressure the ozone gas will begin to leave the solution. If the transit time of the ozone-gas-water solution from the outlet of the heat exchanger 28 to the dispense nozzle 36 is relatively long, then the ozone gas will have a longer time available to leave the solution in transit from the back pressure regulator to the exchanger dispense nozzle 36. The decay in concentration can be reduced even further since the solution is maintained at the pressure P3 until last possible moment when the solution is dispensed onto the surface of the material 38 at a pressure P2.

Materials Processing Method W/Ozone-Solvent Solution Heated W/Heat Exchanger

Description—FIG. 1B.

With reference to FIG. 1B, liquid back-pressure regulator 158 is positioned downstream of the heat exchanger. Whereas pressure dropping elements downstream of the heat exchanger such as dissolved ozone monitor, a chemical injector, connecting tubing, and a dispense nozzle can provide sufficient pressure drop to provide a particular pressure downstream of the exchanger, one may also use a back-pressure regulator as shown.

Operation—FIG. 1B

With reference to FIG. 1B, back-pressure regulator 158 may be set to a predetermined back pressure. The regulator serves to maintain the pressure upstream of the regulator (and down stream of the heat exchanger) over a range of flow rates.

Heat Exchanger: A Point-of-Use Heater for Quickly Heating the Ozone-Gas-Water Solution. The ozone-water solution flows through three-way valve 24 to the process fluid inlet of the heat exchanger 28. A heated working fluid such as water, supplied by a recirculating heating unit 30, flows through the hot working fluid side of the heat exchanger. The recirculating heating unit 30 is sized to provide the power required to increase the ozone water solution temperature at a specified ozone water solution flow rate. The temperature hot working fluid (typically water) that flows from the recirculating heating unit 30, through the exchanger 28, and back to the recirculating heating unit 30 for reheating is controlled by the temperature controller of the recirculating heating unit. The temperature of the ozone water solution exiting from the exchanger can be changed by changing the temperature setpoint on the recirculating heating unit. In passing through the heat exchanger, the ozone-water solution is quickly heated to a higher temperature and then immediately applied to the material to be oxidized.

The volume of the fluid passages through which the heated, supersaturated, ozone-water solution must pass, starting at the inlet of the heat exchanger 28 and ending at the dispense nozzle 36 must be kept relatively small. A typical value for this volume is 100 to 300 ml for a system designed for a dispense flow rate of approximately 3.0 l/min and a dispense temperature of approximately 50 degree C. This corresponds to a residence time of 2 seconds to 6 seconds. In addition, the volume of the fluid stream starting at the dispense nozzle 36 and ending at the surface of the material to be oxidized 38 must be kept small. A typical value for this volume is 5 to 10 ml for a system designed for a dispense flow rate of approximately 3.0 l/min and a dispense temperature of approximately 50 degree C. This corresponds to a residence time of 0.1 seconds to 0.2 seconds. A minimum total residence time, the time delay between heating the solution and applying the solution to the surface(s) to be cleaned or oxidized, minimizes the time available for the dissolved ozone concentration to fall once the solution temperature is increased.

The ozone gas will come out of solution at a higher rate and the dissolved ozone concentration will fall at a higher rate if the ozone-water solution is heated to a higher temperature. The optimum temperature for maximizing the etch rate is determined by the mass transport coefficient M as discussed earlier. Once S>>M at sufficiently high temperature, further increases in temperature do not increase etch rate further. One design approach is then to design the point-of-use heater to have a sufficiently small residence time at that etch rate maximizing temperature that the dissolved ozone concentration decays a relatively small amount.

The ozone gas will come out of solution at a higher rate and the dissolved ozone concentration will fall at a higher rate if the inside surface of the point-of-use heater (the process side of the heat exchanger in this embodiment) has scratches, since the ozone will leave solution most readily at the location of the scratches. Accordingly, a relatively smooth inner surface is desired. The inside surface of the 316 stainless steel tube-in-tube heat exchanger model 413 made by Exergy Inc. has a surface roughness of ˜20 Ra. Electropolished versions are available with a surface roughness of ˜5 Ra.

The ozone gas will come out of solution at a higher rate and the dissolved ozone concentration will fall at a higher rate if the surface area of the free stream(s) of fluid passing from the dispense nozzle(s) to the surface 36 is larger. If the flow of the solution from the dispense nozzle to the to surface of the material to be oxidized 38 is carried by many small diameter streams, then the rate of loss of ozone gas from solution will higher when compared to the case of the solution being carried by a single solid stream because the surface area of the many small diameter streams is larger.

In applications such as wafer processing the use of stainless steel wetted components is not acceptable because these materials introduce metal contamination into the process chemistry. In these applications the preferred materials for all wetted parts are metal free materials such as Teflon PFA or Teflon PTFE or quartz. Accordingly, the point-of-use heater should employ materials such as Teflon PFA or Teflon PTFE for all wetted surfaces in lieu of stainless steel for these applications.

In the prior art, the ozone is dissolved in water at a given temperature T1 and the ozone-water solution is applied to the material to be oxidized at a temperature T2=T1. Accordingly, if one lowers the temperature T1 to increase the dissolved ozone concentration, then one decreases the surface reaction rate S. Alternatively, if one increases the temperature T2 to increase the surface reaction rate, then one decreases the dissolved ozone concentration.

The present invention overcomes this limitation by tricking mother nature into providing a higher dissolved concentration at the elevated temperature that could be achieved under equilibrium conditions.

A first type of method for treating materials at high speed using a solution of ozone gas dissolved in a solvent comprises the steps of dissolving relatively high concentration ozone gas in water at a relatively low predetermined temperature T1 to form an ozone-water solution with a relatively high dissolved ozone concentration, and heating the ozone-water solution with a point-of-use heater to quickly increase the solution temperature to a predetermined higher temperature T2>T1, where preferrably T2−T1>5 degree C., and applying the heated ozone-water solution to said material(s).

A second type of method for oxidizing materials at high speed using a solution of ozone gas dissolved in solvent comprises the steps of dissolving (relatively high concentration) ozone gas in water at a relatively low predetermined temperature T1 to form an ozone-water solution (with a relatively high dissolved ozone concentration), applying the cold ozone-water solution to said materials while heating said materials and said ozone-water solution at the point of application to quickly increase said material temperature and said solution temperature to a predetermined higher temperature T2>T1, where preferrably T2−T1>5 degree C.

The heated ozone-water solution will have a much higher dissolved ozone concentration at said higher temperature than could be achieved if the ozone gas was initially dissolved in water at said higher temperature. The parameter space for the preferred embodiments and prior art is shown in Table 2 below. In the prior art, the ozone is dissolved and applied at the same temperature.

TABLE 2
Parameter Space of the Preferred Embodiments and Prior Art (the
ozone-water solution is prepared by dissolving ozone gas in water at a
temperature T1; the ozone-water solution is applied to the material to be
oxidized at a temperature T2

| | |
|---|---|
| T2 > T1 | Preferred Embodiments |
| T2 = T1 | PRIOR ART |
| T2 < T1 | generally lower performance than T2 = T1 |
| | (Note 1) |

Note 1: In the case with T2<T1 the dissolved concentration is nominally the same as when T2=T1 and the surface reaction rate S is lower because the surface temperature is lower.

The point-of-use heater is designed to have a small residence volume so that the residence time between the inlet of the heater and the point of application is small and there is insufficient time for supersaturated solution to return to equilibrium before reaching the surface of the material to be oxidized. The time required for the solution to return to equilibrium is dependent upon the temperature to which to solution is heated. Our preliminary measurements indicate that at a temperature of about 50 degree C., a residence time of 2 seconds will allow the dissolved concentration to only fall by about 10 to 20 percent. At higher temperatures, the required residence time is smaller. The residence time is proportional to the volume and inversely proportional to the dispense flow rate though that volume. We prepared an ozone-water solution by dissolving ozone gas, at concentration of 240 g/Nm3, a flow rate of 0.48 L/min, and a pressure of 1 bar, into water at a temperature of about 8 degree C. using a Mazzei Model 287 venturi injector and bubble column contactor operated in the recirculating mode. We waited about 30 minutes and allowed the dissolved concentration reach the saturation concentration at about 70. We drew the ozone-water solution from the unpressurized contactor with a high pressure gear pump capable of delivering a flow rate of 2.7 L/minute at 80 psi. We passed the solution through an Exergy tube in tube heat exchanger model 413, through a UV absorption type dissolved ozone monitor and thermocouple probe, and then to a waste collection carboy. We measured the dissolved concentration upstream and downstream of the heater as a function of the temperature of the ozone-water solution downstream of the heater for several different temperatures. We used this data to estimate the decay time constant as function of temperature by assuming that the decay time was an exponential function of the temperature. We ran a similar test using a coil in heated water bath heater. We flowed the water through a 20-foot long coil of stainless steel, 0.375 inch OD, 0.305 inch ID tubing, immersed in a heated water bath. Since the water bath did not have sufficient power to maintain a constant bath temperature, the dispense temperature of the ozone water solution decreased about 5 degree C. during the test. Accordingly, we used average temperatures in analyzing the results. The residence volume of the coil in bath heater was about 270 ml and the residence volume of the tube in tube heat exchanger was about 90 ml. (see the table 3 footnotes) The results for both tests were consistent with the model presented below. The results for one test series are presented in Table 3 below.

TABLE 3
Decay time constant as a function of temperature: Measured decay time constant as function of
temperature and calculated decay time constant as function of temperature assuming that the decay
time is an exponential function of the temperature

| | | | Tau = 2E−10 * Exp(8.26(1000/T) | | | | | | | |
|---|---|---|---|---|---|---|---|---|---|---|
| | | | measured | calculated | transit | | transit | | transit | |
| | | | decay | decay | time | decay | time | decay | time | decay |
| | | | const. | const. | t | factor | t | factor | t | factor |
| Temp | Temp | 1000/T | Tau | Tau | secs | exp(−t/ | secs | exp(−t/ | secs | exp(−t/ |
| deg. C. | deg. K | (K) | secs | secs | note 1 | Tau) | note 2 | Tau) | note 3 | Tau) |
| 20 | 293 | 3.41 | | 292.3 | 2 | 99% | 6 | 98% | 22 | 93% |
| 25 | 298 | 3.36 | | 186.6 | 2 | 99% | 6 | 97% | 22 | 89% |
| 30 | 303 | 3.30 | | 120.9 | 2 | 98% | 6 | 95% | 22 | 83% |
| 35 | 308 | 3.25 | | 79.4 | 2 | 98% | 6 | 93% | 22 | 76% |
| 40 | 313 | 3.19 | | 52.9 | 2 | 96% | 6 | 89% | 22 | 66% |
| 45 | 318 | 3.14 | | 35.7 | 2 | 95% | 6 | 85% | 22 | 54% |
| 50 | 323 | 3.10 | | 24.3 | 2 | 92% | 6 | 78% | 22 | 41% |
| 55 | 328 | 3.05 | | 16.8 | 2 | 89% | 6 | 70% | 22 | 27% |
| 60 | 333 | 3.00 | 11.00 | 11.7 | 2 | 84% | 6 | 60% | 22 | 15% |
| 65 | 338 | 2.96 | 8.4 | 8.3 | 2 | 79% | 6 | 49% | 22 | 7% |
| 70 | 343 | 2.92 | | 5.9 | 2 | 71% | 6 | 36% | 22 | 2% |
| 75 | 348 | 2.87 | 4.05 | 4.3 | 2 | 63% | 6 | 24% | 22 | 1% |
| 80 | 353 | 2.83 | | 3.1 | 2 | 52% | 6 | 14% | 22 | 0% |
| 85 | 358 | 2.79 | | 2.3 | 2 | 41% | 6 | 7% | 22 | 0% |
| 90 | 363 | 2.75 | | 1.7 | 2 | 30% | 6 | 3% | 22 | 0% |
| 95 | 368 | 2.72 | | 1.3 | 2 | 20% | 6 | 1% | 22 | 0% |

Note 1:
Exergy Model 413 stainless steel tube-in-tube heat exchanger; total residence volume from the heater inlet to the heater outlet approximately 90 ml; dispense flow rate 45 ml/sec; residence time approximately 2 secs
Note 2:
⅜ inch OD, 20 foot long, coil in water bath heater; total residence volume from the heater inlet to the heater outlet approximately 270 ml; dispense flow rate approx. 45 ml/sec; residence time approximately 6 secs.
Note 3:
relatively large volume heater or heat exchanger; total residence volume from the heater inlet to the heater outlet chosen to be 1000 ml; dispense flow rate approx. 45 ml/sec; residence time approximately 22 secs.

From this data we can see that higher temperatures cause the concentration to fall more quickly. If one is to minimize the drop in concentration upon heating, then the residence time must be decreased if the temperature is increased. For example, if we would like the dissolved ozone concentration at the outlet of the point-of-use heater to be no less than 80 percent of the dissolved ozone concentration at the inlet of the point-of-use heater, then the transit time must be less than or equal to the values estimated in Table 4 below.

TABLE 4
Maximum estimated permissible ozone-water solution heating time (heater
transit time): Example calculated for the dissolved ozone concentration at
the heater outlet to be no less than 80 percent of the dissolved ozone
concentration at the heater inlet. Estimated from decay data measured
with an inlet dissolved ozone concentration of about 100 mg/liter, an
initial upstream ozone-water solution temperature of about 8 deg. C. and
the a final specified downstream ozone-water solution temperature
ranging from 20 deg. C. to 95 deg. C.

| Example Decay Factor = | | | | |
|---|---|---|---|---|
| 80% (Downstream | | | | Calculated |
| Conc./Upstream Conc.) | | | | maximum |
| Ave solution | | | Estimated | allowable |
| temp. at heater | | | decay | heater transit time |
| outlet | | | const. | t = −Tau * Ln(decay |
| Temp | Temp. | 1000/T | Tau | factor) |
| deg. C. | deg. K | (K) | secs | secs |
| 20 | 293 | 3.41 | 292.3 | 65.22 |
| 25 | 298 | 3.36 | 186.6 | 41.63 |
| 30 | 303 | 3.30 | 120.9 | 26.97 |
| 35 | 308 | 3.25 | 79.4 | 17.72 |
| 40 | 313 | 3.19 | 52.9 | 11.80 |
| 45 | 318 | 3.14 | 35.7 | 7.96 |
| 50 | 323 | 3.10 | 24.3 | 5.43 |
| 55 | 328 | 3.05 | 16.8 | 3.75 |
| 60 | 333 | 3.00 | 11.7 | 2.62 |
| 65 | 338 | 2.96 | 8.3 | 1.85 |
| 70 | 343 | 2.92 | 5.9 | 1.32 |
| 75 | 348 | 2.87 | 4.3 | 0.95 |
| 80 | 353 | 2.83 | 3.1 | 0.69 |
| 85 | 358 | 2.79 | 2.3 | 0.51 |
| 90 | 363 | 2.75 | 1.7 | 0.37 |
| 95 | 368 | 2.72 | 1.3 | 0.28 |

We know from out model that an increased temperature will provide a significant increase in etch rate until the etch rate becomes mass transport limited. Our measurements show that with a wafer spinning at about 4,000 rpm and a dispense flow rate of 2.7 L/min, that the etch rate becomes mass transport limited at the wafer edge at about 50 degree C. Other methods of applying the solution to the material to be oxidized may provide a higher or lower mass transport coefficient and a correspondingly higher or lower optimum temperature.

Heating Power Requirement. The power input in watts required to increase the temperature of a stream of water can be calculated given the water flow rate, the desired temperature rise, and the heat capacity of the water. We have shown the results of that calculation in Table 5 below. If the flow rate of the ozone-water solution which passes through the point-of-use heater is 2.7 L/min, and the water enters at a temperature of 5 degree C., and the desired exit temperature is 55 deg. C., then the heater must transfer energy to the ozone-water stream at a power level of 9.3 kW.

TABLE 5
Point-of-use Heater Power Requirement

| | | | Required | |
|---|---|---|---|---|
| Dispense Flow | Inlet Water | Desired Outlet | Temp. | Power |
| Rate | Temp. | Water Temp. | Increase | Req'd |
| (L/min) | (deg. C.) | (deg. C.) | (deg. C.) | (kW) |
| 2.7 | 5 | 45 | 40 | 7.45 |
| 2.7 | 5 | 55 | 50 | 9.3 |
| 2.7 | 5 | 65 | 60 | 11.2 |
| 2.7 | 5 | 75 | 70 | 13.0 |
| 2.7 | 5 | 85 | 80 | 14.9 |
| 2.7 | 5 | 95 | 90 | 16.8 |
| 3.3 | 5 | 45 | 40 | 9.1 |
| 3.3 | 5 | 55 | 50 | 11.4 |
| 3.3 | 5 | 65 | 60 | 13.7 |
| 3.3 | 5 | 75 | 70 | 15.9 |
| 3.3 | 5 | 85 | 80 | 18.2 |
| 3.3 | 5 | 95 | 90 | 20.5 |

The power required to increase the ozone gas-water solution temperature can be transferred from a heated working fluid in a heat exchanger. The energy transferred by a particular heat exchanger is determined by the temperature and flow rate of hot working fluid entering the working fluid side of the exchanger, the temperature and flow rate of the ozone gas-water solution entering the process side of the exchanger, and the desired temperature of the ozone-water solution exiting from the exchanger.

Example flow rates and temperatures are shown in Table 6 below. We can see that for a given flow rate and temperature for the ozone-water solution entering the heat exchanger and a given flow rate for the heated working fluid circulated through the outer tube of the heat exchanger by the recirculating heating unit, that changing the temperature of the working fluid will change the temperature of the ozone-water solution exiting from the exchanger to the dispense nozzle. The embodiment can provide a constant dispense temperature T2 the other parameters mentioned are held constant.

TABLE 6
Calculated Performance of Exergy Model 413 Stainless Steel Tube-in-
Tube Heat Exchanger Reported by the Manufacturer. The ozone-gas-
water solution is passed through the 0.180 inch ID, .250 inch OD, 240
inch long, inner tube. The heated working fluid from the recirculating
heating unit is passed through the annular space bounded by a
concentric .430 inch ID outer tube and the inner tube. The internal
volume of the inner tube is 90 ml.

| | Example 1: 48° C. Dispense | | Example 2: 56° C. Dispense | |
|---|---|---|---|---|
| | Temperature | | Temperature | |
| | Inner Tube | Outer Tube | Inner Tube | Outer Tube |
| | ozone-water | heated | ozone-water | heated working |
| | solution | working fluid | solution | fluid |
| Fluid | water | water | water | water |
| Used | | | | |
| for the | | | | |
| Calcu- | | | | |
| lation | | | | |
| Temp | 7 | 60 | 7 | 70 |
| In (° C.) | | | | |
| Temp. Out | 48 | 38 | 56 | 43 |
| (° C.) | | | | |
| Vol. Flow | 2.7 | 5 | 2.7 | 5 |
| (L/min) | | | | |
| Pressure | 24 | 6 | 24 | 6 |
| Drop (psi) | | | | |
| Heat | 7616 | 7616 | 9203 | 9203 |
| Transfer | | | | |
| (watts) | | | | |

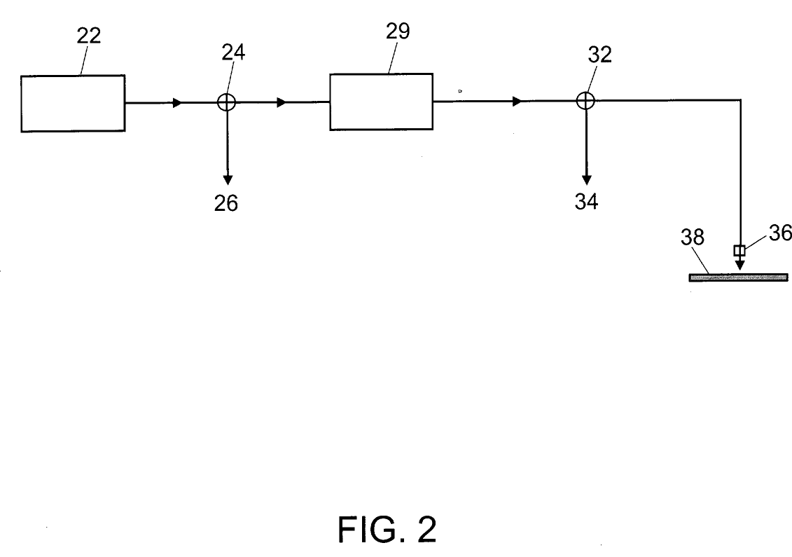

Materials Processing Method W/Ozone-Water Solution Heated W/A Point-Of-Use Water Heater
Description—FIG. 2

With reference to FIG. 2, an ozonated water supply 22 is connected through a length of tubing to the common input of a three-way valve 24. The one outlet of three-way valve 24 is connected through a length of tubing to the cold process fluid inlet of point-of-use heater 29. The other outlet of three-way valve 24 is connected through a length of tubing to the facility drain-reclaim 26 for the ozone-water solution. The heated process fluid outlet of point-of-use heater 29 is connected through a short length of tubing to a three-way valve 32. The one outlet of three-way valve 32 is connected through a short length of tubing to a dispense nozzle 36. The dispense nozzle 36 is spaced a relatively short distance from the surface 38 of the material to be oxidized, cleaned, or processed. The other outlet of three-way valve 32 is connected through a length of tubing to the facility drain-reclaim 34 for the heated ozone-water solution.

Operation—FIG. 2

Point-of-Use Heater: A Point-of-Use Heater for Quickly Heating the Ozone-Gas-Water Solution: The point-of-use heater 29 has the same requirements as the heat exchanger including those relating to internal volume, surface roughness, and materials of metal free materials of construction. Most commercially available heaters of the required power level and materials of construction such as those made for point-of-use heating of DI water for the semiconductor and pharmaceutical industry have an internal volume of at least 2000 ml. One embodiment for a point-of-use heater with small internal volume is constructed using radiant and convention heating of the ozone-water solution. The ozone-water solution is flowed through quartz tubing that surrounds the IR heating source. The volume of the tubing can be made small to minimize the residence time inside the heater. A temperature sensor, either at the outlet of the heater, or just upstream of the dispense nozzle, is connected to temperature controller. The temperature controller increases or decreases the amount of power delivered by the heater to achieve and maintain a specified dispense temperature. A direct heater with feedback control from the dispense temperature can typically adjust the temperature at the dispense point more quickly than can a heat exchanger embodiment.

Heating Power Requirement: The heating power requirement using a point-of-use heater 29 is the same as that using a heat exchanger 28.

Materials Processing Method Additionally Including Point-Of-Use Chemical Injection—Single Chemical Supply

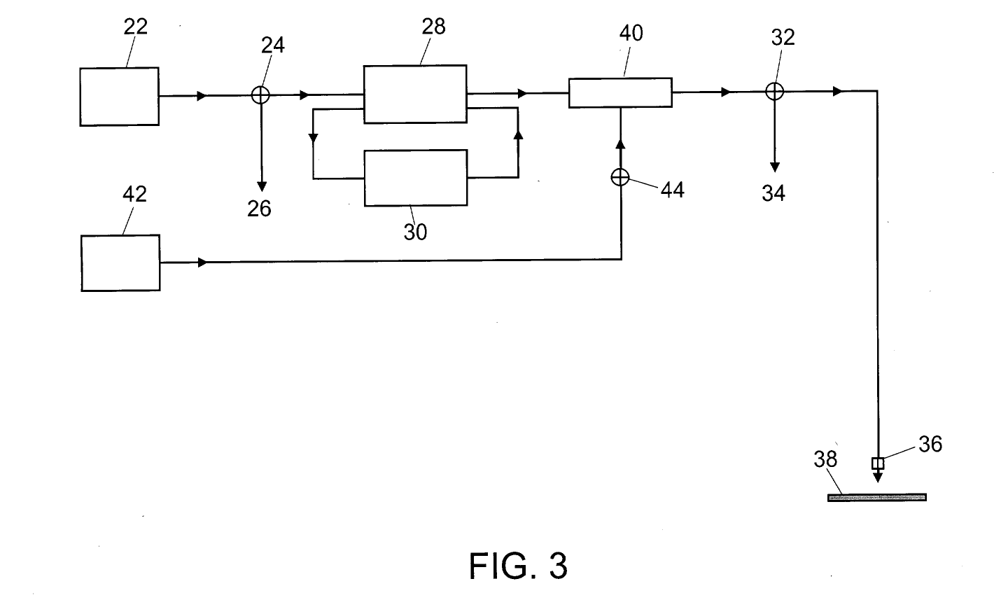

Description—FIG. 3

It is often useful to have a means to mix additional chemicals with the ozone-gas-water solution prior to applying the solution to the material to be oxidized.

With reference to FIG. 3, an ozonated water supply 22 is connected through a length of tubing to the common input of a three-way valve 24. The one outlet of three-way valve 24 is connected through a length of tubing to the cold process fluid inlet of a heat exchanger 28. The other outlet of three-way valve 24 is connected through a length of tubing to the facility drain-reclaim 26 for the ozone-water solution. The heated working fluid outlet of a recirculating heating unit 30 is connected through a length of tubing to the heated working fluid inlet of heat exchanger 28. The heated working fluid outlet of heat exchanger 28 is connected through a length of tubing to the working fluid return of recirculating heating unit 30. The heated process fluid outlet of heat exchanger 28 is connected through a short length of tubing to the inlet of chemical injector/mixer 40. The outlet of an injected chemical supply 42 is connected to the inlet of two-way valve 44. The outlet of valve 44 is connected to the chemical injection port of chemical injector/mixer 40. The outlet of chemical injector/mixer 40 is connected to the common inlet port of three-way valve 32. The one outlet of three-way valve 32 is connected through a short length of tubing to a dispense nozzle 36. The dispense nozzle 36 is spaced a relatively short distance from the surface 38 of the material to be oxidized, cleaned, or processed. The other outlet of three-way valve 32 is connected through a length of tubing to the facility drain-reclaim 34 for the heated ozone-water solution.

Operation—FIG. 3

Injected Chemical Supply System—Single Chemical Reservoir: The injected chemical supply provides a chemical at a predetermined delivery pressure and a predetermined flow rate into the injection port of the injector/mixer 40 where the concentration of the chemical dispensed by the supply and ratio of the flow rate of the injected chemical to the flow rate of the ozone-gas-water solution through the injector/mixer determines the concentration of the injected chemical in the solution exiting from the mixer. The supply 42 may be implement with a source of pressurized nitrogen regulated to a predetermined pressure (not shown) connected through a length of tubing to a reservoir (not shown) containing a liquid chemical to be injected. The dip-tube outlet (not shown) of the chemical reservoir is connected through a length of tubing to the inlet side a flow controlling needle valve (not shown). The outlet of the flow controlling needle valve is connected through a length of tubing to the inlet of a flow meter. The outlet of the flow meter is connected through a length of tubing to the inlet of the chemical injection control valve 44. The outlet of the chemical injection control valve 44 is connected through a length of tubing to the chemical injection port of chemical injector/mixer 40. The pressurized injected chemical supply can also be implemented using a metering pump of other means known to those skilled in the art.

Point-of-use Chemical Injector: The chemical injector/mixer 40 may be a venturi injector, a static mixer, a mixing “T”, or other device known to those skilled in the art. The injected chemical supply must deliver the chemical to the injection port of chemical injector/mixer with sufficient pressure to achieve the desired predetermined injected chemical flow rate. The internal volume of the injector mixer 40 must be kept to minimize the additional volume between the heat exchanger 28 and the dispense nozzle 36 referred to in the earlier discussion.

Minimizing temperature or Dissolved Ozone Concentration Changes Caused by the Injection of Chemicals: In the preferred embodiment the chemical injector/mixer 40 is located downstream of the heat exchanger 28. The temperature of the ozone-water solution is set at a predetermined temperature that is in the range of 30 to 95 deg. C. In the electronic device cleaning and processing embodiment the temperature may be approximately 50 deg. C. If the temperature of the injected chemical is below the temperature of the ozone-water solution entering the injector, then the solution exiting from the heater will be below the temperature of the solution entering the point-of-use heater. The fall in temperature may be mitigated by minimizing the volume flow rate of the injected chemical relative to the volume flow rate of the ozone-water solution. In an alternative embodiment, the injected chemicals can be preheated to approximately the same temperature as the temperature of the ozone-water solution entering the chemical injector thereby eliminating any fall in temperature mentioned above.

It is well known that by the introduction of hydroxyl radical scavengers (carbonates, bicarbonates, phosphates, etc) into an ozone-water solution at a molar concentration of 5 to 10 times the molar concentration of the ozone, that the concentration of the molecular ozone in solution can be maintained. We have found that borates can also be used to stabilize the concentration and adjust the pH. In some applications such as medical instrument sterilization, where metal ion contamination is not a concern, one can use a large range of hydroxyl radical scavenger chemicals such a sodium phosphate, potassium phosphate, sodium carbonate. In the case of electronic device processing, one can use ammonium counter ions in lieu of the metal counter ions. However, many candidate hydroxyl radical scavenger chemicals such ammonium carbonate, ammonium bicarbonate, ammonium phosphate, ammonium acetate, carboxylic acid, phosphonic acid, and salts thereof, as well as sulfates, for example ammonium sulfate, if given sufficient time, may react with ozone-water solution, oxidize the injected chemical, consume ozone, and thereby significantly reduce the dissolved ozone concentration. The advantage of injecting these chemicals near the point-of-use is that the time available for these reactions to proceed very far is severely reduced. Accordingly, many chemicals that would not normally be useable if mixed in a heated ozone-water solution and given time to react can be employed by injecting the chemicals into the ozone-water solution stream just upstream of the point-of-use.

In the semiconductor wafer processing application a chemical may be injected at approximately 20-25 deg. C., at a flow rate of approximately 1 ml/sec into an ozone-water solution flowing at approximately 50 ml/sec. We found it useful to add approximately 1 ml of 1.0 mole/liter solution of a hydroxyl radical scavenger such as ammonium bicarbonate for every 50 ml of a dispensed 72 mg/Liter ozone-water solution (50:1 dilution of the injected mixture), thereby forming a mixture of ozone-water solution with a dissolved ozone concentration of about 72 mg/Liter (1.5 millimoles/liter) and a hydroxyl radical scavenger concentration of about 20 millimoles/liter. Other alternative hydroxyl radical scavenger chemicals well known to those skilled in the art such as ammonium carbonate, ammonium acetate, and acetic acid can also produce good results.

The pH of the ozone-water solution has a number of important effects. First, the pH can influence metal corrosion rates. Generally, the optimum pH for minimizing metal corrosion is slightly less than 7. Second, the pH can influence of etch rate. For example, the inventors have shown that normalized etch rate of Shipley UV-6 DUV positive photoresist at pH=4.2 is about 1/10^{th} the etch rate at PH=6.7. Many metal free pH adjusting chemicals suitable for electronic device manufacturing (ammonium hydroxide, ammonium phosphate monobasic, ammonium phosphate dibasic), if given sufficient time, may react with ozone-water solution, oxidize the injected chemical, consume ozone, and thereby significantly reduce the dissolved ozone. Point-of-use injection of these chemicals can significantly reduce the amount of consumption of both ozone and the chemical.

Metal corrosion control is a challenge in many aqueous cleaning systems. Corrosion inhibitors such as benzotriazoles, tolytriaxoles, mercaptobenzathiozol, axoles, imidazoles, thioxoles, indoles, pyrazoles, benzoate, molybdates, phosphates, chromates, dichromates, tungstate, silicates, vandate, and borate may be introduced into the water-ozone solution to control metal corrosion. Benzotriazole is an attractive copper corrosion inhibitor. Corrosion inhibitor chemicals may be conveniently injected and mixed into the ozone-water solution just upstream of the point of application of the solution to the material to be cleaned or oxidized.

Surfactants are often used in aqueous cleaning systems to improve wetting of surfaces. However, most candidate surfactants react with ozone. Point-of-use injection of these chemicals can significantly reduce the amount of consumption of both ozone and the surfactant.

In the preferred embodiment the chemical injector/mixer 40 is located downstream of the heat exchanger 28. Alternatively, the chemical injector/mixer 40 could be located just upstream of the heat exchanger 28. In this case the injected chemicals are heated with the ozone-water solution. However, the chemicals have a slightly longer time available to react with the ozone-water solution.

Materials Processing Method Additionally Including Point-Of-Use Chemical Injection—Multiple Chemical Supplies

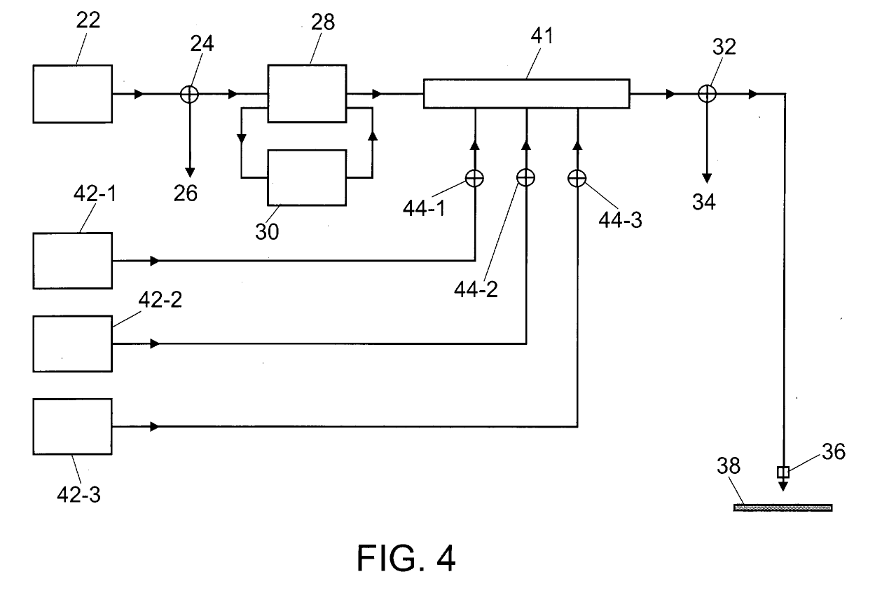

Description—FIG. 4

In an alternative embodiment, means may be provide for the injection of more than one chemical, each from a separate chemical reservoir. With reference to FIG. 4, an ozonated water supply 22 is connected through a length of tubing to the common input of a three-way valve 24. The one outlet of three-way valve 24 is connected through a length of tubing to the cold process fluid inlet of a heat exchanger 28. The other outlet of three-way valve 24 is connected through a length of tubing to the facility drain-reclaim 26 for the ozone-water solution. The heated working fluid outlet of a recirculating heating unit 30 is connected through a length of tubing to the heated working fluid inlet of heat exchanger 28. The heated working fluid outlet of heat exchanger 28 is connected through a length of tubing to the working fluid return of recirculating heating unit 30. The heated process fluid outlet of heat exchanger 28 is connected through a short length of tubing to the inlet of chemical injector/mixer 41. The outlet of an injected chemical supply 40-1 is connected to the inlet of two-way valve 44-1. The outlet of valve 44-1 is connected to a first chemical injection port of a multiple port chemical injector/mixer 41. The outlet of an injected chemical supply 40-2 is connected to the inlet of two-way valve 44-2. The outlet of valve 44-2 is connected to a second chemical injection port of a multiple port chemical injector/mixer 41. The outlet of an injected chemical supply 40-3 is connected to the inlet of two-way valve 44-3. The outlet of valve 44-3 is connected to a third chemical injection port of a multiple port chemical injector/mixer 41. The outlet of chemical injector/mixer 41 is connected to the common inlet port of three-way valve 32. The one outlet of three-way valve 32 is connected through a short length of tubing to a dispense nozzle 36. The dispense nozzle 36 is spaced a relatively short distance from the surface 38 of the material to be oxidized, cleaned, or processed. The other outlet of three-way valve 32 is connected through a length of tubing to the facility drain-reclaim 34 for the heated ozone-water solution. Embodiments for the injection of chemicals, either from a fewer number, or from a greater number of injected chemical supplies, can be implemented using a similar approach.

Separate Injector/Mixer Element for Each Injected Chemical. In an alternative embodiment a separate injector/mixer element for each injected chemical, may be used in lieu of a single injector/mixer element, with multiple chemical inlet ports. The design of apparatus for the injection of chemicals into a fluid stream is well known to those skilled in the art. Many alternative approaches may be chosen provided that the residence time of the ozone-water solution in the injecting mixing element(s) is small since this residence time adds to the total residence time. The short residence time from the inlet of the point-of-use heater 28 or 29 to the point of application of the ozone-water and injected chemical solution to the material to be oxidized has two important benefits. A short residence time minimizes the amount of time available for the dissolved ozone concentration of the supersaturated ozone-water solution entering the mixing element to fall much during the time required for the solution to pass through the element. A short residence time also minimizes the amount of time available for the ozone-water solution to react with the injected chemicals. If the chemicals react with the ozone-water solution, the reaction may not only consume ozone and reduce the dissolved ozone concentration, but also may consume some or all of the injected chemical.

Means for Purging Chemical Injector Lines. In an alternative embodiment, each chemical injection valve 44-1, 44-2, and 44-3 may be a four-way valve to provide for purging the injection line. In the “off” position a four-way chemical injection valve can shut off chemical injection to the injected chemical inlet. In the “on” position, the valve can permit chemical injection to the injected chemical inlet. In the “purge” position permit the purging with DI water, for example, the lengths of tubing between the valves 44-1, 44-2, and 44-3 and the chemical injector/mixer 41 to prepare for the introduction of a different chemical into the injected chemical inlet of chemical injector/mixer 41.

Operation—FIG. 4

This embodiment provides for the injection of different chemicals a predetermined times during the materials processing cycle. The rate of injection for each of the chemicals can be specified and controlled for each instant of time during the materials processing cycle. A preferred embodiment may utilize a computer or microprocessor to control the flow rates at each time step of the process. The operation of the point-of-use chemical injection system with multiple chemical supplies is otherwise the same as the operation of a point-of-use chemical injection system with a single chemical supply.

Materials Processing Method With A Spin Processor

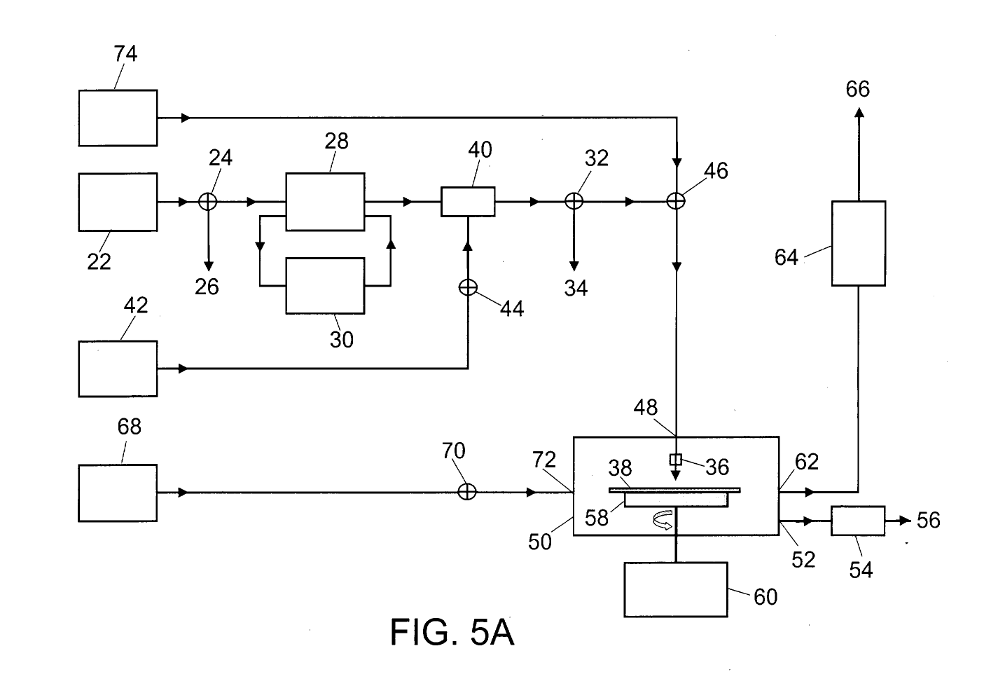

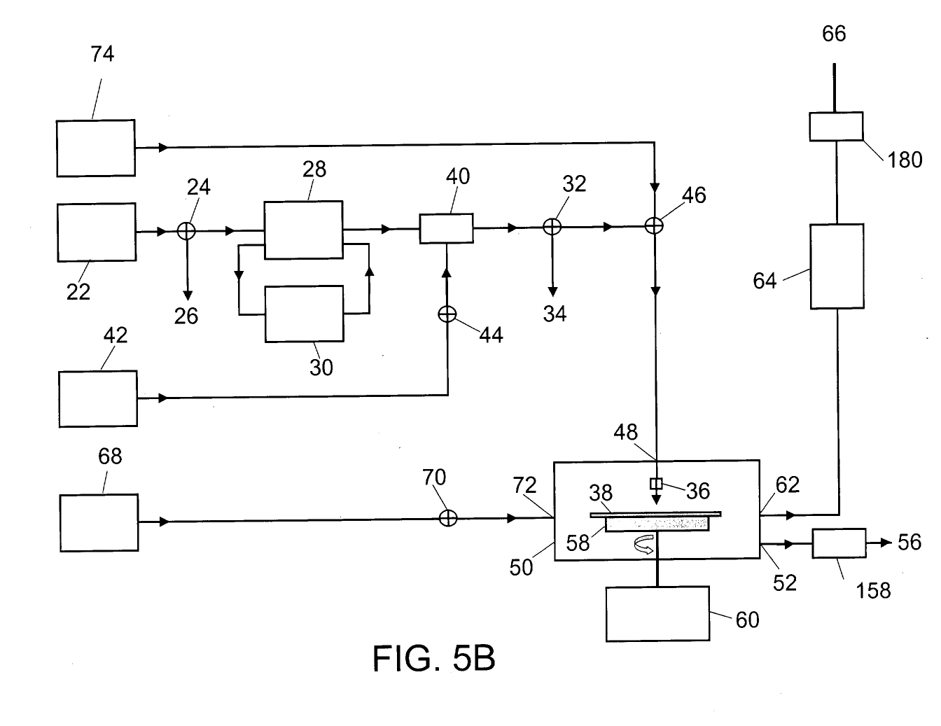

Description—FIG. 5A

One preferred method for applying the ozone-water solution to semiconductor substrates and the like is to apply the ozone-water solution to the surface of the substrate while spinning the substrate about an axis at a relatively high (1,000 to 4,000 rpm) rotational speed. The use of a this method for applying the ozone-water solution to semiconductor substrates and the like provides for a higher mass transport rate M than can be achieved by immersion techniques. With reference to FIG. 5A, an ozonated water supply 22 is connected through a length of tubing to the common input of a three-way valve 24. The one outlet of three-way valve 24 is connected through a length of tubing to the cold process fluid inlet of a heat exchanger 28. The other outlet of three-way valve 24 is connected through a length of tubing to the facility drain-reclaim 26 for the ozone-water solution. The heated working fluid outlet of a recirculating heating unit 30 is connected through a length of tubing to the heated working fluid inlet of heat exchanger 28. The heated working fluid outlet of heat exchanger 28 is connected through a length of tubing to the working fluid return of recirculating heating unit 30. The heated process fluid outlet of heat exchanger 28 is connected through a short length of tubing to the inlet of chemical injector/mixer 40. The outlet of an injected chemical supply 42 is connected to the inlet of two-way valve 44. The outlet of valve 44 is connected to the chemical injection port of chemical injector/mixer 40. The outlet of chemical injector/mixer 40 is connected to the common inlet port of three-way valve 32. The one outlet of three-way valve 32 is connected through a short length to one inlet of a three-way valve etch/rinse valve 46. The common outlet of three-way etch/rinse valve 46 is connected through a short length of tubing to the process fluid inlet 48 to a dispense nozzle 36 located in a gas tight materials processing module 50. In the preferred embodiment the materials processing module 50 is fitted with a lid with a gas tight seal (not shown). The sealed materials processing module serves to contain the any ozone gas that is released from solution at the point of application. A pressurized DI water rinse supply 74 is connected through a length of tubing to the other inlet of port of the three-way etch/rinse valve 46. Pressurized DI water rinse supply 74 typically comprises a pressurized source of DI water connected though a liquid pressure regulator and a liquid flow controller and liquid particulate filter. The dispense nozzle 36 is spaced a relatively short distance (typically 0.5 to 10 cm) from the surface of the material 38 to be oxidized, cleaned, etch, or processed. The other outlet of three-way valve 32 is connected through a length of tubing to the facility drain-reclaim 34 for the heated ozone-water solution.

A process fluid drain outlet port 52 of the materials processing module 50 is connected through a short length of tubing to the inlet of liquid trap 54. When the ozone-water solution is dispensed onto the surface of the substrate at a given flow rate, the gas displaced from the housing may exit at approximately the same flow rate with a relatively small pressure drop. This insures that the pressure in the housing does not rise during the dispense cycle. The outlet of liquid trap 54 to connected by a length of tubing to the facility drain/reclaim 56 for process module liquid effluent. The wafer or substrate or the like is held by a spinner chuck 58. The chuck 58 may hold the wafer or substrate or the like (the material 38 to be oxidized, cleaned, etched, or processed) by the use of vacuum, edge clamps, or other means well known to those skilled in the art. The spinner chuck 58 is connected by a shaft or other means to wafer spinner motor 60. The motor, typically controlled by a microprocessor, can be programmed to accelerate the wafer or substrate or the like at a predetermined rate from zero rpm to a predetermined rpm, hold that rpm for a specified period of time, then decelerate at a predetermined rate to back to zero. Alternatively, the motor may be programmed to successively spin at several different rpm values chosen for different portions of the materials processing cycle. An ozone off-gas outlet port 62 is connected through a length of tubing to the inlet to an ozone catalytic unit 64. The outlet of ozone catalytic unit 64 is connected through a length of tubing to a facility exhaust vent 66. The diameter of the vent line and flow capacity of the ozone catalytic unit 64 is chosen so that the vent line is non-back pressuring. In the preferred embodiment the ozone destruction unit 64 is of the catalytic type filled with a catalyst such as Carulyte 200 (Carus Corporation). Since the waste ozone gas entering the catalyst unit contains water vapor, one may heat the catalyst unit with a heat tape and temperature controller to about 50 degree C. to prevent moisture condensation on the catalyst. The increased temperature also serves to increase the performance of the catalyst. The catalyst unit is sized to provide a sufficient residence time to convert the high concentration waste ozone off-gas to oxygen. The higher the waste gas flow rate, the larger the catalyst volume must be to achieve the conversion. The required residence time can be obtained from the catalyst supplier. Alternatively, the ozone destruction unit 64 can be thermal destruction unit in which the ozone gas-oxygen mixture is decomposed back to oxygen by raising the temperature of the waste ozone gas to about 300 degree C. A pressurized nitrogen purge gas supply 68 is connected through a length of tubing to the inlet port of a two-way valve purge valve 70. The outlet port of the two-way gas purge valve 70 is connected to a purge-gas inlet 72 to the materials processing module 50. Pressurized nitrogen purge supply 68 typically comprises a pressurized source of nitrogen connected though a gas pressure regulator and a gas flow controller and gas particulate filter.

In a single wafer processing embodiment one can use a single wafer spinner such as the all Teflon microprocessor controlled wafer spinner made by Laurell in which the spinner has been fitted with a gas tight lid seal. The Laurell spinner model WS400-6TFM/Lite is all Teflon and designed to accommodate wafers up to 150 mm diameter. The spinner acceleration rate, deceleration rate, and rpm can be set and controlled between 100 RPM and 6000 RPM. The spinner can be upgraded with a valve control option that enables the spinner microprocessor to control up to eight valves. This enables precise automated control of the purge to waste, etch dispense, and DI rinse dispense cycle times. Laurell makes spinners to accommodate 200 mm diameter wafers, 300 mm diameter wafers, and other substrates sizes and shapes.

Measured Photoresist Removal Performance with Equilibrium Processing with T2=T1

We have measured photoresist etch rate using a spin-etch configuration where ozone gas was dissolved in water at a given temperature T1 and given concentration. The ozone-water solution was dispensed at the same temperature T2 though a dispense nozzle to the center of spinning wafer coated with a layer of hard baked I-line positive photoresist or DUV positive photoresist.

We used 150 mm diameter silicon wafers coated with a thin (0.5 to 0.8 micron) and uniform layer of photoresist. We exposed the layer to a stream of ozone dissolved in water at a given concentration and temperature for a specified period time to partially remove some of the thickness of resist. We then measured the remaining layer thickness with an NanoSpec ellipsometer and calculated an etch rate, the amount of organic material removed per unit time. The results are summarized in Tables 7 and 8 below.

TABLE 7
The measured etch rate when ozone is dissolved in water at a given
temperature and given concentration and applied at a given flow rate
though a dispense nozzle at the same temperature to the center of
spinning wafer coated with a layer of hard baked I-line positive
photoresist. The highest etch rate is achieved at the center of the
wafer and the lowest etch rate is achieved at the edge of the wafer
for the example shown

| Dissolved | | | | | | |
|---|---|---|---|---|---|---|
| Ozone | Dis- | | | | | |
| Concen- | solved | Applied | Flow | Wafer | Max Etch | Min Etch |
| tration | Temp | Temp | Rate | spin | Rate | Rate |
| (mg/L) | (deg C.) | (deg C.) | (L/min) | (RPM) | (A°/min) | (A°/min) |
| 75 | 9.9 | 9.9 | 1.2 | 4000 | 4270 | 3718 |
| 62 | 18.8 | 18.8 | 1.26 | 4000 | 6178 | 3538 |
| 24.9 | 27.8 | 27.8 | 1.26 | 4000 | 3524 | 1940 |

TABLE 8
The measured etch rate when ozone is dissolved in water at a given
temperature and given concentration and applied at a given flow rate
though a dispense nozzle at the same temperature to the center of
spinning wafer coated with a layer of hard baked DUV positive
photoresist. The highest etch rate is achieved at the center of the wafer
and the lowest etch rate is achieved at the edge of the wafer for the
example shown.

| Dissolved | | | | | | |
|---|---|---|---|---|---|---|
| Ozone | Dis- | | | | | |
| Concen- | solved | Applied | Flow | Wafer | Max Etch | Min Etch |
| tration | Temp | Temp | Rate | spin | Rate | Rate |
| (mg/L) | (deg C.) | (deg C.) | (L/min) | (RPM) | (A°/min) | (A°/min) |
| 90 | 10.4 | 10.4 | 1.2 | 4000 | 1226 | 986 |
| 60 | 19.2 | 19.2 | 1.32 | 4000 | 2426 | 1774 |
| 24.9 | 27.8 | 27.8 | 1.23 | 4000 | 2308 | 1058 |

We know from our previous discussion that increasing the temperature of the water reduces the equilibrium dissolved ozone concentration as predicted by Henry's law. In the case of semiconductor wafers coated with a layer of organic polymer, we found that etch rate was higher at 20 degree C. than at 10 degree C. even though the equilibrium dissolved ozone concentration was significantly lower (60 mg/L at 20 deg. C. compared to 90 mg/L at 10 deg. We see that the maximum etch rate first increases with increased temperature and then the etch rate decreases with further increases in temperature. We see that I-line positive photoresist is etched by the process at a faster rate than DUV resist. This is because the I-line positive photoresist has a higher value of S than DUV positive photoresist at a given temperature.

These etch rates are not high enough to provide reasonable throughputs in a single wafer configuration.

Measured Photoresist Removal Performance with Non-Equilibrium Processing with T2>T1

We tested one embodiment of the invention in which ozone is dissolved in water at a lower temperature to produce a high dissolved concentration, then passed at given flow rate though a point of use heater, and applied at a higher temperature to the center of spinning wafer. With both I-line and DUV positive photo resist and showed that we were able to achieve an I-line positive photoresist etch rate of 16,812 A°/minute and DUV positive photoresist etch rate of 10,626A°/minute. (See Tables 9 and 10.). These etch rates are about a factor of five higher than the highest etch rates than we were able to initially achieve using conventional techniques (compare to Tables 7 and 8). The mass transport M is generally higher at a higher RPM and the etch rate is higher as well.

We again see that I-line positive photoresist is etched by the process at a faster rate than DUV resist because the I-line positive photoresist has a higher value of S than DUV positive photoresist at a given temperature.

TABLE 9
The measured etch rate when ozone is dissolved in water at a lower
temperature to produce a high dissolved concentration, then passed
at given flow rate though a point of use heater, and applied at a higher
temperature to the center of spinning wafer. The wafer is coated with a
layer of hard baked I-line positive photoresist. The highest etch rate is
achieved at the center of the wafer and the lowest etch rate is achieved
at the edge of the wafer.

| Dissolved | | | | | | |
|---|---|---|---|---|---|---|
| Ozone | Dis- | | | | | |
| Concen- | solved | Applied | Flow | Wafer | Max Etch | Min Etch |
| tration | Temp. | Temp. | Rate | spin | Rate | Rate |
| (mg/L) | (deg C.) | (deg C.) | (L/min) | (RPM) | (A°/min) | (A°/min) |
| 95 | 7.5 | 49.5 | 2.7 | 1000 | 20208 | 9459 |
| 95 | 7.5 | 47.5 | 2.7 | 4000 | 23850 | 16812 |

TABLE 10
The measured etch rate when ozone is dissolved in water at a given
temperature and given concentration and applied at a given flow rate
though a point of use heater and through a dispense nozzle at a higher
temperature to the center of spinning wafer coated with a layer of hard
baked DUV positive photoresist. The highest etch rate is achieved at
the center of the wafer and the lowest etch rate is achieved at the edge
of the wafer.

| Dissolved | | | | | | |
|---|---|---|---|---|---|---|
| Ozone | Dis- | | | | | |
| Concen- | solve | Applied | Flow | Wafer | Max Etch | Min Etch |
| tration | Temp. | Temp. | Rate | spin | Rate | Rate |
| (mg/L) | (deg C.) | (deg C.) | (L/min) | (RPM) | (A°/min) | (A°/min) |
| 95 | 7.5 | 48.5 | 2.7 | 1000 | 16227 | 6117 |
| 95 | 7.5 | 47.5 | 2.7 | 4000 | 19413 | 10626 |

We have presented experimental results on a method for removing photoresist at high speed using a solution of ozone gas dissolved in water comprising the steps of a) dissolving high ozone gas in water at a relatively low predetermined temperature to form an ozone-water solution with a high dissolved ozone concentration, b) heating the ozone-water solution with a point-of-use water heater (a liquid to liquid heat exchanger) to quickly increase the solution temperature to a predetermined higher temperature, and c) applying the heated ozone-water solution to the center of a photoresist coated wafer rotating at high speed. The etch rate is increased, not only because the surface reaction rate is increased at the higher temperature, but also because the heated ozone-water solution has a much higher dissolved ozone concentration at the higher temperature than could be achieved if the ozone gas was initially dissolved in water at the higher temperature under equilibrium conditions

Alternative Means for Applying Ozone-Water Solution to The Substrate: The application of the ozone-water-other chemicals solution to the surface or surfaces of the material to be processed can be accomplished in a number of different ways. In the preferred embodiment the solution can be applied to the center of the wafer through a single solid stream nozzle 36 with an inside diameter of about 6 mm positioned to apply a flow of water to the wafer at the center. In a second embodiment the solution can successively applied to different positions between the center and edge of the wafer. In this second embodiment the ozone-water solution can be flowed through a nozzle which can be successively positioned at different locations from the center to the edge of the wafer or from the edge to the center of the wafer. The dwell time at each position can be controlled to reduce the radial variation in the etch rate or cleaning rate or oxidation rate over the duration of the materials processing cycle. In a third embodiment the solution can be applied the surface of the wafer with multiple nozzles 36A, 36B, 36C, . . . (not shown). In the fourth embodiment one or more nozzles may be mounted on one or more rotating spray arms (not shown) positioned to apply the solution to one or more surfaces of the material to be oxidized. The ozone-water-other chemicals solution can be applied to the surface or surfaces of the material to be processed by other means familiar to those skilled in the art.

Alternative Means for Applying DI Rinse Water to The Substrate. In an alternative embodiment the DI rinse water may be applied to the substrate with a separate set of one or more rinse nozzles (not shown). Rinse nozzles may be chosen for optimum rinse performance at a predetermined rinse flow rate and the nozzles may be positioned to rinse one more surfaces of the substrate.

Optional Instrumentation Upstream of the Dispense Point: A dissolved ozone monitor and temperature sensor may be inserted in the short length of tubing just upstream of the dispense nozzle 36. This instrumentation provides a continuous readout of the dissolved ozone concentration and temperature of the heated ozone-water solution just upstream of the dispense point. This can be a source of useful diagnostic information during process development. Since the elements add additional volume between the inlet of the water heater 28 and the point of application of the solution to the material 38, the internal volume of these optional instrumentation sensors should be small so that the residence volume through which the heated ozone-water solution must pass is kept small and the time delay between heating the ozone-water solution and applying the heated ozone-water solution to the material 38 is kept sufficiently small as discussed earlier.

Alternative Locations of the Back Pressure Regulator for an Ozonated Water Supply Designed to Dissolve Ozone Gas in Water at a Pressure Greater Than 1 Atmosphere (14.5 psia.) In an ozonated water supply designed to dissolve ozone gas in water at a pressure above 14.5 psia, a gas back pressure regulator is typically placed in the waste-ozone off-gas (undissolved ozone gas) outlet of the ozone gas-water contactor element and a liquid back pressure regulator is typically placed in the ozonated outlet line of the ozone-gas water contactor element. In the preferred embodiment for spin processing or semiconductor wafers and the like, the apparatus is designed to apply the ozone gas-water solution to the material to be oxidized 38 in a material processing module operated at one atmosphere pressure. In one embodiment the liquid back pressure regulator may be positioned between the outlet of the ozonated water supply 22 and the inlet of the two three-way valve 24. Alternatively, the liquid back pressure regulator may be moved to a position just upstream of the dispense nozzle 36 to minimize the time available for the ozone gas to leave the ozone-water solution from the time the pressure is reduced to atmospheric pressure and the solution is applied to the material. In systems designed to apply the ozone gas-water solution to the material to be oxidized 38 in a material processing module operated at the same pressure as a pressurized ozone-gas-water contactor element, the liquid back pressure regulator may be positioned at the liquid outlet of a pressurized materials processing module and the gas back pressure regulator, which is typically placed in the waste-ozone off-gas outlet of the ozone gas-water contactor, can be relocated to the waste-ozone off-gas outlet of the materials processing module.

Alternative Locations of the Back Pressure Regulator for an Ozonated Water Supply Designed to Dissolve Ozone Gas in Water at a Pressure Greater Than 1 Atmosphere (14.5 psia.) In an ozonated water supply designed to dissolve ozone gas in water at a pressure above 14.5 psia, a gas back pressure regulator is typically placed in the waste-ozone off-gas (undissolved ozone gas) outlet of the ozone gas-water contactor element and a liquid back pressure regulator is typically placed in the ozonated outlet line of the ozone-gas water contactor element. In one embodiment for spin processing or semiconductor wafers and the like, the apparatus is designed to apply the ozone gas-water solution to the material to be oxidized 38 in a material processing module operated at one atmosphere pressure. In one embodiment the liquid back pressure regulator may be positioned between the outlet of the ozonated water supply 22 and the inlet of the two three-way valve 24. Alternatively, the liquid back pressure regulator may be moved to a position just upstream of the dispense nozzle 36 to minimize the time available for the ozone gas to leave the ozone-water solution from the time the pressure is reduced to atmospheric pressure and the solution is applied to the material. In systems designed to apply the ozone gas-water solution to the material to be oxidized 38 in a material processing module operated at the same pressure as a pressurized ozone-gas-water contactor element, the liquid back pressure regulator may be positioned at the liquid outlet of a pressurized materials processing module and the gas back pressure regulator, which is typically placed in the waste-ozone off-gas outlet of the ozone gas-water contactor, can be relocated to the waste-ozone off-gas outlet of the materials processing module. The pressure setting of the back pressure regulator positioned downstream of the heating means is discussed in the beginning of the specification.

Operation—FIG. 5A

A preferred technique for applying the ozone-water solution to semiconductor substrates and the like is to apply the ozone-water solution to the surface of the substrate while spinning the substrate about an axis at a relatively high (1,000 to 4,000 rpm) rotational speed. The use of a this method for applying the ozone-water solution to semiconductor substrates and the like provides for a higher mass transport rate M than can be achieved by immersion techniques. One very important use of the preferred embodiments is for the removal of photoresist and post etch residue from semiconductor wafers and the like. Let us describe the operation for a typical photoresist or post etch residue removal application. With reference to FIG. 5A, ozononated water supply 22 supplies an ozonated water formed by dissolving ozone gas at a gas phase concentration of 240 mg/L and pressure of 14.5 psia (1 bar) into DI water chilled to a temperature of about 8 degree C. The ozonated water supply delivers the chilled ozone gas-water solution at a dissolved concentration of about 90 mg/L and at a flow rate of 2.7 Liter/min through three way purge valve 24, through heat exchanger 28 or point-of-use heater 29 where the solution temperature is increased to about 50 degree C., through chemical injector/mixer 40, through three-way purge valve 32, through three-way etch/rinse valve 46, through materials-processing-module inlet 48, through dispense nozzle 36 where the heated ozone-water solution is applied to the center of a semiconductor wafer 38 spinning at about 3500 to 4,000 rpm. Under these conditions the inventors have shown that the dissolved ozone concentration downstream of the point-of-use heater is approximately 75 mg/L, more than 80 percent of the concentration at the inlet of the point-of-use heater. The ozone-water solution traverses the surface to the wafer from the point of application to the edge of the wafer and enters the process fluid outlet of the materials-processing-module where the ozone-water solution and other liquid effluents from the process are carried through a trap to facility drain 56. The trap prevents back flow of an gases from the facility drain reclaim reservoir. The nitrogen purge supply flows dry filtered nitrogen gas, or another suitable gas, at a flow rate of about 0.5 L/min, through the two-way nitrogen purge valve 70, to the inlet of the materials-processing-module 72. The nitrogen gas assists in the removal of any ozone gas that leaves the ozone-water solution inside the materials-processing-module and provides an nitrogen blanketed processing environment. The ozone off-gas, nitrogen, and other waste gases from the process, exit from the materials-processing-module at outlet port 62, pass through the catalyst unit 64 where the waste ozone gas is converted to oxygen before exiting to the facility exhaust vent 66. The period during which the ozone-water solution is applied to the spinning substrate can be designated as the duration of the etch clean cycle. Once the etch cycle is completed, the three way purge valve 32 can be set to direct the flow of the heated ozone-water solution to the facility drain/reclaim 34 for the heated ozone-water solution and the three-way etch/rinse valve 46 can be placed in the rinse position to allow the rinse water to flow to the materials-processing-module. DI water can then flow from the pressurized DI water supply through the three way valve 46, through materials-processing-module inlet 48, through dispense nozzle 36 where the DI water solution is applied to the center of a semiconductor wafer 38 spinning at about 3500 to 4,000 rpm. The period during which the DI rinse water is applied to the spinning substrate 38 can be designated as the duration of the rinse cycle. Once the rinse cycle is completed, the three-way etch rinse valve 46 can be returned to the etch position while the three-way purge valve 32 remains set to direct the flow of the heated ozone-water solution to the facility drain/reclaim 34 so that all liquid flows to materials-processing-module are off and the wafer can be spun dry. The period during which all liquid flows to the materials processing module are off and the substrate is spinning can be designated as the duration of the spin dry cycle. The spin RPM and duration of each cycle can be set to a predetermined value for a particular process application.

Materials Processing Method With A Spin Processor

Description—FIG. 5B.

With reference to FIG. 5B, liquid back-pressure regulator 158 is positioned downstream of drain outlet port 52 of materials processing module 50 and gas back-pressure regulator 180 is placed downstream of gas outlet port 62, either upstream of catalytic unit 64 or downstream of catalytic unit 64 as shown in this example.

Operation—FIG. 5B

With reference to FIG. 5B, liquid back-pressure regulator 158 may be set to a predetermined back pressure. The liquid back-pressure regulator serves to maintain the liquid pressure upstream of the regulator (and down stream of drain outlet port) over a range of liquid flow rates. Gas back-pressure regulator 180 may be set to a predetermined back pressure (typcally the same as that of the liquid back-pressure regulator. The gas back-pressure regulator serves to maintain the gas pressure upstream of the regulator (and down stream of module 50 gas outlet port 52) over a range of flow rates.

Example Process Conditions for Photoresist Removal And Post Etch Residue Removal. A typical wafer spin processing sequence my include spin etch or cleaning or oxidation cycle, a spin rinse cycle, and a spin dry cycle. Example process conditions for photoresist removal and post etch residue removal with 150 mm diameter wafers in a single wafer spin processing configuration are summarized in Table 11 below.

TABLE 11
Example Process Conditions for Photoresist Removal And Post Etch
Residue Removal-Single Wafer Processing Configuration - 150 mm
Diameter Wafers

| | |
|---|---|
| ETCH CLEAN | |
| Dissolved Ozone Concentration | 70 to 210 mg/L |
| (mg/L)/(millimoles/liter) | (1.5 to 4.5 millimoles/L) |
| Hydroxyl Radical Scavenger | Carbonate, Bicarbonate, |
| | Phosphate, Acetate |
| Hydroxy Radical Scavenger Concentration | 5 to 10 × dissolved |
| (millimoles/liter) | ozone concentration |
| pH | 6.5 to 7.5 |
| Ozone-Water Solution Temperature at the | 40 to 60 |
| point of application (° C.) | |
| Spin Etch Speed (RPM) | 1,000 to 4,000 |
| Ozone-Water Solution Flow Rate (L/min) | 1.0 to 3.0 |
| Etch Duration (min) | 0.5 to 6.0 |
| RINSE | |
| DI Rinse Temperature (° C.) | 20 to 50 |
| Spin Rinse Speed (RPM) | 1,000 to 4,000 |
| DI Rinse Flow Rate (L/min) | 0.5 to 1.0 |
| DI Rinse Duration (min) | 0.167 to 1.0 |
| DRY | |
| Spin Dry Speed (RPM) | 2,000 to 4,000 |
| Dry Duration (min) | 0.167 to 1.0 |

These process conditions are typical for this type of application. However, process conditions outside the range of values presented in the Table 11 above can also provide satisfactory performance for this and other applications and wafer processing configurations. For example, batch wafer spinning configurations in which two to four cassettes of wafers are processed at one time typically operate at a lower RPM and lower etch flow rate per wafer. The RPM for a batch spinner is typically in the range of 500 to 1500 RPM. The total etch chemistry flow rate for a batch wafer spinner is typically in the range of 10 to 20 liters/minute. The lower RPM and lower flow rates will yield a lower mass transport rate and lower etch rate. The temperature at which the etch rate will become mass transport limited will be lower since the mass transport rate is lower as discussed earlier.

Process Performance Measured by the Inventors: A typical duration for an etch cleaning cycle for removing photoresist and post etch residue is 0.5 to 6 minutes. The inventors have demonstrated the ability to remove hard baked Olin OCG-897 I-line positive photoresist from semiconductor wafers at an etch rate of approximately 17,000 Angstroms/minute. The inventors have demonstrated the ability to remove hard baked Shipley UV6 DUV positive photoresist from semiconductor wafers at an etch rate of approximately 11,000 Angstroms/minute. The etch rate is generally lowest at the wafer edge. The reported etch rates are those measured at the wafer edge at a flow rate of 2.7 L/min., a dissolved ozone concentration of about 75 mg/L, a spin speed of about 4,000 RPM, and temperature of approximately 50 degree C., and hydroxyl radical scavenger concentration of about 15 millimoles/Liter. The inventors have demonstrated the ability to remove both post metal etch resist and resist residue under similar conditions from test structures using 0.35 μm technology with I-line resist in less than 1.5 minutes at 50 degree C. The inventors have demonstrated the ability to remove both post metal etch resist and resist residue from test structures using 0.18 μm technology with DUV resist in less than 3.0 minutes at 50 degree C. It is useful to compare to cycle times of this new ozone-water post etch cleaning process with the current process based upon plasma ashing and solvent residue removal. This is summarized in Table 12 below.

TABLE 12
Post Metal Etch Clean at 50 deg. C.: Comparison with
Conventional Process

| | CONVENTIONAL | | | NEW OZONE-WATER | | |
|---|---|---|---|---|---|---|
| | PROCESS | | | PROCESS | | |
| | | I-line | DUV | | I-line | DUV |
| | | resist | resist | | resist | resist |
| | | Time | Time | | Time | Time |
| | Process | Req'd | Req'd | Process | Req'd | Req'd |
| Step # | Step | (min) | (min) | Step | (min) | (min) |
| | single wafer process | | | single wafer process | | |
| 1 | O2 Ash | 3.0 | 5.0 | Ozone | 1.5 | 3.0 |
| | | | | Etch | | |
| 2 | Hot/Cold | 1.5 | 1.5 | Cold DI | 0.5 | 0.5 |
| | DI Rinse | | | Rinse | | |
| 3 | Spin Dry | 0.5 | 0.5 | Spin Dry | 0.5 | 0.5 |

| | batch process | | | |
|---|---|---|---|---|
| 4 | Batch | 10 | 10 | NA |
| | Solvent | | | |
| | Clean | | | |
| 5 | Batch DI | 5 | 5 | NA |
| | Rinse | | | |
| 6 | Batch | 5 | 5 | NA |
| | Spin Dry | | | |

This new ozone-water process has demonstrated the potential to replace the conventional plasma ashing and solvent cleaning process used for post-metal-etch clean. The process can be readily integrated into a single wafer cluster tool at a low cost. A single ozone-water spin etch module would replace the plasma ashing module and hot DI rinse/spin dry module. The process has demonstrated the ability to remove the post metal etch resist and resist residue from the test structures using 0.35 μm technology with OCG 897-12 positive I-line resist in 1.5 minutes. The process has demonstrated the ability to remove the post metal etch resist and resist residue from the test structures using 0.18 μm technology with Shipley UV6 positive DUV resist in 3.0 minutes.

The process has demonstrated the ability to remove the post oxide etch resist and resist residue from the test structures using 0.35 μm technology with OCG 897-12 positive I-line resist in 1.0 minutes. The process has demonstrated the ability to remove the post oxide etch resist from the test structures using 0.18 μm technology with Shipley UV6 positive DUV resist in 3.0 minutes. However, the process has not yet demonstrated the ability to completely remove the post-oxide-etch residue from the test structures using 0.18 μm technology with Shipley UV6 positive DUV resist with a cycle time of 5 minutes. In applications using I-line resist only the new ozone-water process has the potential to replace the conventional plasma ashing and solvent cleaning process used for post-oxide etch clean.

Materials Processing Method With Spray Processor

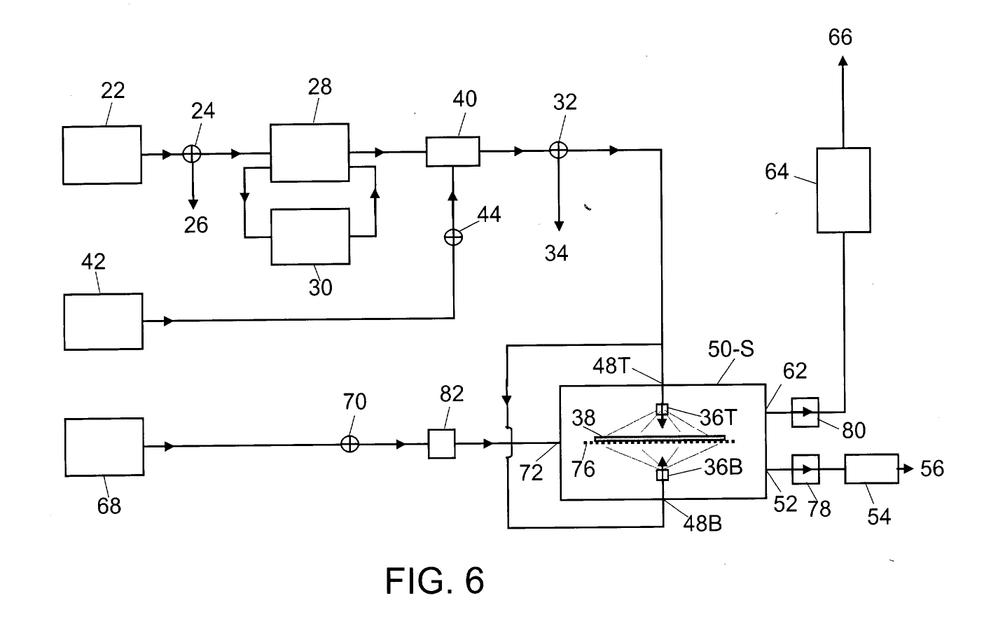

Description—FIG. 6

There are a number of applications in which one may wish to process materials such as medical instruments, bio-materials, and medical devices for the purpose of surface treatment, cleaning, disinfection, or sterilization. In these types of applications alternative processing configurations can be used. The principal difference between the spray processor and the spin processor shown in FIG. 6 is that the spray processor does not spin the material to be processes at high RPM. The materials to be processed may not be able to be spun at high RPM because of their mass, size, or asymmetric shape. In this case the instruments or materials to be processed can be placed on a rack or wire mesh support and the heated ozone-water-chemical solution can be applied to the materials from multiple directions using one or more spray heads. The materials may be mounted on a rack or supporting structure that permits good access for the spray and the heated ozone-water-chemical solution my be applied with one or more spray heads. The spray heads may be fixed in position, mounted on rotating spray arms, mounted on translating spray arms. The rack or structure that supports the materials to be processed may be fixed in position, may be slowly rotated at low rpm, or may be slowly translated. A materials processing module designed for sterilization of materials or devices or instruments must have several additional elements to prevent microbial contamination of the materials processing module. The additional elements may be understood by referring to FIG. 6. The elements 22, 24, 26, 28, 29, 30, 32, 34, 36, 38, 40, 42, 44, 48, 50, 52 54, 56, 62, 64, 66, 68, 70, and 72 are the same as defined earlier. A materials processing module designed for sterilization does not require a separate rinse supply. Accordingly, the rinse supply 74 and etch rinse valve 46 is not required. Three-way valve 32 is connected by short lengths of tubing through the process fluid inlet 48T and 48B to top spray assembly 36T and bottom spray assembly 36B located above and below a support structure 76. A drain line check valve 78 is located between the process-fluid outlet 52 and the trap 54 to prevent backflow to the process module. A vent line check valve 80 is located between the off-gas outlet 62 and the catalytic ozone destruction unit 64 to prevent backflow to the process module. A purge gas sterile filter 82 is located between the outlet of two-way purge gas valve 70 and the purge gas inlet 72.

Operation—FIG. 6

In reference to FIG. 6, the operation of the spray processor is similar to that of the spin processor. The ozone gas-water solution is formed at a relatively low temperature and heated at the point-of-use as described earlier. Additional chemicals can be injected at the point-of-use from one or more chemical supplies as described earlier. The heated ozone-water solution flows from the outlet of three-way valve 32 through the process fluid inlets 48T and 48B in the spray type materials processing module 50-S to the top and bottom spray assemblies 36T and 36B The material to be processed or sterilized 38 is positioned on an open support structure 76. The support structure is designed to not block the spray from impinging on the surfaces of the material to be processed or sterilized. The heated ozone gas-water solution is sprayed onto all surfaces of the materials or instruments or devices with the top and bottom spray assemblies 36T and 36B. If the instruments have internal channels that must be sterilized, then the heated ozone gas-water solution may be also flowed through those internal channels as well. Ozone dissolved in water is a zero residue sterilant. However, if additional chemicals such as surfactants are injected and mixed with ozone-water solution to improve wetting and soil removal during the sterilization cycle, then the residues of those added chemicals may need to be rinsed from the surfaces of those instruments or materials in a subsequent sterile rinse cycle.

A sterile water rinse method not requiring a sterile filter. In the prior art the sterile rinse has been implemented by passing water through a 0.2 micron sterile filter. This type of filter becomes clogged with use and must be replaced at regular intervals. In the present embodiment, one can use the heated ozone gas-water solution as a sterile rinse solution. The solution may be used with no additional injected chemicals except perhaps a chemically benign buffer and scavenger. One good candidate buffer is a phosphate buffer made by mixing KH2PO4 and Na2HPO4. Another candidate buffer is boric acid and sodium borate. The phosphate or borate will also serve as a hydroxyl radical scavenger. The ozone gas dissolved in water to form a supply of ozonated water will quickly kill the most resistant organisms. The 12D sterilization time for the most resistant water-borne organisms such as Giardia and Cryptosporidium at a dissolved ozone concentration of only 60 mg/L is 0.2 minutes (12 seconds) as shown in Table 13. The residence time of a typical ozone gas-water contactor used in an ozonated water supply is much longer than 12 seconds. The residence time in a recirculating contactor can be higher. Accordingly, the ozone-water solution dispensed from the ozonated water supply at a concentration of about 60 mg/L will be sterile water. When the ozone-water solution is passed through the point-of-use heater 28 or 29 and heated to a higher temperature (50 degree C. for example), the concentration will decay to a low value with an exponential decay time constant estimated by the inventors to be about 25 seconds. The materials processing chamber may be continuously purged with sterile nitrogen or sterile air during the sterilization cycle to sweep the waste ozone off-gas from the chamber. When the instruments or devices are removed from the instrument chamber at the end of the sterilization and optional rinse cycle, the dissolved ozone concentration will have decayed to a very low value. Example process conditions for medical instrument and medical device sterilization are shown in Table 14.

TABLE 13
The lethality of ozone dissolved in water at a specified concentration
against microorganisms in aqueous suspension in a stirred reactor. The
time required to achieve a 12 log reduction in the specified organism
at two different concentrations is calculated from the measured D value
data. The D value is the time required to reduce the number of viable
organisms by a factor of 10 at a specified sterilant concentration C

| | D | | 12D | |
|---|---|---|---|---|
| | secs | 12CD | minutes | |
| Microorganism | C = 10 mg/l | mg · min/l | C = 60 mg/l | note |
| Eschrichia Coli | 0.03 | 0.06 | 0.001 | a |
| Striptococcus Fecalis | 0.045 | 0.09 | 0.002 | a |
| Mycobacterium | 0.15 | 0.3 | 0.005 | a |
| Tuberculosum | | | | |
| Polio Virus | 0.06 | 0.12 | 0.002 | a |
| Endamoeba Histolytica | 1 | 2 | 0.033 | a |
| Bacillus Megatherium | 3 | 6 | 0.100 | a |
| (Spores) | | | | |
| Giardia Lamlia, Giardia | 6 | 12 | 0.200 | a |
| Muris (Cysts) | | | | |
| Cryptosporidium | 6 | 12 | 0.200 | a |

Note
a: Block, 1978; Sobsey, 1989: D values measured at a dissolved concentration of 1-2 mg/l, pH 7, and temperature of 15° C.

TABLE 14
Example Process Conditions for Medical Instrument and Medical
Device Sterilization

| | |
|---|---|
| STERILIZE | |
| Dissolved Ozone Concentration | 70 to 210 mg/L |
| (mg/L)/(millimoles/liter) | (1.5 to 4.5 millimoles/Liter) |
| Hydroxyl Radical Scavenger | Examples: Carbonate, |
| | Bicarbonate, Phosphate, |
| | Acetate |
| Hydroxyl Radical Scavenger | 5 to 10 × dissolved ozone |
| Concentration (millimoles/liter) | concentration |
| pH Buffer | Examples: Phosphate, Borate |
| pH Buffer Concentration | ˜10 millimoles/Liter |
| pH | 6.5 to 7.5 |
| Surfactant - optional | Non-ionic and |
| | Anionic Mixture |
| Sequestering Agent - optional | Examples: Sodium |
| | Tripolyphosphate (STTP) |
| Sequestering Agent Concentration | 10 millimoles/Liter |
| Ozone-Water Solution (Sterilant) | 30 to 50 |
| Temperature at the point of application to | |
| the (° C.) | |
| Ozone-Water Solution Flow Rate (L/min) | 5 to 10.0 |
| Sterilization Cycle Duration (min) | 5 to 10.0 |
| RINSE - optional | |
| DRY - optional | |

Process Performance Measured by the Inventors: The inventors have calculated the steriliant efficacy of an ozone-water solution at different solution temperatures for a dissolved ozone concentration of 60 mg/L based upon inactivation rates, measured by the inventors under equilibrium conditions, for AOAC porcelain penicylinders and AOAC Dacron polyester suture loop carriers inoculated with 1E6 Bacillus Subtilus spores according to the AOAC protocol.

Inactivation times are influenced not only by surface reaction rate but also by the dissolved concentration. They are also confounded by the statistical nature of the carrier inactivation process. We computed the average 12CD value for inactivation of carriers at each of the different equilibrium temperatures and dissolved concentrations. The use of the concentration-time product effectively normalized the results by the concentration. The results showed there is a very strong temperature dependence of inactivation rate. The analysis demonstrated that the inactivation at 20 deg. C. is not mass transport limited, but surface reaction rate (temperature) limited.

The results for penicylinders are presented in Table 15. The parameter 12CD is the concentration-time product for inactivation of a million spore challenge with a million to one assurance level. We see that an increase in the temperature from 20 deg. C. to 30 deg. C. (10 deg. C. increase), causes the 12CD value to decrease by more than a factor of 4 from 14 to 2.6. In next column (col. 6). We have computed the value of 12 CD at 10, 30, 40, and 50 deg. C. from the measured value at 20 deg. C. The computation is based upon the following hypothesis: 1) the surface reaction rate coefficient S increases by a factor of 2 for every 5 deg. C. increase in temperature (similar to that observed for the oxidation of polymer films), and 2) the overall reaction rate is dominated by the surface reaction rate over the temperature range. This assumption seems to be valid up to 30 deg. C. We have also computed the predicted 12D sterilization time at a dissolved ozone concentration of 60 mg/L (see table column 7). Further measurements will be required to determine the point at which the reaction becomes mass transport limited.

TABLE 15
The measured and calculated temperature dependence of the D value and
12 D sterilization time for porcelain penicyliders inoculated with bacillus
subtilis (BS) var niger spores (ATCC 19659) according to AOAC protocol.
The initial spore population was at least 1E6 CFU per carrier

| | | | | | 12CD | |
|---|---|---|---|---|---|---|
| | | Total No. | | | hr · mg/L | |
| | No. of | of | D value | 12CD | calculated | 12D time |
| Temp. | Replicate | Carriers | min. @ | hr · mg/L | from values @ | minutes @ |
| deg. C. | Tests | Tested | 60 mg/L | measured | 20 deg. C. | C. = 60 mg/L |
| 10 | | | | | 56 | 56 |
| 20 | 24 | 153 | 1.2 | 14 | 14 | 14 |
| 30 | 7 | 43 | .3 | 2.6 | 3.5 | 3.5 |
| 40 | | | | | .875 | .875 |
| 50 | | | | | .215 | .215 |

The results for polyester suture loops are presented in Table 16. We see that polyester suture loops are more resistant to inactivation than penicylinders, and hence the FDA approved cycle time is generally determined by suture loop inactivation time. We see that an increase in the temperature from 10 deg. C. to 20 deg. C. to 30 deg. C. (10 deg. steps), causes the 12CD value to decrease by nearly a factor of 4 for each step from 285 to 71 to 26. In next column(col. 6) we have again computed the value of 12 CD at 10, 30, 40, and 50 deg. C. from the measured value at 20 deg. C. based upon the assumption stated above. Again, the results are remarkably consistent with the model. However, there is only one replicate at 30 deg. C. More data is required to prove the hypothesis.

TABLE 16
The measured and calculated temperature dependence of the D value and 12 D
sterilization time for polyester suture loops inoculated with bacillus subtilis (BS)
var niger spores (ATCC 19659) according to AOAC protocol. The initial spore
population was at least 1E6 CFU per carrier

| | | | | | 12CD | |
|---|---|---|---|---|---|---|
| | | | | | hr · mg/L | |
| | No. of | Total No. | D value | 12CD | calculated | 12D time |
| Temp. | Replicate | of Carriers | min. @ | hr · mg/L | from values @ | minutes @ |
| deg. C. | Tests | Tested | 60 mg/L | measured | 20 deg. C. | C = 60 mg/L |
| 10 | 13 | 168 | 24 | 285 | 284 | 284 |
| 20 | 5 | 64 | 6 | 71 | 71 | 71 |
| 30 | 1 | 6 | 1.5 | 26 | 17.8 | 17.8 |
| 40 | | | | | 4.4 | 4.4 |
| 50 | | | | | 1.1 | 1.1 |

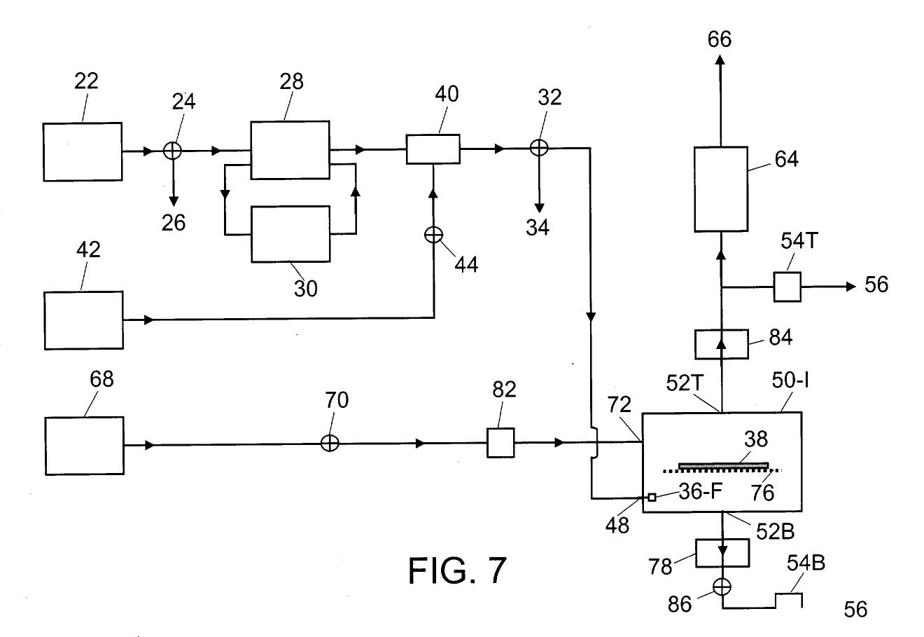

Materials Processing Method With Immersion Processing
Description—FIG. 7

Spin processing and spray processing configurations can generally provide better mass transport to the surface of the material to be processed than can immersion processing configurations. However, there are some applications where immersion processing can offer other advantages with respect to full wetting of complex surfaces. This can be particularly important in sterilization processing applications. In reference to FIG. 7, the outlet of three way valve 32 is connected by a short length of tubing to the process fluid inlet 48 of an immersion type materials processing module 50-I to a fill nozzle 36-F. The drain outlet 52B is connected by a short length of tubing to drain check valve 86. The outlet of check valve 86 is connected by a length of tubing to a drain line trap 54B. The drain line trap 54B is connected by a length of tubing to facility drain/reclaim 56. Purge gas supply 68 is connected by a short length of tubing to the inlet of two-way valve 70. The outlet of two-way valve 70 is connected to the inlet of sterile filter 82. The outlet of sterile filter 82 is connected to the module purge gas inlet 72. The overflow/waste gas vent outlet 52T is connected through a length of tubing to the inlet of a check valve 84. The outlet of the check valve 84 is connected to the inlet of a trap 54T. The outlet of trap 54T is connected to the facility drain/reclaim for process effluent 56. The outlet of check valve 84 is also connected to the to inlet of the catalytic ozone destruction unit 64. The outlet of the catalytic ozone destruction unit 64 is connected to a facility exhaust vent 66. The material(s) to be processed 38 may be in position inside the process module with a support structure 76.

Operation—FIG. 7

In reference to FIG. 7, the ozone gas-water solution is formed at a relatively low temperature and heated at the point-of-use as described earlier. Additional chemicals can be injected at the point-of-use from one or more chemical supplies as described earlier. The heated ozone-water solution flows from the outlet of three-way valve 32 through the process fluid inlet 48 in an immersion type material processing module 50-I to the a fill nozzle 36-F while the drain valve 86 is closed. Once the immersion module fills completely to the top with the heated ozone-water solution and the materials to be processed are immersed in the heated ozone-water solution, the heated ozone-water solution, together with any gases, flows out of the overflow/vent outlet 52T through filter 84, through the trap 54T to the facility drain/reclaim 56 for process effluent. Most of the undissolved gases that exit from the module pass through the catalytic ozone destruction unit 64 to the facility exhaust vent 66. The immersion processing module can be designed with baffles or other means to insure that the surfaces of the materials are continuously exposed to fresh heated ozone-gas-water solution as the solution is flowed from the module inlet 48 to the module overflow/vent outlet 52T. The module can be designed to hold instruments, devices, or materials with a minimum volume and thereby decrease the residence of the heated zone-water solution for a given ozone-water solution flow rate. The dissolved ozone concentration of the heated ozone-water solution will decay with time with a temperature dependent decay rate as discussed earlier. The residence time of the solution in the immersion module can be set at a predetermined value to insure that the dissolved concentration does not fall below a predetermined value for the duration of the cleaning or sterilization or oxidation process cycle. Once the cleaning cycle is complete the flow of the heated ozone-water solution to the process module may be stopped by setting the thee-way valve 32 to direct the flow to the facility drain/reclaim 34 for the heated ozone-water solution. The module may be drained by opening the drain valve 78 and opening the two-way purge 70 to admit nitrogen, air, or some other purge gas into the module to replace the liquid that is drained from the module through check valve 86, through trap 54B to facility drain/reclaim 56. If the module is designed for sterile processing, then the filter 82 may be 0.2 micron filter to remove microbes from the purge gas. If the module is designed for ultra-clean processing, then the filter 82 may be designed to remove particulate contamination from the purge gas. It is desirable to design the immersion processing module with baffles and other means to insure that the flow of liquid from the inlet to the outlet is approximately plug flow to insure that most of the “reduced concentration” or “spent” ozone-water solution and oxidation or cleaning byproducts are swept from the module and replaced by a “fresh” heated ozone-water solution. An alternative method of insuring that the “reduced concentration” or “spent” ozone zone-water solution and oxidation or cleaning byproducts are removed from the module and replaced by a “fresh” heated ozone-water solution is to fill process the materials with a series of fill, hold, drain, fill, hold, drain cycles. The module may be drained and refilled once the dissolved ozone concentration has fallen to a predetermined level. The solution may be stirred or mixed during the holding period with a high flow recirculation pump, with a stirrer, with ultrasonic or megasonic transducers, or other means known to those skilled in the art. Since the dissolved concentration of the heated ozone-water solution falls more quickly at higher temperatures, optimum hold times will typically be shorter at higher processing temperatures.

Materials Processing Method With A Spin Processor—Back Pressure Provided by a Back Pressure Regulator at the Outlet of a Materials Processing Module with Small Internal Volume

In reference to FIGS. 5A and 5B we have shown one preferred method of materials processing with a spin processor. In the spin processor shown inside the dotted line box 200 in FIGS. 5A and 5B, the wafer mounted on a chuck that is contained in a closed module. The liquid flow from the module through a drain outlet and the off-gas flows from the outlet through a vent outlet. As discussed earlier, a back pressure regulator may be placed in the drain outlet line and a back pressure regulator may be placed in the vent line.

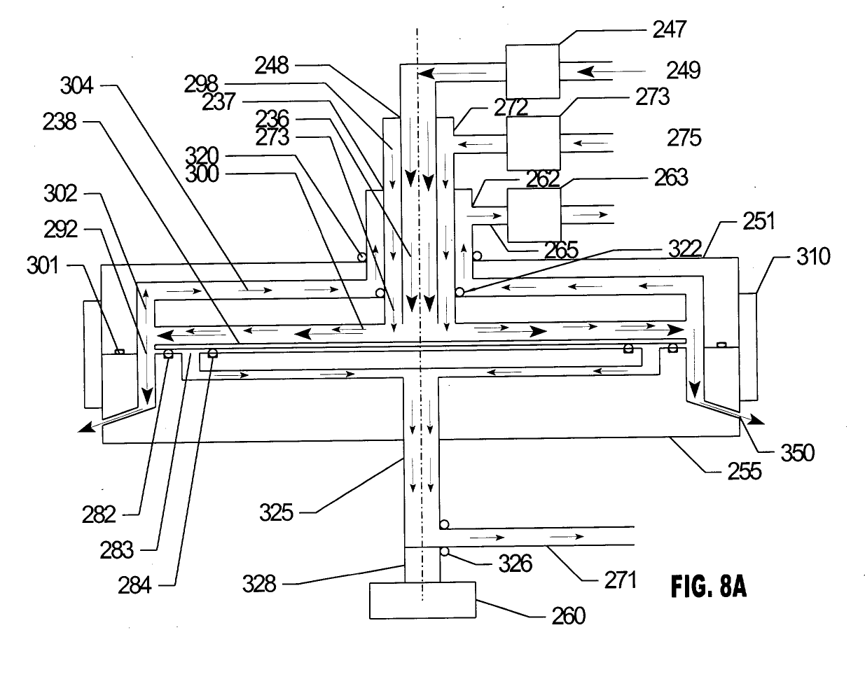

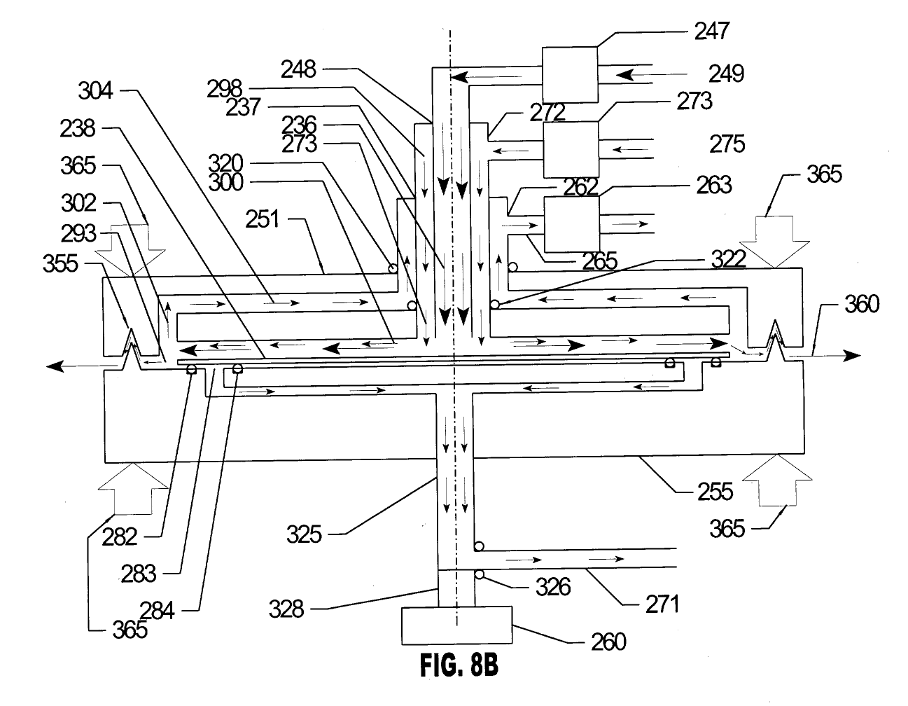

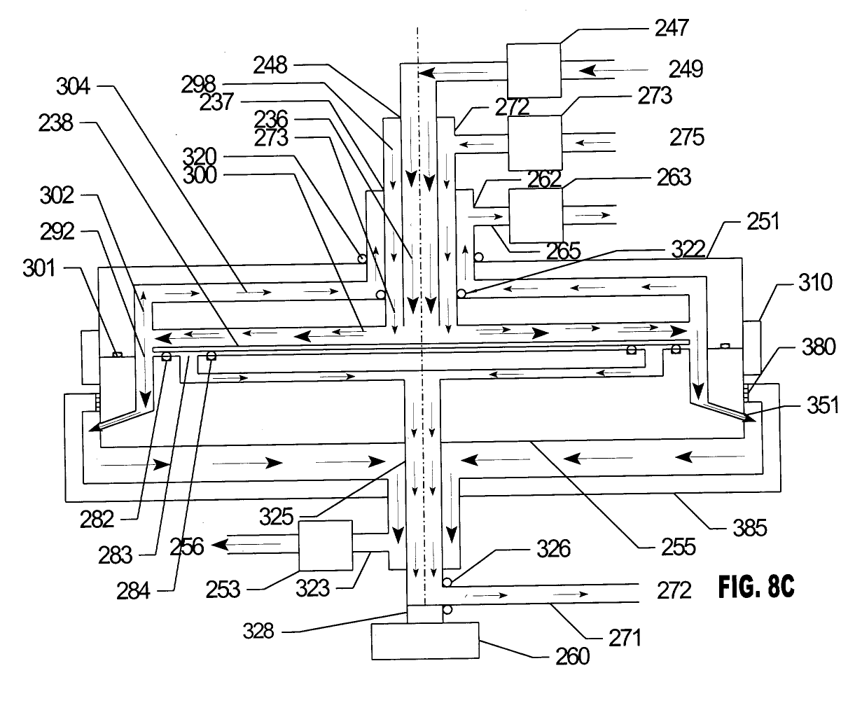

FIG. 8A

In reference to FIG. 8A, an alternative embodiment of a spin processor 200 of FIG. 5B is shown. In this embodiment, the wafer in mounted on a chuck with a mating top section which fully encloses the wafer. The chuck with its mating top section and wafer are then spin processed as an integral unit. The fluid connections to the bottom of the chuck and the mating top section are made at the center of each through fluid and gas tight rotary seals. This design is distinguished from that of FIG. 5B in a number of aspects: 1) The materials processing module may have a very small internal volume compared to conventional spin processing module such as the WS-400-TFM made by Laurell Technologies., 2) There module and wafer spin together whereas the wafer spins within a closed module in a conventional design. 3) The module is compact in size and can be readily integrated into a cluster of spin processors. 4) The module can be placed inside a housing similar to that of a conventional spin processor 5) The module top section may be lifted from the bottom chuck section for conventional spin processing inside of a conventional spin processor.

Description—FIG. 8A

FIG. 8A is an alternative embodiment of the spin processing module 200 shown in FIG. 5B. The module shown in FIG. 8A is designed to be connected to the same supporting hardware shown in FIG. 5B to supply the heated ozone-solvent chemical solution to the dispense nozzle, rinse water to the dispense nozzle, purge gas to the process module, a vent connection for the off-gas to a catalyst unit, and a connection to a facility drain/reclaim. This supporting hardware is not repeated in FIG. 8A for the sake of clarity.

FIG. 8A is a schematic cross sectional view of a circular process module comprising a bottom section 255 and a top section 251. Bottom section 255 contains an integral vacuum chuck with a annular vacuum slot 283 near the edge of the wafer 238. The annular vacuum slot 283 is sealed to back side perimeter of wafer 238 with two concentric seals 282 and 284. The outer seal prevents the intrusion of process liquids and process gases under the backside of the wafer. Annular vacuum slot 283 connected by radial manifold channels 280 to a centrally located vacuum outlet tube 325. Vacuum inlet tube 325 is connected to the vacuum tube 271 through a suitable gas tight and liquid tight rotary coupling 326. The vacuum tube 271 is connected to a source of vacuum 272.

Bottom section 255 also contains an integral annular drain slot 292 located just outboard of the wafer edge for collection of process liquids that flow radially outward from the central dispense nozzle 236 to the wafer edge. Annular drain slot 292 is connected by radial manifold channels 292 to a centrally located drain outlet tube 327. Drain outlet tube 327 is concentric to the vacuum outlet tube 325 Drain outlet tube 327 is connected to the drain tube 323 through a suitable gas tight and liquid tight rotary coupling 324. Drain tube 323 is connected through liquid back-pressure regulator 253 to the facility drain/reclaim inlet 256.

Motor 260 is connected to the vacuum inlet tube 325 through drive coupling 328. The vacuum inlet tube is designed to support weight of the spin process module and to serve is the connection between the spin process module and the motor 260. One approach is the use of a direct drive with a hollow shaft motor. Another approach is to use a gear or belt drive to couple the motor to the process module. Methods for connecting a vacuum chuck to a motor for spin processing a substrate are well known to those skilled in the art. Methods of providing gas tight and liquid tight rotary fluid couplings are also well known to those skilled in the art.

Top section 251 contains a center dispense nozzle 236 spaced a predetermined distance from the wafer surface. The dispense nozzle is connected by a dispense tube 248 through a check valve 247 to a three way etch dispense valve 249, either to a source of heated ozone-solvent solution or to a source of rinse solution. The central dispense nozzle supplies these process fluids to the center of the spinning wafer. The process fluids move radially outward to the edge of the wafer and then enter drain slot 292 as described above.

Top section 251 also contains an integral annular vent outlet slot 302 located just outboard of the wafer edge for collection of process off-gases such as ozone gas, oxygen gas, carbon dioxide that flow radially outward from the central dispense nozzle 236 to the wafer edge. Annular vent outlet slot 302 is connected by radial manifold channels 304 to a centrally located vent outlet tube 237. Vent outlet tube 237 is concentric to the purge gas supply tube 298. Vent outlet tube 237 is connected to the vent tube 265 through a gas back-pressure regulator 263 to a catalytic ozone destruct unit to the facility exhaust vent inlet. In an alternative embodiment, the gas back pressure regulator may be located downsteam of a catalytic ozone destruction unit.

Top section 251 also contains an integral annular purge gas inlet slot 273 located concentric to the dispense nozzle inlet at the center of the wafer. The purge gas inlet slot 273 is connected by purge gas inlet tube 272 which is concentric to the dispense inlet tube 248. Purge gas inlet tube 272 is connected through a check valve 373 to a source of purge gas 275. The purge gas can be run during the process or run at the end of the process to sweep residual process gases from the process module in preparation for the opening of the processing module for processed wafer unload and next wafer load. The radial manifold channels 304 to a centrally located vent outlet tube 237. Vent outlet tube 237 is concentric to the purge gas supply tube 298. Vent outlet tube 237 is connected to the vent tube 265 through a gas back-pressure regulator 263,to a catalytic ozone destruct unit to the facility exhaust vent inlet.

The set of three concentric tubes are connected to top section 251 by a set of gas tight and liquid tight rotary seals shown schematically as 320 and 322. This assembly process tube assembly can also be designed to serve as the bearing mounted spindle to support the rotary motion of the top and bottom assembly. In this way the top and bottom section of the process module can be supported by a top and bottom drive assembly. There are other means for driving the module that are well known to those skilled in the art. The process module comprising the top section 251, the bottom section 255 and the wafer 238 are rotated about a center axis at about 500 to 4000 RPM.

The top section also may contain an O-ring or other suitable seal 301 to provide a gas tight and liquid tight seal between the top and bottom section to form a gas tight, pressurized, spin processing module. The top and bottom section may be locked together with a locking mechanism 310. The mechanism may be of a bayonet type mount, threaded mount, or other means can be readily latched and unlatched under automated control. The top section may be designed to slide up the top mounted tube assembly so that the top is separated from the bottom assembly to provide room for unloading a processed wafer and loading the next wafer under manual or robotic control.

A spin processing module of similar design can be constructed to simultaneously expose both the top side and bottom side of the wafer to the etch, rinse, and drying process. In such a design an edge holding mechanical chuck may be used in lieu of a vacuum chuck. A second dispense nozzle and second purge gas inlet is located in the center of the bottom module using the same arrangement currently used for the top half of the module. Drain outlet slots and vent outlet slots located in the top half and bottom half can be designed to be dual purpose. The top and bottom of the module are then made of the same design. One can employ a hydrophobic vent or other means to insure that only gas exits to the catalyst unit and the liquid passes to the drain. Again, gas and liquid back pressure regulators or pressure dropping orifices can be installed on the gas outlet and liquid outlet lines to maintain a predetermined pressure in the process module.

Operation—FIG. 8A

The operation of the spin processor shown in FIG. 8A is similar to that shown in FIG. 5B.
1. unlatch (unseal) and open the spin processing module for wafer unload/load
2. deactivate the vacuum chuck and unload the previously processed wafer (substrate)
3. load the new wafer (substrate) onto the vacuum chuck (or other suitable non-vacuum chuck) and activate the chuck to hold the wafer in place.
4. close and latch (seal) the spin processing module
5. spin the wafer module containing the wafer to the setpoint process RPM (3000 RPM for example)
6. set the gas back pressure regulator on the gas outlet (vent) line and size the liquid back pressure regulator or the pressure dropping orifices on the process liquid outlet ( drain) line to provide a predetermined back pressure (2 bar˜30 psig for example) to minimize the loss of ozone from solution
7. set the process temperature and process flow rate
8. flow the heated ozone-solvent solution to the dispense nozzle of the process module for a specified duration (20 to 90 seconds for example); as in the case of FIG. 5A and FIG. 5B, the solution is prepared by dissolving a relatively high concentration ozone gas in a solvent at a relatively low predetermined temperature T1 to form an ozone-solvent solution with a relatively high dissolved ozone concentration, and heating the ozone-water solution with a point-of-use heater to quickly increase the temperature to a predetermined higher temperature T2>T1, and applying the ozone-solvent solution to said material(s) whereby the heated ozone-water solution will have a much higher dissolved ozone concentration at said higher temperature, than could be achieved if the ozone gas was initially dissolved in water at said higher temperature. As before, additional chemicals may be mixed with the ozone-solvent solution just upstream of the point of application.
9. flow the rinse solution to the dispense nozzle of the process module for a specified duration (10 seconds for example) to rinse the wafer.
10. spin dry the wafer
11. purge the process module with filtered nitrogen or other suitable purge gas for a specified duration (5 seconds for example) to remove any residual process gases.
12. unlatch (unseal) and open the spin processing module for wafer unload/load
   Description—FIG. 8B

FIG. 8B is an alternative embodiment of the spin processing module shown in FIG. 8A. The embodiment shown in FIG. 8B is the same as that shown in FIG. 8A except for the design of the pressure dropping element at the outlet of the module. In the embodiment shown in FIG. 8B, the process liquids exit from the processor though an adjustable annular pressure dropping element 355 shown in cross section in lieu of the pressure dropping orifices 350. In this embodiment, the module can be placed inside a housing similar to that of a conventional spin processor and the process liquids that exit from at the peripheral slot 360 may be collected by the drain located in that housing and directed to to the facility drain/reclaim inlet (not shown).

Operation—FIG. 8B

The design of the annular pressure dropping element 355 is analogous to the design of a needle valve. In a needle valve, a conical needle can be set at a different depth in a conical seat to vary the pressure drop across the needle valve. In the design shown in FIG. 8B, the annular raised ridge of triangular cross section can be set a different depths in the annular slot of triangular cross section to vary the pressure drop across the element as fluid flows through the passage between the two elements and exits at peripheral slot 360. The depth of penetration can be increased or decreased by increasing or decreasing the force applied to the top and bottom section as shown schematically by the arrows 365. This can then provide a means for adjusting the back pressure to a specified value. The back pressure may be measured by a pressure transducer (not shown) installed to sense the pressure inside the module formed by the to and bottom section. The pressure may be adjusted to a specified value for a particular flow rate or the pressure may be adjusted under closed loop control to maintain the pressure at a particular set-point value at different flow rates.

Description—FIG. 8C

FIG. 8C is an alternative embodiment of the spin processing module shown in FIG. 8A. The embodiment shown in FIG. 8C is the same as that shown in FIG. 8A except for the design of the pressure dropping element at the outlet of the module. In the embodiment shown in FIG. 8C, the process liquids exit from the processor a set of one or more orifices 351. In this embodiment, fixed drain collection unit 385 is sealed to the lower section 255 through a gas and liquid tight seal 380. The seal 380 may be a O-ring seal or a non-contacting seal of labyrinth design. These seal designs are well known to those skilled in the art. The drain collection unit outlet 323 is connected through back pressure regulator 253 to the outlet 256 to the facility drain-reclaim. The drain collection unit may be stationary while the upper section 251 and lower section 255 may rotate with the wafer.

Operation—FIG. 8C

The process liquids that exit from the orifices 351 and move the center of the drain collection module to outlet 323 and then through back pressure regulator 253 to outlet 256. In this design all the liquid process effluents are captured by drain collection unit 385. The liquid back pressure inside the module formed by the top section 251 and bottom section 255 and drain collection module 385 is determined by the setting of the back pressure regulator 253. The orifices 351 may then be sized to have a low pressure drop since they need not serve as the pressure dropping elements for setting the back pressure inside the module formed by the top section 251 and bottom section 255 and drain collection unit 385.

Typical Ozone-Water Solution Supply Using Venturi Injector And Downstream Bubble Column

Description—FIG. 9

In reference to FIG. 9, a DI water supply 130 is connected through a length of tubing to the fill inlet of a three-way valve 132. The outlet of three-way valve 132 is connected through a length of tubing to the inlet of pump 134. The outlet of pump 134 is connected to the process fluid inlet of heat exchanger 136. A recirculating cooling unit is connected to the working fluid inlet and outlet of the heat exchanger 136. The process fluid outlet of the heat exchanger 136 is connected to the motive flow inlet of venturi injector 140. The outlet of venturi injector 140 is connected to a bubble column inlet 142 in bubble column 144. The pump is a positive displacement pump capable of delivering the pressure to overcome the pressure drop across the exchanger 136 and venturi injector 140. The supply outlet 156 of the bubble contactor 146 is connected by a length of tubing to a liquid back pressure regulator 158. The outlet of liquid back pressure regulator 158 is connected by a length of tubing to two-way valve 160. The outlet of the two-way valve 160 is connected to the process to provide a pressurized source of ozonated water at 162.

An pressurized oxygen supply 164 is connected by a length of tubing to a two-way valve 166. The outlet of two-way valve 166 is connected by a length of tubing to mass flow controller 168. The outlet of mass flow controller 168 is connected to the oxygen gas inlet of high concentration ozone generator 170. A recirculating cooling unit 172 is connected to cool the ozone generator cells of ozone generator 170. The ozone gas outlet of ozone generator 170 is connected to the inlet of check valve 174. The outlet of check valve 174 is connected to the suction gas inlet of venturi injector 140. The waste ozone gas vent outlet 176 of contactor 146 is connected to an ozone catalytic destruction unit 178. The outlet of ozone catalytic destruction unit 178 is connected to the inlet of off-gas back-pressure regulator 180. The outlet of back pressure regulator 180 is connected to the inlet to the facility vent 182 for contactor off-gas. The recirculate-outlet 154 of contactor 146 is connected by a length of tubing to the recirculate inlet of three-way valve 132. An level sensor 148 is positioned several inches from the top of the contactor 146 to detect the position of the minimum liquid level in the contactor. An level sensor 150 is positioned a short distance (1-2 inches) above level sensor 148 to detect the position of the maximum liquid level in the contactor. The level sensors are connected to a fill level controller 152. The fill level controller connected to the fill valve 132, a solenoid valve, to control the filling of the contactor as water is removed from the contactor at the supply point 162. The connection from the controller to the valve is not shown. This embodiment is designed to provide for dissolving ozone gas in water at a pressure above atmospheric to increase the dissolved ozone concentration as predicted by Henry's law. Since the contactor and connecting tubing is chilled below ambient, the entire system is insulated.

In an alternative embodiment, designed to dissolve ozone gas at atmospheric pressure, the liquid back pressure regulator 158 may be eliminated and the gas back pressure regulator 178 is moved to outlet line of the ozone generator 170 to maintain the required pressure in the ozone generator for efficient generation of ozone gas. In this alternative embodiment the contactor is not pressurized. Accordingly, a pump (not shown) must be placed between the contactor supply outlet 156 and the valve 160 to provide a pressurized source of ozonated water at 162. In this case the two-way valve solenoid valve (all valves are understood to be solenoid valves)160 may be replaced by a three way solenoid valve (not shown) with the normally open outlet connect by a length of tubing back to the contactor 146 and the normally closed outlet connected to 162. In this configuration, the ozonated water can be recirculated back to the contactor (connection not shown) to keep the concentration in the line a full concentration, and then dispensed to the process by actuating the three-way dispense valve (not shown). In electronic device cleaning/processing applictions, all wetted materials may be Teflon PFA or Teflon PTFE materials in lieu of metal materials to exclude the introduction of metal contamination into the process.

Operation—FIG. 9

In reference to FIG. 9, DI water at near room temperature flows through the heat exhanger 134 where it may be cooled to a lower temperature (5 degree C. for example). The chilled DI water enters the venturi injector 140 where ozone gas is injected. Oxygen gas under pressure is regulated to a delivery pressure (40 psig. for example) and supplied to the inlet of mass flow controller 168. The mass flow controller controls the mass flow to the inlet of the ozone generator 170. An ozone generator such as the ASTEX AX8100 can deliver ozone at a concentration of about 240 g/NM3 at a flow rate of 1.5 L/min. An ASTEX AX 8200 can deliver ozone at a concentration of about 240 g/NM3 at a flow rate of 4.5 L/min. The ozone gas enters the suction inlet of venturi injector 140 where the high shear forces produce many very small bubbles of ozone gas that move to the bubble contactor with the water flow. The chilled DI water, mixed with ozone gas bubbles, moves through the contactor as shown by the arrows on FIG. 9. The large surface area of the many small bubbles provide for a high rate of mass transfer from the gas to the liquid by diffusion. The residence time of the bubbles in the contactor determines the concentration that can be achieved at the end of one pass through the contactor. The ozone gas that does not dissolve into the water exits form the contactor at the outlet 176. The level controller 152 controls the opening and closing of the fill valve 132. The level of water in the contactor is controlled as water is drawn from the contactor at 162.

An ozonated water supply can be designed to operate either as a batch recirculating dissolved ozone supply system or as a single pass continuous flow dissolved ozone supply system. Both systems have a means for generating high concentration ozone gas, a means for cooling a volume of water, and a means for dissolving the ozone gas in the water. The key design elements are summarized in Table 18.

TABLE 18
Key Design Elements: Batch Recirculating Compared to a Continuous Flow Ozonated Supply

| | Batch | |
|---|---|---|
| | Ozone Mass Flow Out > Ozone | Continuous |
| | Mass Flow | Ozone Mass Flow Out = |
| Design Element | Dissolved | Ozone Mass Flow Dissolved |
| supply duty cycle | intermittent | continuous |
| ozone generator flow | variable | constant |
| req'd ozone gas mass flow | <DIO3 mass flow rate | ≧DIO3 mass flow rate |
| rate | | |
| operating temperature | <20 C. or ≧20 C. | <20 C. or ≧20 C. |
| req'd DI water cooling | proportional to average DIO | proportional to peak DIO Flow |
| capacity | Flow | |
| operating pressure | P = 1 bar or P > 1 bar | P = 1 bar or P > 1 bar |
| gas-liquid contactor | venturi injector or packed | venturi injector or packed |
| element | column | column |
| gas-liquid contact volume | bubble column or packed | bubble column or packed |
| | column | column |
| ozone injection pressure | <1 bar or contactor pressure | <1 bar or contactor pressure |
| maximum DIO3 | Cout = saturation | Cout < saturation |
| concentration | concentration | concentration |
| system cost | lowest | higher |

Let us describe the operation of small batch type ozonated supply system of the type employed in the inventors laboratory. A small venturi injector and bubble column contacting system for dissolving ozone gas at one atmospheric pressure employ a high pressure pump 134 feeding a small venturi injector 140 (Mazzei Injector Model 287) with chilled DI water at a motive flow rate of 3.5 L/min. (See FIG. 9) The water enters the inlet 142 in the center of the internal bubble column 144, then spills over the partition to the outer annular volume between the column 144 and the internal wall of the contactor 146 and returns to the pump by exiting from the outlet 154. Accordingly, the pump 134 continuously circulates water in a closed loop from the contactor 146, through the venturi injector 140 at a flow rate of about 3.5 L/min, and back to contactor bubble column 144. Once refilled with fresh water, the concentration can be restored to saturation in about 20 to 30 minutes for a ozone flow rate of 0.48 L/min at a gas phase ozone concentration of 240 g/NM3 and a contactor volume of 12 liters.

A pressure of about 40 psig is required to pass a motive flow of 3.5 L/min through the venturi in a system with an unpressurized contactor (p=1 bar=14.5 psia). Ozone gas from the ozone gas delivery system is fed to the suction inlet port of the venturi at a flow rate of 0.5 Liters/min. The pressure at the suction port of the venturi is about 0.7 to 0.8 bar (approx. 10 to 12 psia). The injection conditions are summarized in Table 19 below. In a recirculating system of this type, the dissolved ozone concentration in the contactor starts from zero and rises exponentially to a maximum saturation value which is determined by Henry's law given the ozone gas concentration and pressure and the water temperature. In an unpressurized system, the ozone gas is dissolved at 1 bar=14.5 pisa. For the flow rates and concentrations specified, the exponential time constant with which the dissolved ozone concentration approaches saturation is about 6 to 7 minutes. Accordingly, one can produce a 12 liter batch of ozonated water at a concentration of about 95% of saturation is 20 minutes (about three time constants). The key design parameters for this small capacity batch system are summarized in Table 19. Much larger capacity systems with higher mass flow rates can be designed using the same approach.

TABLE 19
Flows, Pressures, and Venturi Injector Size for a venturi-based ozone
gas-water contacting system for dissolving ozone gas at a pressure of
1 bar and a flow rate of 0.48 L/min. The predicted saturation concentration
with a water temperature of 5 degree C. and ozone gas concentration
of 240 g/Nm3 is also shown

| | Injector |
|---|---|
| PARAMETER | Design Values |
| venturi outlet/contactor pressure (bar) | 1 bar |
| venturi outlet pressure - pisa (psig) | 43.5 (28.8) |
| Injector (ozone) flow - liters/min (ft3/hr) | .48 (1.0) |
| Venturi Inlet Pressure-psig | 40 |
| Motive (water) flow - liters/min (gpm) | 3.5 (.8) |
| Pump Pressure Boost Required - psig | 40 |
| Venturi Size (Mazzei Model Number) | Model 287 |
| Predicted Saturation Concentration | 109 mg/L |

If the mass flow rate of the ozone to the injector is increased by increasing the ozone gas flow rate at a given gas phase concentration, then the volume of water will approach saturation in a shorter time. For example, the Astex AX 8100 ozone generator can supply ozone at a concentration of about 240 g/Nm3 at a flow rate of 1.5 L/min at a generator power setting of 90%. An Astex AX8200 ozone generator has three times the capacity of an AX8100 and can supply ozone at a concentration of about 240 g/Nm3 at a flow rate of 4.5 L/min at a generator power setting of 90%. The mass transfer rate from the gas to the liquid is a function of the surface area and the concentration difference between the gas phase and liquid phase. Accordingly, the mass transfer rate gradually falls as the dissolved concentration rises.

The entire ozone gas-water contacting system may be enclosed in a 19 inch equipment rack equipped with a ventilation system and a safety interlock system employing ozone leak detection sensors. In a system designed for use in semiconductor applications all the wetted parts can be Teflon or PVDF to eliminate iron contamination associated with stainless steel components.

The contactor can be either pressurized or unpressurized. If the contactor is designed to withstand pressures above one atmosphere, then the ozone gas can be dissolved in water at elevated pressures and thereby produce a higher dissolved ozone concentration at a given ozone gas phase concentration and water temperature than can be achieved at one atmosphere. For example, ozone can be dissolved in water at 4 bar (58 psia) In this case the pump provides boost pressure above the contactor pressure and the venturi is selected to achieve adequate suction at desired ozone flow rate. In Table 20 below we have presented the parameters for a high pressure venturi-based ozone gas-water contacting system for dissolving ozone gas at a pressure 3, or 4 bar and a flow rate of 1.5 L/min or 4.5 L/min. In such a system the off gas from the contactor must exit from the pressurized contactor through a back pressure regulator set to the desired contactor pressure and the liquid stream that is dispensed to the process must also exit from the contactor through a back pressure regulator set to the desired contactor pressure as shown in FIG. 9.

TABLE 20
Flows, Pressures, and Venturi Injector Size for a venturi-based ozone gas-water contacting
system for dissolving ozone gas at a pressure 3, or 4 bar and a flow rate of 1.5 L/min or
4.5 L/min. The predicted saturation concentration with a water temperature of 5 degree C.
and ozone gas concentration of 240 g/Nm3 is also shown

| PARAMETER | Injector Design Values | | | |
|---|---|---|---|---|
| venturi outlet/contactor pressure (bar) | 3 bar | 4 bar | 3 bar | 4 bar |
| venturi outlet pressure - pisa (psig) | 43.5 (28.8) | 58 (43.3) | 43.5 (28.8) | 58 (43.3) |
| Injector (ozone) flow - liters/min (ft3/hr) | 1.5 (3.2) | 1.5 (3.2) | 4.5 (9.6) | 4.5 (9.6) |
| Venturi Inlet Pressure - psig | 70 | 100 | 90 | 120 |
| Motive (water) flow - liters/min (gpm) | 14.5 (3.8) | 17.2 (4.5) | 29.5 (7.8) | 35.6 (9.4) |
| Pump Pressure Boost Required - psig | 41.2 | 56.7 | 46.5 | 76.7 |
| Venturi Size (Mazzei Model Number) | Model | Model | Model | Model |
| | 484 | 484 | 584 | 584 |
| Predicted Saturation Concentration at T = 5 | 327 mg/L | 436 mg/L | 327 mg/L | 436 mg/L |
| Deg C. w/ozone gas at 240 g/Nm3 | | | | |

If one can use a concentration that is less than the saturation concentration, then one can achieve that concentration in a shorter time. This is the basis of a single pass ozone gas-water contacting system.

Typical Ozone-Water Solution Supply Using a Packed Column
Description—FIG. 10

In reference to FIG. 10, the design of a single pass ozonated water supply using a packed column is shown. The chilled water supply subsystem (elements 130, 132, 134, 136, and 138) is the same as described under FIG. 9 except valve 132 is a two way valve in a single pass configuration. The design of the ozone gas subsystem (elements 164, 166, 168, 170, and 172) is the same as described under FIG. 9. The design of the off-gas subsystem with gas back pressure regulator (elements 178, 180, and 182 is the same as described under FIG. 9. The design of the column level control subsystem (elements 148, 150, and 152) is the same as described under FIG. 9. The design of the supply outlet to the process (elements 156, 158, 160) is the same as described under FIG. 9. Since this system is design for a single pass there is not recirculation of the ozonated water back through the contactor.

The systems differ only in the type of contactor used. In reference to FIG. 10, the ozone gas from generator 170 is connected by a length of tubing through a check valve 174 to the inlet of a gas distributor plate 174 located in the bottom of a pack column contactor filled with PFA packing. The packing is typically about 1/10^{th} the column diameter. The sizing of the packing and column for a particular gas and liquid flow rate is well known to those skilled in the art.

The process outlet of heat exchanger 136 supplies the chilled DI water to the packed column contactor 146 at a point near the top of the contactor.

Operation—FIG. 10

In reference to FIG. 10, the operation of the subsystems which are the same as those shown in FIG. 9 are the same as described under FIG. 9. Whereas the venturi injector produces many small bubbles to provide a large surface area for mass transfer to occur in a downstream bubble column as described under FIG. 9, the column packing provides the large surface area for mass transfer in the packed column design. In a single pass design the volume of the column is made relatively large (greater than 20 liters for a system designed to produce ozononated water at a concentration of 70 mg/L at a liquid flow rate of 10 L/min and a water temperature of 20 degree C. One cannot simply decrease the water temperature to produce a higher dissolved ozone concentration in a single pass contactor. If one decreases the DI water temperature from 20 degree C. to 5 degree C., then one doubles the capacity for the water to dissolve a given mass of ozone. In order to realize a benefit from this increased capacity one must double the mass flow rate supplied by the ozone generator by using a larger generator capable of supplying a concentration of 240 mg/L at a flow rate of 12 L/min as compared to 6 L/min for example. One may also increase the column size to accommodate the higher flow rate.

We have presented a method of producing an ozone-solvent solution with a very high dissolved ozone concentration for use in industrial applications comprising the following steps:
a) cooling a volume of solvent (particulary an aqueous solution) to a temperature below room temperature but above the freezing point of the solvent, e.g. water between 1 deg. C. and 15 deg. C.,
b) dissolving ozone gas in said volume of solvent under elevated pressure using an ozone gas-water contacting means to form an ozone-solvent solution
c) dispensing the low temperature ozone-solvent solution to a process chamber whereby the ozone-solvent solution can have a much higher dissolved ozone concentration than can an ozone-solvent solution formed at the same pressure at room temperature.

The preferred embodiments described in FIGS. 1 to 15 will be able to derive significant benefit from a supply of a very high concentration cold ozone water solution. This new class of ozonated water supply systems have the potential to achieve a factor of two increased in concentration compared to prior art supply systems operating at 20 degree C.

This new class of ozonated water supplies has a number of advantages:
this approach provides a means to increase the dissolved concentration to levels a factor of two higher than can be produced at near room temperature;
a cold ozone water solution temperature reduces the rate of thermal decay of the ozone in solution over that in a 20 degree C. solution;
a cold ozone water solution can be piped relatively long distances in suitably insulated lines;
a supply of cold ozone water solution with a factor of two higher dissolved ozone concentration transports a given ozone mass flow using half the water as a conventional supply;
a factor of two high dissolved ozone concentration will enable a new class of applications to achieve a factor of two increase in etch rate over that which can be achieved currently;
applications will be able to consume less water to process a wafer or substrate or other material than the same application supplied from a supply system which runs at near room temperature because a given ozone mass flow can be carried at a lower water flow rate if the dissolved ozone concentration is higher;
Since the water flow rate can be reduced by a factor of two, the pressure drop across the point-of-use heater (heat exchanger or direct heater) is reduced by about a factor of 4. In the current configuration this means the presssure at the outlet of the dissolved ozone supply is reduced from about 95 psig for a flow rate of 3.3 L/min to about 27 psig for a flow rate of 1.65 L/min. (This eliminates the need to boost the pressure at the exchanger inlet with a pump or other means. An ozone-water contactor pressure of about 2.5 bar or more is adequate to supply this pressure with no additional boost);

since the water flow rate can be reduced by a factor of two the power requirement of the point-of-use heater is reduced by a factor of two as shown in the table 21 below. At a flow rate of 1.65 L/min the required power input to the water stream to increase the temperature 50 degree C. is 5.7 kW. At a flow rate of 3.3 L/min the required power input to the water stream to increase the temperature 50 degree C. is 11.4 kW.

TABLE 21
Example Heater Power Requirements

| | | | | Power |
|---|---|---|---|---|
| Dispense Flow | Inlet Water | Desired Outlet | Required | Input |
| Rate | Temp. | Water Temp. | Temp. Increase | Req'd |
| (L/min) | (deg. C.) | (deg. C.) | (deg. C.) | (kW) |
| 1.65 | 5 | 45 | 40 | 4.55 |
| 1.65 | 5 | 55 | 50 | 5.7 |
| 1.65 | 5 | 65 | 60 | 6.85 |
| 1.65 | 5 | 75 | 70 | 7.95 |
| 1.65 | 5 | 85 | 80 | 9.1 |
| 1.65 | 5 | 95 | 90 | 10.25 |
| 3.3 | 5 | 45 | 40 | 9.1 |
| 3.3 | 5 | 55 | 50 | 11.4 |
| 3.3 | 5 | 65 | 60 | 13.7 |
| 3.3 | 5 | 75 | 70 | 15.9 |
| 3.3 | 5 | 85 | 80 | 18.2 |
| 3.3 | 5 | 95 | 90 | 20.5 |

since the water flow rate can be reduced by a factor of two, the pressure drop across the DI water cooling heat exchanger is reduced by about a factor of 4; this eliminates the need for pump or other means to boost the DI water pressure at the system inlet over that available from the facility DI water supply.

since the water flow rate can be reduced by a factor of two the power requirement of the DI water cooling unit is reduced by a factor of two as shown in the table below. At a flow rate of 1.65 L/min the required power withdrawal from the water stream to decrease the temperature 15 degree C. is 1.7 kW. At a flow rate of 1.65 L/min the required power withdrawal from the water stream to decrease the temperature 15 degree C. is 3.4 kW. With a system feeding three process modules, the total DI water flow to the contactor is 5.0 L/min. The cooling power is shown in the table 22 below.

TABLE 22
Example Heater Power Requirements for Lower Flow Rates

| DI water | Inlet Water | Desired Outlet | Required | Power |
|---|---|---|---|---|
| Flow Rate | Temp. | Water Temp. | Temp. Increase | Removal |
| (L/min) | (deg. C.) | (deg. C.) | (deg. C.) | Req'd (kW) |
| 1.65 | 20 | 5 | 15 | 1.7 |
| 3.3 | 20 | 5 | 15 | 3.4 |
| 5 | 20 | 5 | 15 | 5.1 |
| 10 | 20 | 5 | 15 | 10.2 |

If a solute, a buffer or hydroxyl radical scavenger chemical, is added to the water before it is cooled, then the freezing point may be reduced to below 0 degree C. Accordingly, in general the water may be cooled to a point above freezing point of the aqueous solution.

General Comments

In many instances in the above description of the preferred embodiments any elements that are between the inlet of the heater 28 or 29 and the dispense nozzle 36 are said to be connected by a short length of tubing. The critical requirement is actually the volume of the tubing not the length because, at a given flow rate, the time delay between the time the ozone-water solution is heated, transported through the connecting tubing to the point of application of the material to be oxidized. When we say short length of tubing we are really saying small volume length of tubing. The tubing length and internal diameter is chosen such that the total time is such that the dissolved ozone concentration does not fall by more that a predetermined amount at a chosen process temperature. In many early embodiments constructed by the inventors the tubing was Teflon with an inside diameter of between 0.125 inches to 0.180 inches. The tubing connecting the various elements was between 2 to 10 inches long such that the total residence time in the heater and interconnecting tubing was less than 5 seconds for example at a particular flow rate through the point-of-use heater. In these embodiments the relatively small diameter (0.125 to 0.180 inside diameter), 10 to 15 inch long length of tubing which conveys the heated ozone-solvent solution to the dispense nozzle also serves as a pressure dropping element at the specified flow rates. The back pressure provided by this pressure dropping element serves a similar function to that of a back pressure regulator.

The teaching relating to the positioning of the back pressure or other pressure dropping element, the benefit of placing the back pressure regulator or other pressure dropping element downstream of the heating means, either just upstream or the inlet to the materials processing module, or just downstream of the outlet of the materials processing module, and the method of the determination of the magnitude of back pressure to minimize the fall of dissolved ozone concentration following heating is generally applicable to all the embodiments shown in all the figures. The teaching relating to the use of back pressure regulators on both the liquid outlet (drain) line and the gas outlet (vent) line of the materials processing module is generally applicable to all the embodiments shown in all the figures.

At a dispense temperature of 50 degree C. the inventors estimated that the dissolved ozone concentration would decrease to about 80 percent of its initial value at the inlet of the point-of-use heater. In all the embodiments shown in all the figures the valves may be gas operated or electrically operated solenoid valves so that the valves can be controlled with a central controller. In all the embodiments, one or more controllers may be included to control the time, duration, and other process parameters during each phase of the materials processing cycle. Many of the embodiments include a three-way valve 24 to direct the chilled ozone-water solution to waste reclaim and a three-way valve 32 to direct the heated ozone-water solution to waste reclaim. In some embodiments one or both of these valves may be omitted. In most of the embodiments shown, a heat exchanger 28 is shown has the point-of-use heater. In all cases it should be noted that a point-of-use heat heater 29 may be used in lieu of a heat exchanger 28. In many embodiments, typical values for process parameters are given. In many cases the process parameters may be set outside the range of parameters listed. For example, if the means of applying the ozonated water solution to the wafer can provide a higher mass transport rate M, then the temperature at which the etch rate will become mass transport limited will be higher also. In some cases we have shown a range of temperatures around a nominal value (for example 40 to 60 degree C.) as a typical temperature at the point of application. This is a nominal value for a particular heating delay time and mass transport condition. If the mass transport conditions are improved, then the etch rate may be increased with a further increase in temperature. In some configurations, the etch rate may not become mass transport limited until the temperature is set to a higher value such as 90 to 95 deg. C. for example. Although specific features of the preferred embodiments are shown in some drawings and not others, this is for convenience only as many features may be combined with any or all of the other features.

Particular mention is made of conditions pertaining to processing semiconductor wafers, especially the removal of photoresist, post etch residue, and other organic materials from semiconductor wafers. Particular mention is made of conditions pertaining to sterilizing or disinfecting medical instruments, medical devices. However, aspects of the present invention may be practiced in other applications. The contents of the preceding discussion and the drawings are set forth as examples only and should not be understood to represent limitations upon the scope of the present invention.

1. A method for treating a material, comprising:
forming an ozone-solvent solution at a first temperature; and
reacting the ozone-solvent solution with the material at a second temperature and at a pressure p that is elevated relative to ambient;
wherein the first temperature is less than the second temperature, the relatively lower first temperature facilitating an increased concentration of dissolved ozone in the solvent, the relatively higher second temperature facilitating an increased reaction rate between the ozone-solvent solution and the material.

2. The method of claim 1, wherein the reacting step comprises:
heating said ozone-solvent solution from said first temperature to said second temperature to form a heated ozone-solvent solution; and
applying said heated ozone-solvent solution to the material at approximately said second temperature at said pressure p;
wherein applying said heated ozone-solvent solution at said pressure p reduces the rate of loss of ozone from the ozone-solvent solution resulting from heating the ozone-solvent solution.

3. The method of claim 2, wherein said step of applying said ozone-solvent solution to said material has at least one point of application, and wherein the step of heating comprises using a liquid-to-liquid heat exchanger placed just upstream of the least one point of application of said ozone-solvent solution to said material and wherein downstream of the liquid-to-liquid heater the ozone-solvent solution is at said pressure p.

4. The method of claim 2, wherein said step of applying said ozone-solvent solution to said material has at least one point of application, and wherein the ozone-solvent solution is heated using an in-line heater placed just upstream of the at least one point of application of said ozone-solvent solution to said material and wherein downstream of the liquid-to-liquid heater the ozone-solvent solution is at said pressure p.

5. A device for treating a material, comprising:
means for forming an ozone-solvent solution at a first temperature; and
means for reacting the ozone-solvent solution with the material at a pressure p and at a second temperature greater than the first temperature to oxidize at least a portion of the material;
wherein said pressure p is elevated relative to ambient; and
wherein the lower first temperature facilitates an increased concentration of dissolved ozone in the solvent, and the higher second temperature facilitates an increased reaction rate between the ozone-solvent solution and the material.

6. A method of treating a material, comprising:
forming an ozone-solvent solution at a first temperature having a dissolved ozone concentration;
reacting said ozone-solvent solution with the material at a pressure p and at a second temperature which is higher than said first temperature;
wherein said pressure p is elevated relative to ambient.

7. The method of claim 6, wherein the reacting step comprises:
heating at least one of said ozone-solvent solution and the material;
thereby causing said ozone-solvent solution to have a higher dissolved ozone concentration while reacting with the material than if said ozone-solvent solution had been formed at said second temperature.

8. The method of claim 7, wherein said reacting step comprises heating said ozone-solvent solution from said first temperature and reacting said ozone-solvent solution with said material at said pressure p in order to maintain a higher dissolved ozone concentration than if said ozone-solvent solution had been formed at said second temperature.

9. The method of claim 7, wherein said reacting step comprises heating said ozone-solvent solution from said first temperature while maintaining said ozone-solvent solution at said pressure p and reacting said ozone-solvent solution with said material in order to maintain a higher dissolved ozone concentration than if said ozone-solvent solution had been formed at said second temperature.

10. A system for treating a substrate with an ozone-solvent solution comprising:
a supply of an ozone-solvent solution formed at a first temperature which delivers a generally continuous supply of said ozone-solvent solution at the first temperature;
a heater having an inlet and an outlet, said inlet fluidly coupled to receive said ozone-solvent solution at said first temperature from said supply, said heater configured to heat from said first temperature said ozone-solvent solution received at said inlet, said outlet providing a generally continuous supply of heated ozone-solvent solution;
a pressure regulator fluidly coupled to the outlet of said heater to maintain said heated ozone-solvent solution at a pressure p that is elevated relative to ambient, and
an applicator fluidly coupled to the outlet of said pressure regulator to receive said generally continuous supply of said heated ozone-solvent solution, said applicator having an outlet configured to direct said heated ozone-solvent solution at a second temperature greater than said first temperature toward said substrate.

11. The method of claims 1-4, and 6-9 wherein said pressure p is above 20 psia.

12. The method of claim 1-4 and 6-9 wherein said pressure p is between 20 psia and 70 psia.

13. The device of claim 5 wherein said pressure p is above 20 psia.

14. The device of claim 5 wherein said pressure p is between 20 psia and 70 psia.

15. The system of claim 10 wherein said pressure p is above 20 psia.

16. The system of claim 10 wherein said pressure p is between 20 psia and 70 psia.

17. A method of treating a surface of a material with an ozone-solvent solution comprising:
choosing a reaction temperature for said ozone-solvent solution;
adjusting the temperature of said ozone-solvent solution to said reaction temperature;
applying the ozone-solvent solution to the surface;
wherein said ozone-solvent solution has a surface reaction rate S with said surface and a mass transport rate M relative to said surface;
and wherein said reaction temperature is chosen such that said surface reaction rate S is much less than the mass transport rate M;
thereby achieving a surface reaction rate that is approximately uniform over the surface of the material to be treated.

18. The method of claim 17 wherein the temperature of said ozone-solvent solution is set such that said surface reaction rate S is at most one-fifth of the lowest value of the mass transport rate M over the surface to be treated.

19. The method of claim 17 wherein the temperature of said ozone-solvent solution is set such that said surface reaction rate S is approximately one-tenth of the lowest value of the mass transport rate over the surface to be treated.

20. The method of claim 17 wherein said material comprises a material that is oxidizable by said ozone-solvent solution.

21. A method of growing an oxide on a material that is oxidizable by an ozone-solvent solution, comprising
forming an ozone-solvent solution at a first temperature; and
reacting the ozone-solvent solution with the material at a second temperature
wherein the first temperature is less than the second temperature, the relatively lower first temperature facilitating an increased concentration of dissolved ozone in the solvent, the relatively higher second temperature facilitating an increased reaction rate between the ozone-solvent solution and the material.

22. The method of claim 21 wherein the material is a metal.

23. The method of claim 21 wherein the material is selected from the group consisting of silicon, germanium, aluminum, and copper.

24. A device for forming an ozone-solvent solution comprising:
a source of solvent at a first temperature;
a source of ozone gas at a first gas concentration and at a first pressure, said ozone gas having an equilibrium saturation concentration when dissolved into said solvent at said first temperature at a second pressure;
an ozone gas-solvent contactor that dissolves ozone gas into said solvent at said first temperature at said first gas concentration and at a third pressure that is above said second pressure to form an ozone-solvent solution at a concentration that is equal to said equilibrium concentration at said second pressure.

25. A device as in claim 24, wherein said ozone gas-solvent contactor has dimensions so as to provide a residence time for said ozone gas to increase in concentration in said ozone-solvent solution from zero to said equilibrium saturation concentration.

26. The device of claim 24 wherein said second pressure is atmospheric pressure.

27. A method of forming an ozone-solvent solution;
providing a solvent at a first temperature;
providing an ozone gas at a first gas concentration and at a first pressure, said ozone gas having an equilibrium saturation concentration when dissolved into said solvent at said first temperature at said second pressure;
dissolving said ozone gas into said solvent at said first temperature and at a third pressure in an ozone gas-solvent contactor to form an ozone-solvent solution;
wherein said third pressure is higher than said second pressure; and
delivering said ozone solution from said ozone gas-solvent contactor at said second pressure when said ozone concentration in said ozone gas solvent contactor is equal to said equilibrium saturation concentration at said second pressure.

28. The method of claim 27 wherein the step of delivering said ozone-solvent solution comprises passing said ozone solvent solution from said ozone gas-solvent contactor through a pressure dropping element.

29. The method of claim 27 wherein said second pressure is atmospheric pressure.

30. A method of treating a material, comprising:
providing a solvent at a first temperature;
providing an ozone gas at a first gas concentration and at a first pressure, said ozone gas having an equilibrium saturation concentration when dissolved into said solvent at said first temperature at said second pressure;
dissolving said ozone gas into said solvent at said first temperature and at a third pressure in an ozone-gas-solvent contactor to form an ozone solvent solution;
wherein said third pressure is higher than said second pressure;
delivering said ozone solution from said ozone-gas solvent contactor at said second pressure when said ozone concentration in said ozone gas-solvent contactor is equal to said equilibrium saturation concentration at said second pressure; and
reacting said ozone-solvent solution with said material.

31. The method of claim 30 wherein said step of reacting is performed at a second temperature; and wherein the first temperature is less than the second temperature, the relatively lower first temperature facilitating an increased concentration of dissolved ozone in the solvent, the relatively higher second temperature facilitating an increased reaction rate between the ozone-solvent solution and the material.

32. The method of claim 30, wherein the reacting step comprises:
heating said ozone-solvent solution from said first temperature to said second temperature to form a heated ozone-solvent solution; and
applying said heated ozone-solvent solution to the material at approximately said second temperature.

33. The method of claim 32, wherein said heated ozone-solvent solution is applied to the material within a time period after heat is first applied to said ozone-solvent solution for heating said ozone-solvent solution from said first temperature to the said second temperature to minimize a decrease in concentration of the dissolved ozone in the ozone-solvent solution resulting from heating the ozone-solvent solution.

34. A compact spin processing system for treating at least one substrate with an ozone-solvent solution, said substrate having two surfaces, comprising;
a housing having an upper portion and a lower portion;
a substrate holder located inside said housing;
a reversible seal located between the upper portion and the lower portion of said housing;
at least one supply channel arranged to carry said ozone-solvent solution to at least a portion of the substrate;
at least one drain channel arranged to convey liquid or gas or gas-liquid solution effluents and reaction products away from said substrate;
a spinner that spins the substrate about and an axis normal to one surface of the substrate.

35. A system as in claim 34 wherein said spinner is configured to spin the upper portion and the lower portion of said housing when sealed together as it spins said substrate.

36. A system as in claim 34 wherein said spinner spins said upper portion and said lower portion together while said upper portion and said lower portion are un-sealed and separated to allow process effluents and reaction products to spin off the substrate.

37. A system as in claim 34 wherein said spinner can rotate said upper portion and said lower portion at a speed that is different from the speed of the substrate.

38. A system as in claim 35 wherein said spinner can maintain the spinning of the upper portion and lower portion while halting the spinning of the substrate for substrate loading and unloading.

39. A system as in claim 35 wherein said spinner can halt the rotation of upper portion, the lower portion, and the substrate for substrate loading and unloading.

40. A system as in claim 34 further including an applicator for applying process fluids, either concurrently or sequentially, to at least a portion of one or both surfaces of the substrate.

41. A system as in claim 34 further comprising:
a connector for connecting to fixed facility supplies;
a conduit fluidly coupled to said connector;
a rotating seal fluidly coupled to said conduit and to said at least one supply channel.

42. A system as in claim 34 further comprising:
a second connector for connecting to fixed facility drains and vents;
a second conduit coupled to said connector;
a second rotating seal coupled to said second conduit and to said at least one drain channel.

43. A system as in claim 34 further including a gas back-pressure regulator fluidly connected between a housing outlet and a facility vent.

44. A system as in claim 34 further including a liquid back-pressure regulator fluidly connected between a housing outlet and a facility drain.

45. A system as in claim 34 in which the substrate comprises a semiconductor wafer.
